(19) United States
(12) Patent Application Publication
(10) Pub. No.: US 2023/0372169 A1
(43) Pub. Date: Nov. 23, 2023

(54) BED WITH BED PRESENCE DETECTION USING TEMPERATURE SIGNALS

(71) Applicant: Sleep Number Corporation, Minneapolis, MN (US)

(72) Inventors: Gary N. Garcia Molina, Madison, WI (US); Pavlo Cherneha, Kyiv (UA); Yehor Shcherbakov, Kyiv (UA)

(21) Appl. No.: 18/198,431

(22) Filed: May 17, 2023

Related U.S. Application Data
(60) Provisional application No. 63/343,130, filed on May 18, 2022.

(51) Int. Cl. A61G 7/05

(52) U.S. Cl. CPC A61G 7/05

(57) ABSTRACT

The disclosed technology provides a bed system for detecting bed presence of a user, having a bed with at least one temperature sensor and a computer system that performs operations including: receiving, from the at least one temperature sensor, temperature signals collected at the bed, providing the temperature signals as input to a bed presence classifier, receiving, from the bed presence classifier, output of a bed presence indication, and returning the bed presence indication. The computer system can also receive, from at least one motion sensor of the bed, pressure signals, and the bed presence classifier can generate the bed presence indication based on the pressure signals and the temperature signals. The bed presence indication can be provided, to a data pipeline, which can include at least one classifier that was trained to determine at least one of user sleep metrics or user health metrics.

### CROSS-REFERENCE TO RELATED APPLICATIONS

This application claims the benefit of U.S. Provisional Application Ser. No. 63/343,130, filed May 18, 2022. The disclosure of the prior application is considered part of (and is incorporated by reference in) the disclosure of this application.

### TECHNICAL FIELD

The present document relates to a bed with user presence detection features.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

### SUMMARY

This disclosure generally relates to systems, methods, and techniques for detecting bed presence or absence using signals from temperature sensors. In some implementations, bed presence or absence can also be detected using a combination of signals from temperature sensors, pressure sensors, and other types of motion sensors of a bed system. For example, the disclosed technology can use signals from at least one temperature sensor located on a surface of a mattress to determine whether a user is lying on the bed (e.g., bed presence) or not (e.g., bed absence). The disclosed technology can provide for monitoring changes in the temperature signals to determine bed presence or absence in a temporal interval (e.g., window of time) of a given duration. For example, the duration can be 1 second windows in which adjacent windows of time do not overlap with each other. In some implementations, bed presence can also be detected using a combination of temperature signals and pressure signals. In such implementations, a sequence of temperature and pressure signals can be collected by at least one temperature sensor and at least one pressure sensor at the bed system. The signals can be collected with, for example, 1 minute increments to determine when each sleep session starts and ends. The temperature signals can also be combined with other sensing modalities or motion sensors that reflect different forms of movement. For example, temperature signals can be combined with load cell signals to detect bed presence. The temperature signals can also be combined with other types of motion signals that are detected and collected by different types of motion sensors described herein.

Some embodiments described herein include a bed system for detecting bed presence of a user, the bed system having: a bed including at least one temperature sensor attached to the bed, and a computer system in communication with the bed, the computer system being configured to perform operations including: receiving, from the at least one temperature sensor, temperature signals collected at the bed, providing the temperature signals as input to a bed presence classifier, receiving, from the bed presence classifier, output of a bed presence indication, and returning the bed presence indication.

Embodiments described herein can include one or more optional features. For example, the bed presence classifier can be a logistic regression classifier. The operations further can include: determining a time at which the user enters the bed as a time associated with the temperature signals received from the at least one temperature sensor. The bed presence indication can be an indication that the user is in the bed. The bed presence indication can be an indication that the user exited the bed.

In some implementations, the operations can also include: receiving, from at least one motion sensor of the bed, pressure signals, the bed presence classifier being configured to generate the bed presence indication based on the pressure signals and the temperature signals. The motion sensor can be a pressure sensor. The motion sensor can be at least one load cell.

The operations can also include providing the bed presence indication as input to a sleep walking detection classifier, the sleep walking detection classifier being configured to predict likelihood of a sleepwalking event occurring during a current sleep session based at least in part on the bed presence indication. In some implementations, the operations can include providing the bed presence indication to a microclimate adjustment module, the microclimate adjustment module being configured to generate instructions that cause one or more components of the bed to adjust a microclimate of the bed based at least in part on the bed presence indication. Sometimes, the operations can also include normalizing the bed presence indication to a binary value, in which a binary value of 0 can indicate that the user is absent from the bed and a binary value of 1 can indicate that the user is in the bed, and returning the binary value as output. In some implementations, the operations can include providing, to a data pipeline, the output, the data pipeline including at least one classifier that was trained to determine at least one of user sleep metrics or user health metrics based at least in part on the output.

As another example, the operations can also include normalizing the bed presence indication to a binary value, in which a binary value of False can indicate that the user is absent from the bed and a binary value of True can indicate that the user is in the bed, and returning the binary value as output. The operations can also include determining that the user is in the bed based on a determination that the bed presence indication exceeds a threshold value. The threshold value can be 0.5. The operations can also include determining that the user is absent from the bed based on a determination that the bed presence indication is less than a threshold value. In some implementations, the bed presence classifier was trained using a machine learning model to correlate increases in the temperature signals with presence of the user in the bed and decreases in the temperature signals with absence of the user from the bed.

In some implementations, the operations can include receiving, from the at least one temperature sensor, the temperature signals for a threshold period of time, separating the received temperature signals into 1 second frames, and processing each of the 1 second frames to provide as input to the bed presence classifier. The operations can also include receiving, from the at least one temperature sensor, another set of temperature signals during another threshold period of time, the another threshold period of time being adjacent to the threshold period of time, in which the threshold period of time does not overlap with the another threshold period of time.

As another example, the bed presence classifier can be stateless. The bed presence classifier can also be configured to generate the bed presence indication based on data collected in real-time by the at least one temperature sensor. The operations can also include generating instructions, based on the bed presence indication, to actuate a home automation device. The bed presence indication can be a probability that the user is in the bed. The at least one temperature sensor can be an array of 5 temperature sensors linearly arranged on a top surface of the bed. The at least one temperature sensor can include 5 sensors. The 5 sensors can be arranged linearly on a top surface of the bed from a left side of the bed to a right side of the bed. The 5 sensors can be attached to a strip material, and the strip material can be adhered to a top surface of the bed, extending from a left side of the bed to a right side of the bed. In some implementations, the bed system can also include at least one pressure sensor. The bed system can also include at least one load cell. The bed further can include a controller, and the computer system can be the controller. In some implementations, the computer system can be remote from the bed.

Some embodiments described herein include a bed system for detecting bed presence of a user, the bed system having a bed including: at least one temperature sensor and at least one motion sensor, and a computer system in communication with the bed, the computer system being able to perform operations including: receiving, from the at least one temperature sensor, temperature signals detected at the bed, receiving, from the at least one motion sensor, motion signals detected at the bed, providing the temperature signals and the motion signals as input to a bed presence classifier, receiving, from the bed presence classifier, output of a bed presence indication, and returning the bed presence indication.

Embodiments described herein can optionally include one or more of the following features. For example, the bed system can also include an air mattress having at least one air chamber, and a pump fluidically connected to the at least one air chamber and configured to inflate or deflate the at least one air chamber of the air mattress. The at least one motion sensor can be attached to the pump. The at least one motion sensor can be inside the at least one air chamber. The at least one motion sensor can be inline of fluid connection between the at least one air chamber and the pump. In some implementations, the bed further can include a controller, and the computer system can be the controller. In some implementations, the computer system can be remote from the bed.

As another example, the bed presence classifier was trained to (i) differentiate the temperature signals from the motion signals, (ii) identify a peak value in the temperature signals and a peak value in the motion signals, the peak value in the temperature signals being within a threshold distance from the peak value in the motion signals, and (iii) generate the bed presence indication based on correlating the peak value in the temperature signals with the peak value in the motion signals. The operations can also include determining a time at which the user enters the bed as a time at which the temperature signals and the motion signals are detected by the at least one temperature sensor and the at least one motion sensor, respectively. The bed presence indication can be an indication that the user is in the bed. The bed presence indication can be an indication that the user exited the bed. The bed presence classifier was trained using a machine learning model to correlate (i) increases in the temperature signals and increases in the motion signals with presence of the user in the bed and (ii) decreases in the temperature signals and decreases in the motion signals with absence of the user from the bed.

In some implementations, the at least one motion sensor can be a pressure sensor. The at least one motion sensor can be a load cell. The at least one motion sensor can include at least one pressure sensor and at least one load cell. The motion signals can be pressure signals. The motion signals can be load cell data.

Some embodiments described herein include a method for detecting bed presence of a user using temperature signals, the method including: receiving, by a computer system and from at least one temperature sensor, temperature signals collected at a bed, providing, by the computer system, the temperature signals as input to a bed presence classifier, receiving, by the computer system and from the bed presence classifier, output of a bed presence indication, and returning, by the computer system, the bed presence indication.

Embodiments described herein can optionally include one or more of the following features. For example, the bed presence classifier can be a logistic regression classifier. The method can also include determining, by the computer system, a time at which the user enters the bed as a time associated with the temperature signals received from the at least one temperature sensor. The method can include receiving, by the computer system and from at least one motion sensor, motion signals, the bed presence classifier being configured to generate the bed presence indication based on the motion signals and the temperature signals. The motion sensor can be a pressure sensor. The motion signals can be pressure signals. The motion sensor can be at least one load cell.

The method can also include providing, by the computer system, the bed presence indication as input to a sleep walking detection classifier, the sleep walking detection classifier being configured to predict likelihood of a sleepwalking event occurring during a current sleep session based at least in part on the bed presence indication. The method can include providing, by the computer system, the bed presence indication to a microclimate adjustment module, the microclimate adjustment module being configured to generate instructions that cause one or more components of the bed to adjust a microclimate of the bed based at least in part on the bed presence indication. The method can also include normalizing, by the computer system, the bed presence indication to a binary value, in which a binary value of 0 indicates that the user is absent from the bed and a binary value of 1 indicates that the user is in the bed, and returning, by the computer system, the binary value. The method can include determining, by the computer system, that the user is in the bed based on a determination that the bed presence indication exceeds a threshold value, the threshold value being 0.5. The method can also include determining, by the computer system, that the user is absent from the bed based on a determination that the bed presence indication is less than a threshold value. In some implementations, the method can include receiving, by the computer system and from the at least one temperature sensor, the temperature signals for a threshold period of time, separating, by the computer system, the collected temperature signals into 1 second frames, and processing, by the computing system, each of the 1 second frames of the collected temperature signals to provide as input to the bed presence classifier. The method can also include receiving, by the computer system and from the at least one temperature sensor, another set of temperature signals during another threshold period of time, the another threshold period of time being adjacent to the threshold period of time, in which the threshold period of time may not overlap with the another threshold period of time. The method can also include generating, by the computer system and based on the bed presence indication, instructions to actuate a home automation device.

Some embodiments described herein include a method for detecting bed presence using temperature signals and pressure signals, the method including: receiving, by a computer system and from at least one temperature sensor, temperature signals detected at a bed, receiving, by the computer system and from at least one pressure sensor, pressure signals detected at the bed, providing, by the computer system, the temperature signals and the pressure signals as input to a bed presence classifier, receiving, by the computer system and from the bed presence classifier, output of a bed presence indication, and returning, by the computer system, the bed presence indication.

Embodiments described herein can optionally include one or more of the abovementioned features. As another example, the bed presence classifier was trained to (i) differentiate the temperature signals from the pressure signals, (ii) identify a peak value in the temperature signals and a peak value in the pressure signals, the peak value in the temperature signals being within a threshold distance from the peak value in the pressure signals, and (iii) generate the bed presence indication based on correlating the peak value in the temperature signals with the peak value in the pressure signals.

Some embodiments described herein include a method for detecting bed presence using temperature signals and motion signals, the method including: receiving, by a computer system and from at least one temperature sensor, temperature signals detected at a bed, receiving, by the computer system and from at least one motion sensor, motion signals detected at the bed, providing, by the computer system, the temperature signals and the motion signals as input to a bed presence classifier, receiving, by the computer system and from the bed presence classifier, output of a bed presence indication, returning, by the computer system, the bed presence indication.

Embodiments described herein can optionally include one or more of the abovementioned features. As another example, the bed presence classifier was trained to (i) differentiate the temperature signals from the motion signals, (ii) identify a peak value in the temperature signals and a peak value in the motion signals, the peak value in the temperature signals being within a threshold distance from the peak value in the motion signals, and (iii) generate the bed presence indication based on correlating the peak value in the temperature signals with the peak value in the motion signals. The motion signals can also be pressure signals.

Some embodiments described herein include a bed system for detecting bed presence of a user, the bed system having: a bed including at least one temperature sensor attached to a top surface of the bed and a computer system in communication with the bed, the computer system configured to perform operations including: receiving, from the at least one temperature sensor, temperature signals collected at the top surface of the bed, providing the temperature signals as input to a bed presence classifier, receiving, from the bed presence classifier, output of a bed presence indication, and returning the bed presence indication.

Embodiments described herein can optionally include one or more of the abovementioned features.

The devices, system, and techniques described herein may provide one or more of the following advantages. For example, a temperature-based bed presence classifier as described throughout this disclosure are stateless. The classifier may not rely on prior states of non-occupancy in a bed. Each time interval (e.g., 1 second time interval) can be classified independently. A stateless classifier can be deployed faster while using less compute resources. This classifier can also increase efficiency and accuracy in determining bed presence information since the classifier does not require inputs of historical data or prior states of non-occupancy in the bed. Moreover, the stateless classifier can be deployed in any bed without having to be configured or re-configured for habits of a particular user of the bed.

As another example, the disclosed temperature-based bed presence detection techniques are less sensitive to motion artifacts compared to other sensing modalities (such as pressure sensor, piezoelectric, and/or load cells). Less sensitivity to minor movements on the bed can increase accuracy of the disclosed techniques in detecting bed presence. Temperature-based detection can rely on an array of sensors, or multiple sensors, which can cover redundancy. The various temperature values collected from the array of sensors or multiple sensors can accurately identify and distinguish microclimates from environmental conditions. Less interference with temperature readings at a surface of the bed from temperature signal collection by the array of sensors, or multiple sensors, can result in accurate readings of the microclimates of the bed that can be easily differentiated and parsed from the environmental climate.

The temperature-based bed presence detection techniques are also stable and consistent regardless of a firmness level of a mattress. For example, the disclosed techniques can provide accurate temperature readings to determine bed presence when the mattress is set to a high firmness level (e.g., firmer) as well as when the mattress is set to a low firmness level (e.g., softer). Similarly, because the disclosed techniques accurately detect temperature regardless of firmness level of the mattress, the disclosed techniques also can accurately detect temperature regardless of a type of bed chamber used in the bed. For example, the disclosed techniques can work with a variety of bed chamber types, including but not limited to foam-filled and spring-based beds. The disclosed techniques can therefore be deployed and used in a variety of bed systems to accurately and efficiently detect bed presence.

As another example, combined temperature and pressure-based presence detection techniques can increase accuracy in detecting bed presence. When different phenomenon, such as temperature (e.g., from temperature sensors) and motion changes (e.g., from pressure sensors, load cells, and/or piezo-electrics), are detected, they can be processed, analyzed, and/or synthesized to improve accuracy in determining bed presence.

As yet another example, the disclosed techniques can be combined with microclimate technologies to improve user comfortability and reduce energy and power consumption. The disclosed techniques can work with existing microclimate technologies, including but not limited to bed heaters/coolers, bedroom heating/cooling units, etc., to maintain user-comfortable bed temperatures and microclimates. The disclosed techniques can also be used to reduce energy and power consumption by turning on microclimate systems only when the user is detected to be in the bed. Moreover, in some implementations, even if microclimate actuators, such as heaters and/or coolers, may interfere with temperature-sensor-based bed presence detection, other sensors that are part of the bed system, such as pressure sensors and/or load cells, can be used to detect bed presence and ensure that accuracy in bed presence detection techniques is maintained.

The details of one or more implementations are set forth in the accompanying drawings and the description below. Other features, aspects and potential advantages will be apparent from the accompanying description and figures.

### DESCRIPTION OF DRAWINGS

FIG. 1 shows an example air bed system.

FIG. 2 is a block diagram of an example of various components of an air bed system.

FIG. 3 shows an example environment including a bed in communication with devices located in and around a home.

FIGS. 4A and 4B are block diagrams of example data processing systems that can be associated with a bed.

FIGS. 5 and 6 are block diagrams of examples of motherboards that can be used in a data processing system associated with a bed.

FIG. 7 is a block diagram of an example of a daughterboard that can be used in a data processing system associated with a bed.

FIG. 8 is a block diagram of an example of a motherboard with no daughterboard that can be used in a data processing system associated with a bed.

FIG. 9 is a block diagram of an example of a sensory array that can be used in a data processing system associated with a bed.

FIG. 10 is a block diagram of an example of a control array that can be used in a data processing system associated with a bed

FIG. 11 is a block diagram of an example of a computing device that can be used in a data processing system associated with a bed.

FIGS. 12-16 are block diagrams of example cloud services that can be used in a data processing system associated with a bed.

FIG. 17 is a block diagram of an example of using a data processing system that can be associated with a bed to automate peripherals around the bed.

FIG. 18 is a schematic diagram that shows an example of a computing device and a mobile computing device.

FIG. 19 is a conceptual diagram of a bed system for detecting bed presence using at least temperature signals.

FIG. 20A is a flowchart of a process for detecting bed presence using temperature signals.

FIG. 20B is a conceptual diagram of a process for detecting bed presence using temperature signals.

FIG. 21A is a flowchart of a process for detecting bed presence using temperature and pressure signals.

FIG. 21B is a conceptual diagram of a process for detecting bed presence using temperature and pressure signals.

FIG. 22 is a swimlane diagram of an example process for training and using machine-learning classifiers to determine bed presence of a user in a bed system.

FIG. 23 is a swimlane diagram of an example process for detecting bed presence using temperature and pressure signals.

Like reference symbols in the various drawings indicate like elements.

### DETAILED DESCRIPTION

This document generally relates to automatically detecting when a user is present or absent from a bed system. Bed presence (e.g., occupancy) can be detected based on measuring changes in temperature that are detected by at least one temperature sensor of the bed system. In some implementations, temperature signals can be combined with pressure signals (e.g., from pressure sensors) and/or other motion-based signals (e.g., from load cells) to accurately determine whether a user is present or absent from the bed system. Bed presence indications determined using the disclosed technology can then be provided to a data pipeline and used in one or more downstream processes. For example, the bed presence indications can be used to classify sleep stages of the user. The bed presence indications can also be used to classify and/or determine sleepwalking events of the user. The bed presence indications can be used to determine one or more adjustments to a microclimate of the bed system. The bed presence indications can also be used in one or more other processes, determinations, and/or controls of home automation devices.

Example Airbed Hardware

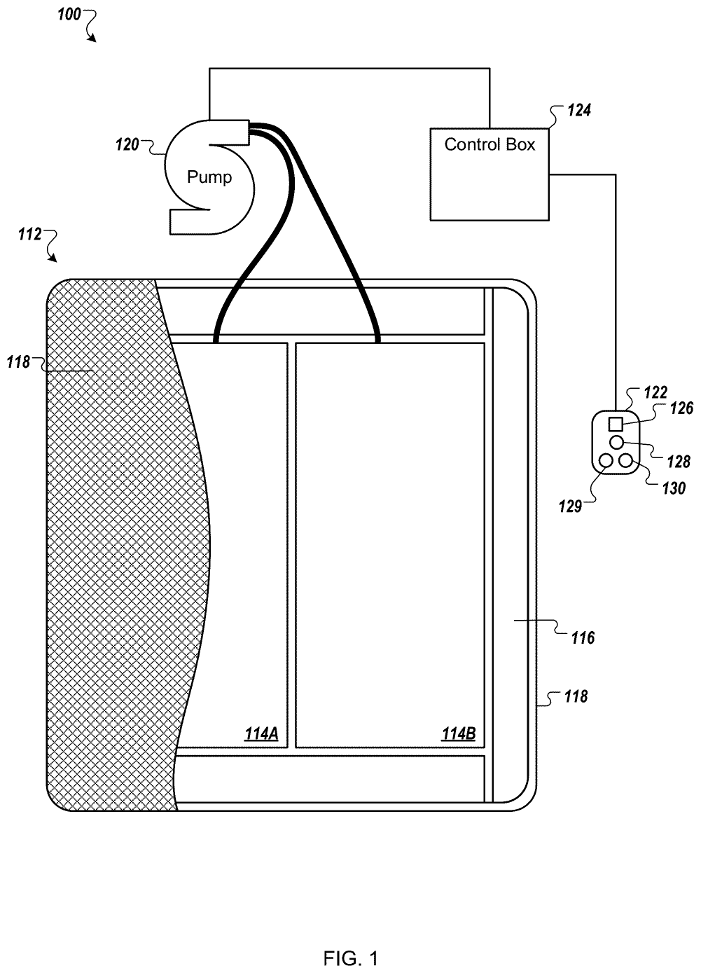

FIG. 1 shows an example air bed system 100 that includes a bed 112. The bed 112 can be a mattress that includes at least one air chamber 114 surrounded by a resilient border 116 and encapsulated by bed ticking 118. The resilient border 116 can comprise any suitable material, such as foam. In some embodiments, the resilient border 116 can combine with a top layer or layers of foam (not shown in FIG. 1) to form an upside down foam tub. In other embodiments, mattress structure can be varied as suitable for the application.

As illustrated in FIG. 1, the bed 112 can be a two chamber design having first and second fluid chambers, such as a first air chamber 114A and a second air chamber 114B. Sometimes, the bed 112 can include chambers for use with fluids other than air that are suitable for the application. For example, the fluids can include liquid. In some embodiments, such as single beds or kids' beds, the bed 112 can include a single air chamber 114A or 114B or multiple air chambers 114A and 114B. Although not depicted, sometimes, the bed 112 can include additional air chambers.

The first and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120. Moreover, sometimes, the pump 120 can be in wireless communication (e.g., via a home network, WIFI, BLUETOOTH, or other wireless network) with a mobile device via the control box 124. The mobile device can include but is not limited to the user's smartphone, cell phone, laptop, tablet, computer, wearable device, home automation device, or other computing device. A mobile application can be presented at the mobile device and provide functionality for the user to control the bed 112 and view information about the bed 112. The user can input commands in the mobile application presented at the mobile device. The inputted commands can be transmitted to the control box 124, which can operate the pump 120 based upon the commands.

The remote control 122 can include a display 126, an output selecting mechanism 128, a pressure increase button 129, and a pressure decrease button 130. The remote control 122 can include one or more additional output selecting mechanisms and/or buttons. The display 126 can present information to the user about settings of the bed 112. For example, the display 126 can present pressure settings of both the first and second air chambers 114A and 114B or one of the first and second air chambers 114A and 114B. Sometimes, the display 126 can be a touch screen, and can receive input from the user indicating one or more commands to control pressure in the first and second air chambers 114A and 114B and/or other settings of the bed 112.

The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can by a physical control (e.g., switch or button) or an input control presented on the display 126. Alternatively, separate remote control units can be provided for each air chamber 114A and 114B and can each include the ability to control multiple air chambers. Pressure increase and decrease buttons 129 and 130 can allow the user to increase or decrease the pressure, respectively, in the air chamber selected with the output selecting mechanism 128. Adjusting the pressure within the selected air chamber can cause a corresponding adjustment to the firmness of the respective air chamber. In some embodiments, the remote control 122 can be omitted or modified as appropriate for an application. For example, as mentioned above, the bed 112 can be controlled by a mobile device in wired or wireless communication with the bed 112.

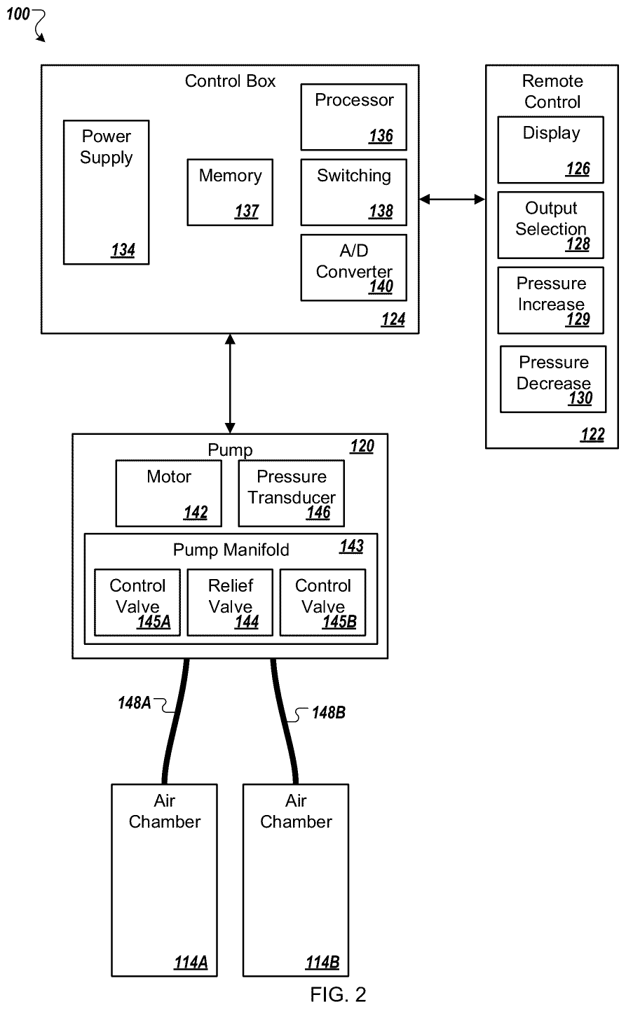

FIG. 2 is a block diagram of an example of various components of an air bed system. For example, these components can be used in the example air bed system 100. As shown in FIG. 2, the control box 124 can include a power supply 134, a processor 136, a memory 137, a switching mechanism 138, and an analog to digital (A/D) converter 140. The switching mechanism 138 can be, for example, a relay or a solid state switch. In some implementations, the switching mechanism 138 can be located in the pump 120 rather than the control box 124.

The pump 120 and the remote control 122 can be in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138, and are operable to regulate the flow of fluid between the pump 120 and first and second air chambers 114A and 114B, respectively.

In some implementations, the pump 120 and the control box 124 can be provided and packaged as a single unit. In some implementations, the pump 120 and the control box 124 can be provided as physically separate units. In yet some implementations, the control box 124, the pump 120, or both can be integrated within or otherwise contained within a bed frame, foundation, or bed support structure that supports the bed 112. Sometimes, the control box 124, the pump 120, or both can be located outside of a bed frame, foundation, or bed support structure (as shown in the example in FIG. 1).

The example air bed system 100 depicted in FIG. 2 includes the two air chambers 114A and 114B and the single pump 120 of the bed 112 depicted in FIG. 1. However, other implementations can include an air bed system having two or more air chambers and one or more pumps incorporated into the air bed system to control the air chambers. For example, a separate pump can be associated with each air chamber of the air bed system. As another example, a pump can be associated with multiple chambers of the air bed system. A first pump can, for example, be associated with air chambers that extend longitudinally from a left side to a midpoint of the air bed system 100 and a second pump can be associated with air chambers that extend longitudinally from a right side to the midpoint of the air bed system 100. Separate pumps can allow each air chamber to be inflated or deflated independently and/or simultaneously. Furthermore, additional pressure transducers can be incorporated into the air bed system 100 such that, for example, a separate pressure transducer can be associated with each air chamber.

As an illustrative example, in use, the processor 136 can send a decrease pressure command to one of air chambers 114A or 114B, and the switching mechanism 138 can convert the low voltage command signals sent by the processor 136 to higher operating voltages sufficient to operate the relief valve 144 of the pump 120 and open the respective control valve 145A or 145B. Opening the relief valve 144 can allow air to escape from the air chamber 114A or 114B through the respective air tube 148A or 148B. During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 in order to convey the pressure information to the user. The processor 136 can also send the digital signal to one or more other devices in wired or wireless communication with the air bed system, including but not limited to mobile devices such as smartphones, cellphones, tablets, computers, wearable devices, and home automation devices. As a result, the user can view pressure information associated with the air bed system at their mobile device instead of at, or in addition to, the remote control 122.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B in order to increase the firmness of the chamber, the pressure transducer 146 can sense pressure within the pump manifold 143. Again, the pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126 in order to convey the pressure information to the user.

Generally speaking, during an inflation or deflation process, the pressure sensed within the pump manifold 143 can provide an approximation of the pressure within the respective air chamber that is in fluid communication with the pump manifold 143. An example method of obtaining a pump manifold pressure reading that is substantially equivalent to the actual pressure within an air chamber includes turning off the pump 120, allowing the pressure within the air chamber 114A or 114B and the pump manifold 143 to equalize, and then sensing the pressure within the pump manifold 143 with the pressure transducer 146. Thus, providing a sufficient amount of time to allow the pressures within the pump manifold 143 and chamber 114A or 114B to equalize can result in pressure readings that are accurate approximations of actual pressure within air chamber 114A or 114B. In some implementations, the pressure of the air chambers 114A and/or 114B can be continuously monitored using multiple pressure sensors (not shown). The pressure sensors can be positioned within the air chambers 114A and/or 114B. The pressure sensors can also be fluidly connected to the air chambers 114A and 114B, such as along the air tubes 148A and 148B.

In some implementations, information collected by the pressure transducer 146 can be analyzed to determine various states of a user laying on the bed 112. For example, the processor 136 can use information collected by the pressure transducer 146 to determine a heartrate or a respiration rate for the user laying on the bed 112. As an illustrative example, the user can be laying on a side of the bed 112 that includes the chamber 114A. The pressure transducer 146 can monitor fluctuations in pressure of the chamber 114A, and this information can be used to determine the user's heartrate and/or respiration rate. As another example, additional processing can be performed using the collected data to determine a sleep state of the user (e.g., awake, light sleep, deep sleep). For example, the processor 136 can determine when the user falls asleep and, while asleep, the various sleep states (e.g., sleep stages) of the user. Based on the determined heartrate, respiration rate, and/or sleep states of the user, the processor 136 can determine information about the user's sleep quality. The processor 136 can, for example, determine how well the user slept during a particular sleep cycle. The processor 136 can also determine user sleep cycle trends. Accordingly, the processor 136 can generate recommendations to improve the user's sleep quality and overall sleep cycle. Information that is determined about the user's sleep cycle (e.g., heartrate, respiration rate, sleep states, sleep quality, recommendations to improve sleep quality, etc.) can be transmitted to the user's mobile device and presented in a mobile application, as described above.

Additional information associated with the user of the air bed system 100 that can be determined using information collected by the pressure transducer 146 includes motion of the user, presence of the user on a surface of the bed 112, weight of the user, heart arrhythmia of the user, snoring of the user or another user on the air bed system, and apnea of the user. One or more other health conditions of the user can also be determined based on the information collected by the pressure transducer 146. Taking user presence detection for example, the pressure transducer 146 can be used to detect the user's presence on the bed 112, e.g., via a gross pressure change determination and/or via one or more of a respiration rate signal, heartrate signal, and/or other biometric signals. Detection of the user's presence on the bed 112 can be beneficial to determine, by the processor 136, one or more adjustments to make to settings of the bed 112 (e.g., adjusting a firmness of the bed 112 when the user is present to a user-preferred firmness setting) and/or peripheral devices (e.g., turning off lights when the user is present, activating a heating or cooling system, etc.).

For example, a simple pressure detection process can identify an increase in pressure as an indication that the user is present on the bed 112. As another example, the processor 136 can determine that the user is present on the bed 112 if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present on the bed 112. The presence of rhythmic fluctuations can be identified as being caused by respiration or heart rhythm (or both) of the user. The detection of respiration or a heartbeat can distinguish between the user being present on the bed and another object (e.g., a suitcase, a pet, a pillow, etc.) being placed upon the bed.

In some implementations, fluctuations in pressure can be measured at the pump 120. For example, one or more pressure sensors can be located within one or more internal cavities of the pump 120 to detect fluctuations in pressure within the pump 120. The fluctuations in pressure detected at the pump 120 can indicate fluctuations in pressure in one or both of the chambers 114A and 114B. One or more sensors located at the pump 120 can be in fluid communication with one or both of the chambers 114A and 114B, and the sensors can be operative to determine pressure within the chambers 114A and 114B. The control box 124 can be configured to determine at least one vital sign (e.g., heartrate, respiratory rate) based on the pressure within the chamber 114A or the chamber 114B.

In some implementations, the control box 124 can analyze a pressure signal detected by one or more pressure sensors to determine a heartrate, respiration rate, and/or other vital signs of the user lying or sitting on the chamber 114A and/or 114B. More specifically, when a user lies on the bed 112 and is positioned over the chamber 114A, each of the user's heart beats, breaths, and other movements (e.g., hand, arm, leg, foot, or other gross body movements) can create a force on the bed 112 that is transmitted to the chamber 114A. As a result of the force input applied to the chamber 114A from the user's movement, a wave can propagate through the chamber 114A and into the pump 120. A pressure sensor located at the pump 120 can detect the wave, and thus the pressure signal outputted by the sensor can indicate a heartrate, respiratory rate, or other information regarding the user.

With regard to sleep state, the air bed system 100 can determine the user's sleep state by using various biometric signals such as heartrate, respiration, and/or movement of the user. While the user is sleeping, the processor 136 can receive one or more of the user's biometric signals (e.g., heartrate, respiration, motion, etc.) and can determine the user's present sleep state based on the received biometric signals. In some implementations, signals indicating fluctuations in pressure in one or both of the chambers 114A and 114B can be amplified and/or filtered to allow for more precise detection of heartrate and respiratory rate.

Sometimes, the processor 136 can also receive additional biometric signals of the user from one or more other sensors or sensor arrays that are positioned on or otherwise integrated into the air bed system 100. For example, one or more sensors can be attached or removably attached to a top surface of the air bed system 100 and configured to detect signals such as heartrate, respiration rate, and/or motion of the user. The processor 136 can then combine biometric signals received from pressure sensors located at the pump 120, the pressure transducer 146, and/or the sensors positioned throughout the air bed system 100 to generate accurate and more precise heartrate, respiratory rate, and other information about the user and the user's sleep quality.

Sometimes, the control box 124 can perform a pattern recognition algorithm or other calculation based on the amplified and filtered pressure signal(s) to determine the user's heartrate and/or respiratory rate. For example, the algorithm or calculation can be based on assumptions that a heartrate portion of the signal has a frequency in a range of 0.5-4.0 Hz and that a respiration rate portion of the signal has a frequency in a range of less than 1 Hz. Sometimes, the control box 124 can use one or more machine learning models to determine the user's heartrate, respiratory rate, or other health information. The models can be trained using training data that includes training pressure signals and expected heartrates and/or respiratory rates. Sometimes, the control box 124 can determine the user's heartrate, respiratory rate, or other health information by using a lookup table that corresponds to sensed pressure signals.

The control box 124 can also be configured to determine other characteristics of the user based on the received pressure signal, such as blood pressure, tossing and turning movements, rolling movements, limb movements, weight, presence or lack of presence of the user, and/or the identity of the user.

For example, the pressure transducer 146 can be used to monitor the air pressure in the chambers 114A and 114B of the bed 112. If the user on the bed 112 is not moving, the air pressure changes in the air chamber 114A or 114B can be relatively minimal, and can be attributable to respiration and/or heartbeat. When the user on the bed 112 is moving, however, the air pressure in the mattress can fluctuate by a much larger amount. Thus, the pressure signals generated by the pressure transducer 146 and received by the processor 136 can be filtered and indicated as corresponding to motion, heartbeat, or respiration. The processor 136 can also attribute such fluctuations in air pressure to sleep quality of the user. Such attributions can be determined based on applying one or more machine learning models and/or algorithms to the pressure signals generated by the pressure transducer 146. For example, if the user shifts and turns a lot during a sleep cycle (for example, in comparison to historic trends of the user's sleep cycles), the processor 136 can determine that the user experienced poor sleep during that particular sleep cycle.

In some implementations, rather than performing the data analysis in the control box 124 with the processor 136, a digital signal processor (DSP) can be provided to analyze the data collected by the pressure transducer 146. Alternatively, the data collected by the pressure transducer 146 can be sent to a cloud-based computing system for remote analysis.

In some implementations, the example air bed system 100 further includes a temperature controller configured to increase, decrease, or maintain a temperature of the bed 112, for example for the comfort of the user. For example, a pad (e.g., mat, layer, etc.) can be placed on top of or be part of the bed 112, or can be placed on top of or be part of one or both of the chambers 114A and 114B. Air can be pushed through the pad and vented to cool off the user on the bed 112. Additionally or alternatively, the pad can include a heating element that can be used to keep the user warm. In some implementations, the temperature controller can receive temperature readings from the pad. The temperature controller can determine whether the temperature readings are less than or greater than some threshold range and/or value. Based on this determination, the temperature controller can actuate components to push air through the pad to cool off the user or active the heating element. In some implementations, separate pads are used for different sides of the bed 112 (e.g., corresponding to the locations of the chambers 114A and 114B) to provide for differing temperature control for the different sides of the bed 112. Each pad can therefore be selectively controlled by the temperature controller to provide cooling or heating that is preferred by each of the users on the different sides of the bed 112. For example, a first user on a left side of the bed 112 can prefer to have their side of the bed 112 cooled during the night while a second user on a right side of the bed 112 can prefer to have their side of the bed 112 warmed during the night.

In some implementations, the user of the air bed system 100 can use an input device, such as the remote control 122 or a mobile device as described above, to input a desired temperature for a surface of the bed 112 (or for a portion of the surface of the bed 112, for example at a foot region, a lumbar or waist region, a shoulder region, and/or a head region of the bed 112). The desired temperature can be encapsulated in a command data structure that includes the desired temperature and also identifies the temperature controller as the desired component to be controlled. The command data structure can then be transmitted via Bluetooth or another suitable communication protocol (e.g., WIFI, a local network, etc.) to the processor 136. In various examples, the command data structure is encrypted before being transmitted. The temperature controller can then configure its elements to increase or decrease the temperature of the pad depending on the temperature input provided at the remote control 122 by the user.

In some implementations, data can be transmitted from a component back to the processor 136 or to one or more display devices, such as the display 126 of the remote controller 122. For example, the current temperature as determined by a sensor element of temperature controller, the pressure of the bed, the current position of the foundation or other information can be transmitted to control box 124. The control box 124 can then transmit the received information to the remote control 122, where the information can be displayed to the user (e.g., on the display 126). As described above, the control box 124 can also transmit the received information to a mobile device (e.g., smartphone, cellphone, laptop, tablet, computer, wearable device, or home automation device) to be displayed in a mobile application or other graphical user interface (GUI) to the user.

In some implementations, the example air bed system 100 further includes an adjustable foundation and an articulation controller configured to adjust the position of a bed (e.g., the bed 112) by adjusting the adjustable foundation that supports the bed. For example, the articulation controller can adjust the bed 112 from a flat position to a position in which a head portion of a mattress of the bed is inclined upward (e.g., to facilitate a user sitting up in bed and/or watching television). The bed 112 can also include multiple separately articulable sections. As an illustrative example, the bed 112 can include one or more of a head portion, a lumbar/waist portion, a leg portion, and/or a foot portion, all of which can be separately articulable. As another example, portions of the bed 112 corresponding to the locations of the chambers 114A and 114B can be articulated independently from each other, to allow one user positioned on the bed 112 surface to rest in a first position (e.g., a flat position or other desired position) while a second user rests in a second position (e.g., a reclining position with the head raised at an angle from the waist or another desired position). Separate positions can also be set for two different beds (e.g., two twin beds placed next to each other). The foundation of the bed 112 can include more than one zone that can be independently adjusted.

Sometimes, the bed 112 can be adjusted to one or more user-defined positions based on user input and/or user preferences. For example, the bed 112 can automatically adjust, by the articulation controller, to one or more user-defined settings. As another example, the user can control the articulation controller to adjust the bed 112 to one or more user-defined positions. Sometimes, the bed 112 can be adjusted to one or more positions that may provide the user with improved or otherwise improve sleep and sleep quality. For example, a head portion on one side of the bed 112 can be automatically articulated, by the articulation controller, when one or more sensors of the air bed system 100 detect that a user sleeping on that side of the bed 112 is snoring. As a result, the user's snoring can be mitigated so that the snoring does not wake up another user sleeping in the bed 112.

In some implementations, the bed 112 can be adjusted using one or more devices in communication with the articulation controller or instead of the articulation controller. For example, the user can change positions of one or more portions of the bed 112 using the remote control 122 described above. The user can also adjust the bed 112 using a mobile application or other graphical user interface presented at a mobile computing device of the user.

The articulation controller can also be configured to provide different levels of massage to one or more portions of the bed 112 for one or more users on the bed 112. The user(s) can also adjust one or more massage settings for different portions of the bed 112 using the remote control 122 and/or a mobile device in communication with the air bed system 100, as described above.

Example of a Bed in a Bedroom Environment

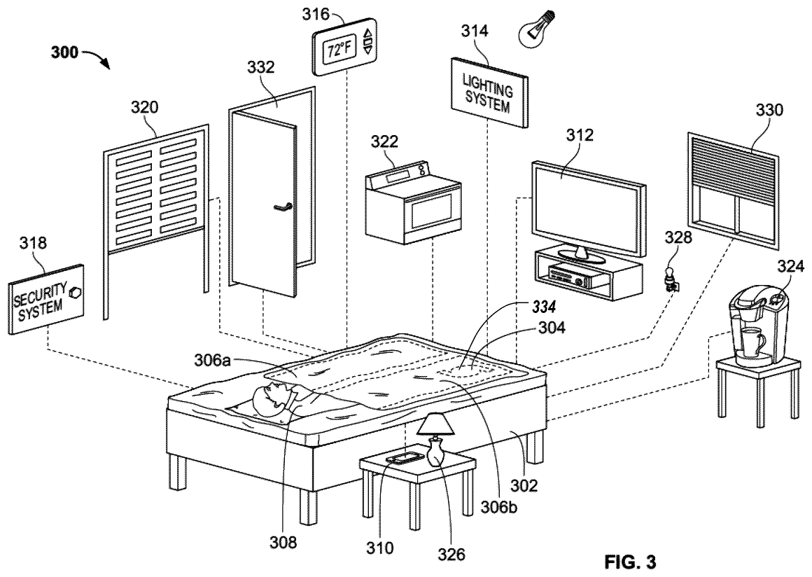

FIG. 3 shows an example environment 300 including a bed 302 in communication with devices located in and around a home. In the example shown, the bed 302 includes pump 304 for controlling air pressure within two air chambers 306a and 306b (as described above with respect to the air chambers 114A and 114B). The pump 304 additionally includes circuitry 334 for controlling inflation and deflation functionality performed by the pump 304. The circuitry 334 is further programmed to detect fluctuations in air pressure of the air chambers 306a-b and uses the detected fluctuations in air pressure to identify bed presence of a user 308, sleep state of the user 308, movement of the user 308, and biometric signals of the user 308, such as heartrate and respiration rate. The detected fluctuations in air pressure can also be used to detect when the user 308 is snoring and whether the user 308 has sleep apnea or other health conditions. Moreover, the detected fluctuations in air pressure can be used to determine an overall sleep quality of the user 308.

In the example shown, the pump 304 is located within a support structure of the bed 302 and the control circuitry 334 for controlling the pump 304 is integrated with the pump 304. In some implementations, the control circuitry 334 is physically separate from the pump 304 and is in wireless or wired communication with the pump 304. In some implementations, the pump 304 and/or control circuitry 334 are located outside of the bed 302. In some implementations, various control functions can be performed by systems located in different physical locations. For example, circuitry for controlling actions of the pump 304 can be located within a pump casing of the pump 304 while control circuitry 334 for performing other functions associated with the bed 302 can be located in another portion of the bed 302, or external to the bed 302. As another example, the control circuitry 334 located within the pump 304 can communicate with control circuitry 334 at a remote location through a LAN or WAN (e.g., the internet). As yet another example, the control circuitry 334 can be included in the control box 124 of FIGS. 1 and 2.

In some implementations, one or more devices other than, or in addition to, the pump 304 and control circuitry 334 can be utilized to identify user bed presence, sleep state, movement, biometric signals, and other information (e.g., sleep quality and/or health related) about the user 308. For example, the bed 302 can include a second pump in addition to the pump 304, with each of the two pumps connected to a respective one of the air chambers 306a-b. For example, the pump 304 can be in fluid communication with the air chamber 306b to control inflation and deflation of the air chamber 306b as well as detect user signals for a user located over the air chamber 306b, such as bed presence, sleep state, movement, and biometric signals. The second pump can then be in fluid communication with the air chamber 306a and used to control inflation and deflation of the air chamber 306a as well as detect user signals for a user located over the air chamber 306a.

As another example, the bed 302 can include one or more pressure sensitive pads or surface portions that are operable to detect movement, including user presence, user motion, respiration, and heartrate. A first pressure sensitive pad can be incorporated into a surface of the bed 302 over a left portion of the bed 302, where a first user would normally be located during sleep, and a second pressure sensitive pad can be incorporated into the surface of the bed 302 over a right portion of the bed 302, where a second user would normally be located during sleep. The movement detected by the one or more pressure sensitive pads or surface portions can be used by control circuitry 334 to identify user sleep state, bed presence, or biometric signals for each of the users. The pressure sensitive pads can also be removable rather than incorporated into the surface of the bed 302.

The bed 302 can also include one or more temperature sensors and/or array of sensors that are operable to detect temperatures in microclimates of the bed 302. Detected temperatures in different microclimates of the bed 302 can be used by the control circuitry 334 to determine one or more modifications to the user 308's sleep environment. For example, a temperature sensor located near a core region of the bed 302 where the user 308 rests can detect high temperature values. Such high temperature values can indicate that the user 308 is warm. To lower the user's body temperature in this microclimate, the control circuitry 334 can determine that a cooling element of the bed 302 can be activated. As another example, the control circuitry 334 can determine that a cooling unit in the home can be automatically activated to cool an ambient temperature in the environment 300.

The control circuitry 334 can also process a combination of signals sensed by different sensors that are integrated into, positioned on, or otherwise in communication with the bed 112. For example, pressure and temperature signals can be processed by the control circuitry 334 to more accurately determine one or more health conditions of the user 308 and/or sleep quality of the user 308. Acoustic signals detected by one or more microphones or other audio sensors can also be used in combination with pressure or motion sensors in order to determine when the user 308 snores, whether the user 308 has sleep apnea, and/or overall sleep quality of the user 308. Combinations of one or more other sensed signals are also possible for the control circuitry 334 to more accurately determine one or more health and/or sleep conditions of the user 308.

Accordingly, information detected by one or more sensors or other components of the bed 112 (e.g., motion information) can be processed by the control circuitry 334 and provided to one or more user devices, such as a user device 310 for presentation to the user 308 or to other users. The information can be presented in a mobile application or other graphical user interface at the user device 310. The user 308 can view different information that is processed and/or determined by the control circuitry 334 and based the signals that are detected by components of the bed 302. For example, the user 308 can view their overall sleep quality for a particular sleep cycle (e.g., the previous night), historic trends of their sleep quality, and health information. The user 308 can also adjust one or more settings of the bed 302 (e.g., increase or decrease pressure in one or more regions of the bed 302, incline or decline different regions of the bed 302, turn on or off massage features of the bed 302, etc.) using the mobile application that is presented at the user device 310.

In the example depicted in FIG. 3, the user device 310 is a mobile phone; however, the user device 310 can also be any one of a tablet, personal computer, laptop, a smartphone, a smart television (e.g., a television 312), a home automation device, or other user device capable of wired or wireless communication with the control circuitry 334, one or more other components of the bed 302, and/or one or more devices in the environment 300. The user device 310 can be in communication with the control circuitry 334 of the bed 302 through a network or through direct point-to-point communication. For example, the control circuitry 334 can be connected to a LAN (e.g., through a WIFI router) and communicate with the user device 310 through the LAN. As another example, the control circuitry 334 and the user device 310 can both connect to the Internet and communicate through the Internet. For example, the control circuitry 334 can connect to the Internet through a WIFI router and the user device 310 can connect to the Internet through communication with a cellular communication system. As another example, the control circuitry 334 can communicate directly with the user device 310 through a wireless communication protocol, such as Bluetooth. As yet another example, the control circuitry 334 can communicate with the user device 310 through a wireless communication protocol, such as ZigBee, Z-Wave, infrared, or another wireless communication protocol suitable for the application. As another example, the control circuitry 334 can communicate with the user device 310 through a wired connection such as, for example, a USB connector, serial/RS232, or another wired connection suitable for the application.

As mentioned above, the user device 310 can display a variety of information and statistics related to sleep, or user 308's interaction with the bed 302. For example, a user interface displayed by the user device 310 can present information including amount of sleep for the user 308 over a period of time (e.g., a single evening, a week, a month, etc.), amount of deep sleep, ratio of deep sleep to restless sleep, time lapse between the user 308 getting into bed and the user 308 falling asleep, total amount of time spent in the bed 302 for a given period of time, heartrate for the user 308 over a period of time, respiration rate for the user 308 over a period of time, or other information related to user interaction with the bed 302 by the user 308 or one or more other users of the bed 302. In some implementations, information for multiple users can be presented on the user device 310, for example information for a first user positioned over the air chamber 306a can be presented along with information for a second user positioned over the air chamber 306b. In some implementations, the information presented on the user device 310 can vary according to the age of the user 308. For example, the information presented on the user device 310 can evolve with the age of the user 308 such that different information is presented on the user device 310 as the user 308 ages as a child or an adult.

The user device 310 can also be used as an interface for the control circuitry 334 of the bed 302 to allow the user 308 to enter information and/or adjust one or more settings of the bed 302. The information entered by the user 308 can be used by the control circuitry 334 to provide better information to the user 308 or to various control signals for controlling functions of the bed 302 or other devices. For example, the user 308 can enter information such as weight, height, and age of the user 308. The control circuitry 334 can use this information to provide the user 308 with a comparison of the user 308's tracked sleep information to sleep information of other people having similar weights, heights, and/or ages as the user 308. The control circuitry 308 can also use this information to more accurately determine overall sleep quality and/or health of the user 308 based on information that is detected by one or more components (e.g., sensors) of the bed 302.

As another example, and as mentioned above, the user 308 can use the user device 310 as an interface for controlling air pressure of the air chambers 306a and 306b, for controlling various recline or incline positions of the bed 302, for controlling temperature of one or more surface temperature control devices of the bed 302, or for allowing the control circuitry 334 to generate control signals for other devices (as described in greater detail below).

In some implementations, the control circuitry 334 of the bed 302 can communicate with other devices or systems in addition to or instead of the user device 310. For example, the control circuitry 334 can communicate with the television 312, a lighting system 314, a thermostat 316, a security system 318, home automation devices, and/or other household devices, including but not limited to an oven 322, a coffee maker 324, a lamp 326, and/or a nightlight 328. Other examples of devices and/or systems that the control circuitry 334 can communicate with include a system for controlling window blinds 330, one or more devices for detecting or controlling the states of one or more doors 332 (such as detecting if a door is open, detecting if a door is locked, or automatically locking a door), and a system for controlling a garage door 320 (e.g., control circuitry 334 integrated with a garage door opener for identifying an open or closed state of the garage door 320 and for causing the garage door opener to open or close the garage door 320). Communications between the control circuitry 334 of the bed 302 and other devices can occur through a network (e.g., a LAN or the Internet) or as point-to-point communication (e.g., using Bluetooth, radio communication, or a wired connection). In some implementations, control circuitry 334 of different beds 302 can communicate with different sets of devices. For example, a kid's bed may not communicate with and/or control the same devices as an adult bed. In some embodiments, the bed 302 can evolve with the age of the user such that the control circuitry 334 of the bed 302 communicates with different devices as a function of age of the user of that bed 302.

The control circuitry 334 can receive information and inputs from other devices/systems and use the received information and inputs to control actions of the bed 302 and/or other devices. For example, the control circuitry 334 can receive information from the thermostat 316 indicating a current environmental temperature for a house or room in which the bed 302 is located. The control circuitry 334 can use the received information (along with other information, such as signals detected from one or more sensors of the bed 302) to determine if a temperature of all or a portion of the surface of the bed 302 should be raised or lowered. The control circuitry 334 can then cause a heating or cooling mechanism of the bed 302 to raise or lower the temperature of the surface of the bed 302. The control circuitry 334 can also cause a heating or cooling unit of the house or room in which the bed 302 is located to raise or lower the ambient temperature surrounding the bed 302. Thus, by adjusting the temperature of the bed 302 and/or the room in which the bed 302 is located, the user 308 can experience more improved sleep quality and comfort.

As an example, the user 308 can indicate a desired sleeping temperature of 74 degrees while a second user of the bed 302 indicates a desired sleeping temperature of 72 degrees. The thermostat 316 can transmit signals indicating room temperature at predetermined times to the control circuitry 334. The thermostat 316 can also send a continuous stream of detected temperature values of the room to the control circuitry 334. The transmitted signal(s) can indicate to the control circuitry 334 that the current temperature of the bedroom is 72 degrees. The control circuitry 334 can identify that the user 308 has indicated a desired sleeping temperature of 74 degrees, and can accordingly send control signals to a heating pad located on the user 308's side of the bed to raise the temperature of the portion of the surface of the bed 302 where the user 308 is located until the user 308's desired temperature is achieved. Moreover, the control circuitry 334 can sent control signals to the thermostat 316 and/or a heating unit in the house to raise the temperature in the room in which the bed 302 is located.

The control circuitry 334 can generate control signals to control other devices and propagate the control signals to the other devices. In some implementations, the control signals are generated based on information collected by the control circuitry 334, including information related to user interaction with the bed 302 by the user 308 and/or one or more other users. Information collected from one or more other devices other than the bed 302 can also be used when generating the control signals. For example, information relating to environmental occurrences (e.g., environmental temperature, environmental noise level, and environmental light level), time of day, time of year, day of the week, or other information can be used when generating control signals for various devices in communication with the control circuitry 334 of the bed 302.

For example, information on the time of day can be combined with information relating to movement and bed presence of the user 308 to generate control signals for the lighting system 314. The control circuitry 334 can, based on detected pressure signals of the user 308 on the bed 302, determine when the user 308 is presently in the bed 302 and when the user 308 falls asleep. Once the control circuitry 334 determines that the user has fallen asleep, the control circuitry 334 can transmit control signals to the lighting system 314 to turn off lights in the room in which the bed 302 is located, to lower the window blinds 330 in the room, and/or to activate the nightlight 328. Moreover, the control circuitry 334 can receive input from the user 308 (e.g., via the user device 310) that indicates a time at which the user 308 would like to wake up. When that time approaches, the control circuitry 334 can transmit control signals to one or more devices in the environment 300 to control devices that may cause the user 308 to wake up. For example, the control signals can be sent to a home automation device that controls multiple devices in the home. The home automation device can be instructed, by the control circuitry 334, to raise the window blinds 330, turn off the nightlight 328, turn on lighting beneath the bed 302, start the coffee machine 324, change a temperature in the house via the thermostat 316, or perform some other home automation. The home automation device can also be instructed to activate an alarm that can cause the user 308 to wake up. Sometimes, the user 308 can input information at the user device 310 that indicates what actions can be taken by the home automation device or other devices in the environment 300.

In some implementations, rather than or in addition to providing control signals for one or more other devices, the control circuitry 334 can provide collected information (e.g., information related to user movement, bed presence, sleep state, or biometric signals for the user 308) to one or more other devices to allow the one or more other devices to utilize the collected information when generating control signals. For example, the control circuitry 334 of the bed 302 can provide information relating to user interactions with the bed 302 by the user 308 to a central controller (not shown) that can use the provided information to generate control signals for various devices, including the bed 302.

The central controller can, for example, be a hub device that provides a variety of information about the user 308 and control information associated with the bed 302 and one or more other devices in the house. The central controller can include one or more sensors that detect signals that can be used by the control circuitry 334 and/or the central controller to determine information about the user 308 (e.g., biometric or other health data, sleep quality, etc.). The sensors can detect signals including but not limited to ambient light, temperature, humidity, volatile organic compound(s), pulse, motion, and audio. These signals can be combined with signals that are detected by sensors of the bed 302 to determine more accurate information about the user 308's health and sleep quality. The central controller can provide controls (e.g., user-defined, presets, automated, user initiated, etc.) for the bed 302, determining and viewing sleep quality and health information, a smart alarm clock, a speaker or other home automation device, a smart picture frame, a nightlight, and one or more mobile applications that the user 308 can install and use at the central controller. The central controller can include a display screen that can output information and also receive input from the user 308. The display can output information such as the user 308's health, sleep quality, weather information, security integration features, lighting integration features, heating and cooling integration features, and other controls to automate devices in the house. The central controller can therefore operate to provide the user 308 with functionality and control of multiple different types of devices in the house as well as the user 308's bed 302.

Still referring to FIG. 3, the control circuitry 334 of the bed 302 can generate control signals for controlling actions of other devices, and transmit the control signals to the other devices in response to information collected by the control circuitry 334, including bed presence of the user 308, sleep state of the user 308, and other factors. For example, the control circuitry 334 integrated with the pump 304 can detect a feature of a mattress of the bed 302, such as an increase in pressure in the air chamber 306b, and use this detected increase in air pressure to determine that the user 308 is present on the bed 302. In some implementations, the control circuitry 334 can identify a heartrate or respiratory rate for the user 308 to identify that the increase in pressure is due to a person sitting, laying, or otherwise resting on the bed 302, rather than an inanimate object (such as a suitcase) having been placed on the bed 302. In some implementations, the information indicating user bed presence can be combined with other information to identify a current or future likely state for the user 308. For example, a detected user bed presence at 11:00 am can indicate that the user is sitting on the bed (e.g., to tie her shoes, or to read a book) and does not intend to go to sleep, while a detected user bed presence at 10:00 pm can indicate that the user 308 is in bed for the evening and is intending to fall asleep soon. As another example, if the control circuitry 334 detects that the user 308 has left the bed 302 at 6:30 am (e.g., indicating that the user 308 has woken up for the day), and then later detects presence of the user 308 at 7:30 am on the bed 302, the control circuitry 334 can use this information that the newly detected presence is likely temporary (e.g., while the user 308 ties her shoes before heading to work) rather than an indication that the user 308 is intending to stay on the bed 302 for an extended period of time.

If the control circuitry 334 determines that the user 308 is likely to remain on the bed 302 for an extended period of time, the control circuitry 334 can determine one or more home automation controls that can aid the user 308 in falling asleep and experiencing improved sleep quality throughout the user 308's sleep cycle. For example, the control circuitry 334 can communicate with security system 318 to ensure that doors are locked. The control circuitry 334 can communicate with the oven 322 to ensure that the oven 322 is turned off. The control circuitry 334 can also communicate with the lighting system 314 to dim or otherwise turn off lights in the room in which the bed 302 is located and/or throughout the house, and the control circuitry 334 can communicate with the thermostat 316 to ensure that the house is at a desired temperature of the user 308. The control circuitry 334 can also determine one or more adjustments that can be made to the bed 302 to facilitate the user 308 falling asleep and staying asleep (e.g., changing a position of one or more regions of the bed 302, foot warming, massage features, pressure/firmness in one or more regions of the bed 302, etc.).

In some implementations, the control circuitry 334 is able to use collected information (including information related to user interaction with the bed 302 by the user 308, as well as environmental information, time information, and input received from the user 308) to identify use patterns for the user 308. For example, the control circuitry 334 can use information indicating bed presence and sleep states for the user 308 collected over a period of time to identify a sleep pattern for the user. The control circuitry 334 can identify that the user 308 generally goes to bed between 9:30 pm and 10:00 pm, generally falls asleep between 10:00 μm and 11:00 μm, and generally wakes up between 6:30 am and 6:45 am, based on information indicating user presence and biometrics for the user 308 collected over a week or a different time period. The control circuitry 334 can use identified patterns of the user 308 to better process and identify user interactions with the bed 302.

For example, given the above example user bed presence, sleep, and wake patterns for the user 308, if the user 308 is detected as being on the bed 302 at 3:00 pm, the control circuitry 334 can determine that the user 308's presence on the bed 302 is only temporary, and use this determination to generate different control signals than would be generated if the control circuitry 334 determined that the user 308 was in bed for the evening (e.g., at 3:00 pm, a head region of the bed 302 can be raised to facilitate reading or watching TV while in the bed 302, whereas in the evening, the bed 302 can be adjusted to a flat position to facilitate falling asleep). As another example, if the control circuitry 334 detects that the user 308 has gotten out of bed at 3:00 am, the control circuitry 334 can use identified patterns for the user 308 to determine that the user has only gotten up temporarily (e.g., to use the bathroom, or get a glass of water) and is not up for the day. For example, the control circuitry 334 can turn on underbed lighting to assist the user 308 in carefully moving around the bed 302 and the room. By contrast, if the control circuitry 334 identifies that the user 308 has gotten out of the bed 302 at 6:40 am, the control circuitry 334 can determine that the user 308 is up for the day and generate a different set of control signals than those that would be generated if it were determined that the user 308 were only getting out of bed temporarily (as would be the case when the user 308 gets out of the bed 302 at 3:00 am) (e.g., the control circuitry 334 can turn on light 326 near the bed 302 and/or raise the window blinds 330 when it is determined that the user 308 is up for the day). For other users, getting out of the bed 302 at 3:00 am can be a normal wake-up time, which the control circuitry 334 can learn and respond to accordingly. Moreover, if the bed 302 is occupied by two users, the control circuitry 334 can learn and respond to the patterns of each of the users.

As described above, the control circuitry 334 for the bed 302 can generate control signals for control functions of various other devices. The control signals can be generated, at least in part, based on detected interactions by the user 308 with the bed 302, as well as other information including time, date, temperature, etc. The control circuitry 334 can communicate with the television 312, receive information from the television 312, and generate control signals for controlling functions of the television 312. For example, the control circuitry 334 can receive an indication from the television 312 that the television 312 is currently turned on. If the television 312 is located in a different room than the bed 302, the control circuitry 334 can generate a control signal to turn the television 312 off upon making a determination that the user 308 has gone to bed for the evening or otherwise is remaining in the room with the bed 302. For example, if presence of the user 308 is detected on the bed 302 during a particular time range (e.g., between 8:00 μm and 7:00 am) and persists for longer than a threshold period of time (e.g., 10 minutes), the control circuitry 334 can determine that the user 308 is in bed for the evening. If the television 312 is on (as indicated by communications received by the control circuitry 334 of the bed 302 from the television 312), the control circuitry 334 can generate a control signal to turn the television 312 off. The control signals can be transmitted to the television (e.g., through a directed communication link between the television 312 and the control circuitry 334 or through a network, such as WIFI). As another example, rather than turning off the television 312 in response to detection of user bed presence, the control circuitry 334 can generate a control signal that causes the volume of the television 312 to be lowered by a pre-specified amount.

As another example, upon detecting that the user 308 has left the bed 302 during a specified time range (e.g., between 6:00 am and 8:00 am), the control circuitry 334 can generate control signals to cause the television 312 to turn on and tune to a pre-specified channel (e.g., the user 308 has indicated a preference for watching the morning news upon getting out of bed). The control circuitry 334 can generate the control signal and transmit the signal to the television 312 to cause the television 312 to turn on and tune to the desired station (which can be stored at the control circuitry 334, the television 312, or another location). As another example, upon detecting that the user 308 has gotten up for the day, the control circuitry 334 can generate and transmit control signals to cause the television 312 to turn on and begin playing a previously recorded program from a digital video recorder (DVR) in communication with the television 312.

As another example, if the television 312 is in the same room as the bed 302, the control circuitry 334 may not cause the television 312 to turn off in response to detection of user bed presence. Rather, the control circuitry 334 can generate and transmit control signals to cause the television 312 to turn off in response to determining that the user 308 is asleep. For example, the control circuitry 334 can monitor biometric signals of the user 308 (e.g., motion, heartrate, respiration rate) to determine that the user 308 has fallen asleep. Upon detecting that the user 308 is sleeping, the control circuitry 334 generates and transmits a control signal to turn the television 312 off. As another example, the control circuitry 334 can generate the control signal to turn off the television 312 after a threshold period of time has passed since the user 308 has fallen asleep (e.g., 10 minutes after the user has fallen asleep). As another example, the control circuitry 334 generates control signals to lower the volume of the television 312 after determining that the user 308 is asleep. As yet another example, the control circuitry 334 generates and transmits a control signal to cause the television to gradually lower in volume over a period of time and then turn off in response to determining that the user 308 is asleep. Any of the control signals described above in reference to the television 312 can also be determined by the central controller previously described.

In some implementations, the control circuitry 334 can similarly interact with other media devices, such as computers, tablets, mobile phones, smart phones, wearable devices, stereo systems, etc. For example, upon detecting that the user 308 is asleep, the control circuitry 334 can generate and transmit a control signal to the user device 310 to cause the user device 310 to turn off, or turn down the volume on a video or audio file being played by the user device 310.

The control circuitry 334 can additionally communicate with the lighting system 314, receive information from the lighting system 314, and generate control signals for controlling functions of the lighting system 314. For example, upon detecting user bed presence on the bed 302 during a certain time frame (e.g., between 8:00 pm and 7:00 am) that lasts for longer than a threshold period of time (e.g., 10 minutes), the control circuitry 334 of the bed 302 can determine that the user 308 is in bed for the evening. In response to this determination, the control circuitry 334 can generate control signals to cause lights in one or more rooms other than the room in which the bed 302 is located to switch off. The control signals can then be transmitted to the lighting system 314 and executed by the lighting system 314 to cause the lights in the indicated rooms to shut off For example, the control circuitry 334 can generate and transmit control signals to turn off lights in all common rooms, but not in other bedrooms. As another example, the control signals generated by the control circuitry 334 can indicate that lights in all rooms other than the room in which the bed 302 is located are to be turned off, while one or more lights located outside of the house containing the bed 302 are to be turned on, in response to determining that the user 308 is in bed for the evening. Additionally, the control circuitry 334 can generate and transmit control signals to cause the nightlight 328 to turn on in response to determining user 308 bed presence or that the user 308 is asleep. As another example, the control circuitry 334 can generate first control signals for turning off a first set of lights (e.g., lights in common rooms) in response to detecting user bed presence, and second control signals for turning off a second set of lights (e.g., lights in the room in which the bed 302 is located) in response to detecting that the user 308 is asleep.

In some implementations, in response to determining that the user 308 is in bed for the evening, the control circuitry 334 of the bed 302 can generate control signals to cause the lighting system 314 to implement a sunset lighting scheme in the room in which the bed 302 is located. A sunset lighting scheme can include, for example, dimming the lights (either gradually over time, or all at once) in combination with changing the color of the light in the bedroom environment, such as adding an amber hue to the lighting in the bedroom. The sunset lighting scheme can help to put the user 308 to sleep when the control circuitry 334 has determined that the user 308 is in bed for the evening. Sometimes, the control signals can cause the lighting system 314 to dim the lights or change color of the lighting in the bedroom environment, but not both.

The control circuitry 334 can also be configured to implement a sunrise lighting scheme when the user 308 wakes up in the morning. The control circuitry 334 can determine that the user 308 is awake for the day, for example, by detecting that the user 308 has gotten off of the bed 302 (e.g., is no longer present on the bed 302) during a specified time frame (e.g., between 6:00 am and 8:00 am). As another example, the control circuitry 334 can monitor movement, heartrate, respiratory rate, or other biometric signals of the user 308 to determine that the user 308 is awake or is waking up, even though the user 308 has not gotten out of bed. If the control circuitry 334 detects that the user is awake or waking up during a specified timeframe, the control circuitry 334 can determine that the user 308 is awake for the day. The specified timeframe can be, for example, based on previously recorded user bed presence information collected over a period of time (e.g., two weeks) that indicates that the user 308 usually wakes up for the day between 6:30 am and 7:30 am. In response to the control circuitry 334 determining that the user 308 is awake, the control circuitry 334 can generate control signals to cause the lighting system 314 to implement the sunrise lighting scheme in the bedroom in which the bed 302 is located. The sunrise lighting scheme can include, for example, turning on lights (e.g., the lamp 326, or other lights in the bedroom). The sunrise lighting scheme can further include gradually increasing the level of light in the room where the bed 302 is located (or in one or more other rooms). The sunrise lighting scheme can also include only turning on lights of specified colors. For example, the sunrise lighting scheme can include lighting the bedroom with blue light to gently assist the user 308 in waking up and becoming active.

In some implementations, the control circuitry 334 can generate different control signals for controlling actions of one or more components, such as the lighting system 314, depending on a time of day that user interactions with the bed 302 are detected. For example, the control circuitry 334 can use historical user interaction information for interactions between the user 308 and the bed 302 to determine that the user 308 usually falls asleep between 10:00 μm and 11:00 μm and usually wakes up between 6:30 am and 7:30 am on weekdays. The control circuitry 334 can use this information to generate a first set of control signals for controlling the lighting system 314 if the user 308 is detected as getting out of bed at 3:00 am and to generate a second set of control signals for controlling the lighting system 314 if the user 308 is detected as getting out of bed after 6:30 am. For example, if the user 308 gets out of bed prior to 6:30 am, the control circuitry 334 can turn on lights that guide the user 308's route to a bathroom. As another example, if the user 308 gets out of bed prior to 6:30 am, the control circuitry 334 can turn on lights that guide the user 308's route to the kitchen (which can include, for example, turning on the nightlight 328, turning on under bed lighting, turning on the lamp 326, or turning on lights along a path that the user 308 takes to get to the kitchen).

As another example, if the user 308 gets out of bed after 6:30 am, the control circuitry 334 can generate control signals to cause the lighting system 314 to initiate a sunrise lighting scheme, or to turn on one or more lights in the bedroom and/or other rooms. In some implementations, if the user 308 is detected as getting out of bed prior to a specified morning rise time for the user 308, the control circuitry 334 can cause the lighting system 314 to turn on lights that are dimmer than lights that are turned on by the lighting system 314 if the user 308 is detected as getting out of bed after the specified morning rise time. Causing the lighting system 314 to only turn on dim lights when the user 308 gets out of bed during the night (e.g., prior to normal rise time for the user 308) can prevent other occupants of the house from being woken up by the lights while still allowing the user 308 to see in order to reach the bathroom, kitchen, or another destination in the house.

The historical user interaction information for interactions between the user 308 and the bed 302 can be used to identify user sleep and awake timeframes. For example, user bed presence times and sleep times can be determined for a set period of time (e.g., two weeks, a month, etc.). The control circuitry 334 can then identify a typical time range or timeframe in which the user 308 goes to bed, a typical timeframe for when the user 308 falls asleep, and a typical timeframe for when the user 308 wakes up (and in some cases, different timeframes for when the user 308 wakes up and when the user 308 actually gets out of bed). In some implementations, buffer time can be added to these timeframes. For example, if the user is identified as typically going to bed between 10:00 μm and 10:30 pm, a buffer of a half hour in each direction can be added to the timeframe such that any detection of the user getting in bed between 9:30 pm and 11:00 pm is interpreted as the user 308 going to bed for the evening. As another example, detection of bed presence of the user 308 starting from a half hour before the earliest typical time that the user 308 goes to bed extending until the typical wake up time (e.g., 6:30 am) for the user 308 can be interpreted as the user 308 going to bed for the evening. For example, if the user 308 typically goes to bed between 10:00 μm and 10:30 pm, if the user 308's bed presence is sensed at 12:30 am one night, that can be interpreted as the user 308 getting into bed for the evening even though this is outside of the user 308's typical timeframe for going to bed because it has occurred prior to the user 308's normal wake up time. In some implementations, different timeframes are identified for different times of the year (e.g., earlier bed time during winter vs. summer) or at different times of the week (e.g., user 308 wakes up earlier on weekdays than on weekends).

The control circuitry 334 can distinguish between the user 308 going to bed for an extended period (such as for the night) as opposed to being present on the bed 302 for a shorter period (such as for a nap) by sensing duration of presence of the user 308 (e.g., by detecting pressure signals and/or temperature signals of the user 308 on the bed 302 by one or more sensors that are integrated into the bed 302). In some examples, the control circuitry 334 can distinguish between the user 308 going to bed for an extended period (such as for the night) as opposed to going to bed for a shorter period (such as for a nap) by sensing duration of sleep of the user 308. For example, the control circuitry 334 can set a time threshold whereby if the user 308 is sensed on the bed 302 for longer than the threshold, the user 308 is considered to have gone to bed for the night. In some examples, the threshold can be about 2 hours, whereby if the user 308 is sensed on the bed 302 for greater than 2 hours, the control circuitry 334 registers that as an extended sleep event. In other examples, the threshold can be greater than or less than two hours. The threshold can also be determined based on historic trends indicating how long the user 302 usually sleeps or otherwise stays on the bed 302.

The control circuitry 334 can detect repeated extended sleep events to automatically determine a typical bed time range of the user 308, without requiring the user 308 to enter a bed time range. This can allow the control circuitry 334 to accurately estimate when the user 308 is likely to go to bed for an extended sleep event, regardless of whether the user 308 typically goes to bed using a traditional sleep schedule or a non-traditional sleep schedule. The control circuitry 334 can then use knowledge of the bed time range of the user 308 to control one or more components (including components of the bed 302 and/or non-bed peripherals) based on sensing bed presence during the bed time range or outside of the bed time range.

In some examples, the control circuitry 334 can automatically determine the bed time range of the user 308 without requiring user inputs. In some examples, the control circuitry 334 can determine the bed time range of the user 308 automatically and in combination with user inputs (e.g., using one or more signals that are sensed by sensors of the bed 302 and/or the central controller described above). In some examples, the control circuitry 334 can set the bed time range directly according to user inputs. In some examples, the control circuitry 334 can associate different bed times with different days of the week. In each of these examples, the control circuitry 334 can control one or more components (such as the lighting system 314, the thermostat 316, the security system 318, the oven 322, the coffee maker 324, the lamp 326, and the nightlight 328), as a function of sensed bed presence and the bed time range.

The control circuitry 334 can additionally communicate with the thermostat 316, receive information from the thermostat 316, and generate control signals for controlling functions of the thermostat 316. For example, the user 308 can indicate user preferences for different temperatures at different times, depending on the sleep state or bed presence of the user 308. For example, the user 308 may prefer an environmental temperature of 72 degrees when out of bed, 70 degrees when in bed but awake, and 68 degrees when sleeping. The control circuitry 334 of the bed 302 can detect bed presence of the user 308 in the evening and determine that the user 308 is in bed for the night. In response to this determination, the control circuitry 334 can generate control signals to cause the thermostat 316 to change the temperature to 70 degrees. The control circuitry 334 can then transmit the control signals to the thermostat 316. Upon detecting that the user 308 is in bed during the bed time range or asleep, the control circuitry 334 can generate and transmit control signals to cause the thermostat 316 to change the temperature to 68. The next morning, upon determining that the user 308 is awake for the day (e.g., the user 308 gets out of bed after 6:30 am), the control circuitry 334 can generate and transmit control circuitry 334 to cause the thermostat to change the temperature to 72 degrees.

The control circuitry 334 can also determine control signals to be transmitted to the thermostat 316 based on maintaining improved or preferred sleep quality of the user 308. In other words, the control circuitry 334 can determine adjustments to the thermostat 316 that are not merely based on user-inputted preferences. For example, the control circuitry 334 can determine, based on historic sleep patterns and quality of the user 308 and by applying one or more machine learning models, that the user 308 experiences their best sleep when the bedroom is at 74 degrees. The control circuitry 334 can receive temperature signals from one or more devices and/or sensors in the bedroom indicating a temperature of the bedroom. When the temperature is below 74 degrees, the control circuitry 334 can determine control signals that cause the thermostat 316 to activate a heating unit in the house to raise the temperature to 74 degrees in the bedroom. When the temperature is above 74 degrees, the control circuitry 334 can determine control signals that cause the thermostat 316 to activate a cooling unit in the house to lower the temperature back to 74 degrees. Sometimes, the control circuitry 334 can also determine control signals that cause the thermostat 316 to maintain the bedroom within a temperature range that is intended to keep the user 308 in particular sleep states and/or transition to next preferred sleep states.

In some implementations, the control circuitry 334 can generate control signals to cause one or more heating or cooling elements on the surface of the bed 302 to change temperature at various times, either in response to user interaction with the bed 302, at various pre-programmed times, based on user preference, and/or in response to detecting microclimate temperatures of the user 308 on the bed 302. For example, the control circuitry 334 can activate a heating element to raise the temperature of one side of the surface of the bed 302 to 73 degrees when it is detected that the user 308 has fallen asleep. As another example, upon determining that the user 308 is up for the day, the control circuitry 334 can turn off a heating or cooling element. As yet another example, the user 308 can pre-program various times at which the temperature at the surface of the bed should be raised or lowered. For example, the user 308 can program the bed 302 to raise the surface temperature to 76 degrees at 10:00 μm, and lower the surface temperature to 68 degrees at 11:30 pm. As another example, one or more temperature sensors on the surface of the bed 302 can detect microclimates of the user 308 on the bed 302. When a detected microclimate of the user 308 drops below a predetermined threshold temperature, the control circuitry 334 can activate a heating element to raise the user 308's body temperature, thereby improving the user 308's comfortability, maintaining the user 308 in their sleep cycle, transitioning the user 308 to a next preferred sleep state, and/or otherwise maintaining or improving the user 308's sleep quality.

In some implementations, in response to detecting user bed presence of the user 308 and/or that the user 308 is asleep, the control circuitry 334 can cause the thermostat 316 to change the temperature in different rooms to different values. For example, in response to determining that the user 308 is in bed for the evening, the control circuitry 334 can generate and transmit control signals to cause the thermostat 316 to set the temperature in one or more bedrooms of the house to 72 degrees and set the temperature in other rooms to 67 degrees. Other control signals are also possible, and can be based on user preference and user input.

The control circuitry 334 can also receive temperature information from the thermostat 316 and use this temperature information to control functions of the bed 302 or other devices. For example, as discussed above, the control circuitry 334 can adjust temperatures of heating elements included in or otherwise attached to the bed 302 (e.g., a foot warming pad) in response to temperature information received from the thermostat 316.

In some implementations, the control circuitry 334 can generate and transmit control signals for controlling other temperature control systems. For example, in response to determining that the user 308 is awake for the day, the control circuitry 334 can generate and transmit control signals for causing floor heating elements to activate in the bedroom and/or in other rooms in the house. For example, the control circuitry 334 can cause a floor heating system in a master bedroom to turn on in response to determining that the user 308 is awake for the day. One or more of the control signals described herein that are determined by the control circuitry 334 can also be determined by the central controller described above.

The control circuitry 334 can additionally communicate with the security system 318, receive information from the security system 318, and generate control signals for controlling functions of the security system 318. For example, in response to detecting that the user 308 in is bed for the evening, the control circuitry 334 can generate control signals to cause the security system 318 to engage or disengage security functions. The control circuitry 334 can then transmit the control signals to the security system 318 to cause the security system 318 to engage (e.g., turning on security cameras along a perimeter of the house, automatically locking doors in the house, etc.). As another example, the control circuitry 334 can generate and transmit control signals to cause the security system 318 to disable in response to determining that the user 308 is awake for the day (e.g., user 308 is no longer present on the bed 302 after 6:00 am). In some implementations, the control circuitry 334 can generate and transmit a first set of control signals to cause the security system 318 to engage a first set of security features in response to detecting user bed presence of the user 308, and can generate and transmit a second set of control signals to cause the security system 318 to engage a second set of security features in response to detecting that the user 308 has fallen asleep.

In some implementations, the control circuitry 334 can receive alerts from the security system 318 and indicate the alert to the user 308. For example, the control circuitry 334 can detect that the user 308 is in bed for the evening and in response, generate and transmit control signals to cause the security system 318 to engage or disengage. The security system can then detect a security breach (e.g., someone has opened the door 332 without entering the security code, or someone has opened a window when the security system 318 is engaged). The security system 318 can communicate the security breach to the control circuitry 334 of the bed 302. In response to receiving the communication from the security system 318, the control circuitry 334 can generate control signals to alert the user 308 to the security breach. For example, the control circuitry 334 can cause the bed 302 to vibrate. As another example, the control circuitry 334 can cause portions of the bed 302 to articulate (e.g., cause the head section to raise or lower) in order to wake the user 308 and alert the user to the security breach. As another example, the control circuitry 334 can generate and transmit control signals to cause the lamp 326 to flash on and off at regular intervals to alert the user 308 to the security breach. As another example, the control circuitry 334 can alert the user 308 of one bed 302 regarding a security breach in a bedroom of another bed, such as an open window in a kid's bedroom. As another example, the control circuitry 334 can send an alert to a garage door controller (e.g., to close and lock the door). As another example, the control circuitry 334 can send an alert for the security to be disengaged. The control circuitry 334 can also set off a smart alarm or other alarm device/clock near the bed 302. The control circuitry 334 can transmit a push notification, text message, or other indication of the security breach to the user device 310. Also, the control circuitry 334 can transmit a notification of the security breach to the central controller described above The central controller can then determine one or more responses to the security breach.

The control circuitry 334 can additionally generate and transmit control signals for controlling the garage door 320 and receive information indicating a state of the garage door 320 (e.g., open or closed). For example, in response to determining that the user 308 is in bed for the evening, the control circuitry 334 can generate and transmit a request to a garage door opener or another device capable of sensing if the garage door 320 is open. The control circuitry 334 can request information on the current state of the garage door 320. If the control circuitry 334 receives a response (e.g., from the garage door opener) indicating that the garage door 320 is open, the control circuitry 334 can either notify the user 308 that the garage door is open (e.g., by displaying a notification or other message at the user device 310, by outputting a notification at the central controller, etc.), and/or generate a control signal to cause the garage door opener to close the garage door 320. For example, the control circuitry 334 can send a message to the user device 310 indicating that the garage door is open. As another example, the control circuitry 334 can cause the bed 302 to vibrate. As yet another example, the control circuitry 334 can generate and transmit a control signal to cause the lighting system 314 to cause one or more lights in the bedroom to flash to alert the user 308 to check the user device 310 for an alert (in this example, an alert regarding the garage door 320 being open). Alternatively, or additionally, the control circuitry 334 can generate and transmit control signals to cause the garage door opener to close the garage door 320 in response to identifying that the user 308 is in bed for the evening and that the garage door 320 is open. Control signals can also vary depend on the age of the user 308.

The control circuitry 334 can similarly send and receive communications for controlling or receiving state information associated with the door 332 or the oven 322. For example, upon detecting that the user 308 is in bed for the evening, the control circuitry 334 can generate and transmit a request to a device or system for detecting a state of the door 332. Information returned in response to the request can indicate various states of the door 332 such as open, closed but unlocked, or closed and locked. If the door 332 is open or closed but unlocked, the control circuitry 334 can alert the user 308 to the state of the door, such as in a manner described above with reference to the garage door 320. Alternatively, or in addition to alerting the user 308, the control circuitry 334 can generate and transmit control signals to cause the door 332 to lock, or to close and lock. If the door 332 is closed and locked, the control circuitry 334 can determine that no further action is needed.

Similarly, upon detecting that the user 308 is in bed for the evening, the control circuitry 334 can generate and transmit a request to the oven 322 to request a state of the oven 322 (e.g., on or off). If the oven 322 is on, the control circuitry 334 can alert the user 308 and/or generate and transmit control signals to cause the oven 322 to turn off. If the oven is already off, the control circuitry 334 can determine that no further action is necessary. In some implementations, different alerts can be generated for different events. For example, the control circuitry 334 can cause the lamp 326 (or one or more other lights, via the lighting system 314) to flash in a first pattern if the security system 318 has detected a breach, flash in a second pattern if garage door 320 is on, flash in a third pattern if the door 332 is open, flash in a fourth pattern if the oven 322 is on, and flash in a fifth pattern if another bed has detected that a user 308 of that bed has gotten up (e.g., that a child of the user 308 has gotten out of bed in the middle of the night as sensed by a sensor in the child's bed). Other examples of alerts that can be processed by the control circuitry 334 of the bed 302 and communicated to the user (e.g., at the user device 310 and/or the central controller described herein) include a smoke detector detecting smoke (and communicating this detection of smoke to the control circuitry 334), a carbon monoxide tester detecting carbon monoxide, a heater malfunctioning, or an alert from any other device capable of communicating with the control circuitry 334 and detecting an occurrence that should be brought to the user 308's attention.

The control circuitry 334 can also communicate with a system or device for controlling a state of the window blinds 330. For example, in response to determining that the user 308 is in bed for the evening, the control circuitry 334 can generate and transmit control signals to cause the window blinds 330 to close. As another example, in response to determining that the user 308 is up for the day (e.g., user has gotten out of bed after 6:30 am) or that the user 308 set an alarm to wake up at a particular time, the control circuitry 334 can generate and transmit control signals to cause the window blinds 330 to open. By contrast, if the user 308 gets out of bed prior to a normal rise time for the user 308, the control circuitry 334 can determine that the user 308 is not awake for the day and may not generate control signals that cause the window blinds 330 to open. As yet another example, the control circuitry 334 can generate and transmit control signals that cause a first set of blinds to close in response to detecting user bed presence of the user 308 and a second set of blinds to close in response to detecting that the user 308 is asleep.

The control circuitry 334 can generate and transmit control signals for controlling functions of other household devices in response to detecting user interactions with the bed 302. For example, in response to determining that the user 308 is awake for the day, the control circuitry 334 can generate and transmit control signals to the coffee maker 324 to cause the coffee maker 324 to begin brewing coffee. As another example, the control circuitry 334 can generate and transmit control signals to the oven 322 to cause the oven 322 to begin preheating (for users that like fresh baked bread in the morning or otherwise bake or prepare food in the morning). As another example, the control circuitry 334 can use information indicating that the user 308 is awake for the day along with information indicating that the time of year is currently winter and/or that the outside temperature is below a threshold value to generate and transmit control signals to cause a car engine block heater to turn on.

As another example, the control circuitry 334 can generate and transmit control signals to cause one or more devices to enter a sleep mode in response to detecting user bed presence of the user 308, or in response to detecting that the user 308 is asleep. For example, the control circuitry 334 can generate control signals to cause a mobile phone of the user 308 to switch into sleep mode or night mode such that notifications from the mobile phone are muted to not disturb the user 308's sleep. The control circuitry 334 can then transmit the control signals to the mobile phone. Later, upon determining that the user 308 is up for the day, the control circuitry 334 can generate and transmit control signals to cause the mobile phone to switch out of sleep mode.

In some implementations, the control circuitry 334 can communicate with one or more noise control devices. For example, upon determining that the user 308 is in bed for the evening, or that the user 308 is asleep (e.g., based on pressure signals received from the bed 302, audio/decibel signals received from audio sensors positioned on or around the bed 302, etc.), the control circuitry 334 can generate and transmit control signals to cause one or more noise cancelation devices to activate. The noise cancelation devices can, for example, be included as part of the bed 302 or located in the bedroom with the bed 302. As another example, upon determining that the user 308 is in bed for the evening or that the user 308 is asleep, the control circuitry 334 can generate and transmit control signals to turn the volume on, off, up, or down, for one or more sound generating devices, such as a stereo system radio, television, computer, tablet, mobile phone, etc.

Additionally, functions of the bed 302 can be controlled by the control circuitry 334 in response to user interactions with the bed 302. As mentioned throughout, functions of the bed 302 described herein can also be controlled by the user device 310 and/or the central controller (e.g., a hub device or other home automation device that controls multiple different devices in the home). As mentioned above, the bed 302 can include an adjustable foundation and an articulation controller configured to adjust the position of one or more portions of the bed 302 by adjusting the adjustable foundation that supports the bed 302. For example, the articulation controller can adjust the bed 302 from a flat position to a position in which a head portion of a mattress of the bed 302 is inclined upward (e.g., to facilitate a user sitting up in bed, reading, and/or watching television). In some implementations, the bed 302 includes multiple separately articulable sections. For example, portions of the bed corresponding to the locations of the air chambers 306a and 306b can be articulated independently from each other, to allow one person positioned on the bed 302 surface to rest in a first position (e.g., a flat position) while a second person rests in a second position (e.g., a reclining position with the head raised at an angle from the waist). In some implementations, separate positions can be set for two different beds (e.g., two twin beds placed next to each other). The foundation of the bed 302 can include more than one zone that can be independently adjusted. The articulation controller can also be configured to provide different levels of massage to one or more users on the bed 302 or to cause the bed to vibrate to communicate alerts to the user 308 as described above.

The control circuitry 334 can adjust positions (e.g., incline and decline positions for the user 308 and/or an additional user of the bed 302) in response to user interactions with the bed 302. For example, the control circuitry 334 can cause the articulation controller to adjust the bed 302 to a first recline position for the user 308 in response to sensing user bed presence for the user 308. The control circuitry 334 can cause the articulation controller to adjust the bed 302 to a second recline position (e.g., a less reclined, or flat position) in response to determining that the user 308 is asleep. As another example, the control circuitry 334 can receive a communication from the television 312 indicating that the user 308 has turned off the television 312, and in response, the control circuitry 334 can cause the articulation controller to adjust the position of the bed 302 to a preferred user sleeping position (e.g., due to the user turning off the television 312 while the user 308 is in bed indicating that the user 308 wishes to go to sleep).

In some implementations, the control circuitry 334 can control the articulation controller so as to wake up one user of the bed 302 without waking another user of the bed 302. For example, the user 308 and a second user of the bed 302 can each set distinct wakeup times (e.g., 6:30 am and 7:15 am respectively). When the wakeup time for the user 308 is reached, the control circuitry 334 can cause the articulation controller to vibrate or change the position of only a side of the bed on which the user 308 is located to wake the user 308 without disturbing the second user. When the wakeup time for the second user is reached, the control circuitry 334 can cause the articulation controller to vibrate or change the position of only the side of the bed on which the second user is located. Alternatively, when the second wakeup time occurs, the control circuitry 334 can utilize other methods (such as audio alarms, or turning on the lights) to wake the second user since the user 308 is already awake and therefore will not be disturbed when the control circuitry 334 attempts to wake the second user.

Still referring to FIG. 3, the control circuitry 334 for the bed 302 can utilize information for interactions with the bed 302 by multiple users to generate control signals for controlling functions of various other devices. For example, the control circuitry 334 can wait to generate control signals for, for example, engaging the security system 318, or instructing the lighting system 314 to turn off lights in various rooms, until both the user 308 and a second user are detected as being present on the bed 302. As another example, the control circuitry 334 can generate a first set of control signals to cause the lighting system 314 to turn off a first set of lights upon detecting bed presence of the user 308 and generate a second set of control signals for turning off a second set of lights in response to detecting bed presence of a second user. As another example, the control circuitry 334 can wait until it has been determined that both the user 308 and a second user are awake for the day before generating control signals to open the window blinds 330. As yet another example, in response to determining that the user 308 has left the bed 302 and is awake for the day, but that a second user is still sleeping, the control circuitry 334 can generate and transmit a first set of control signals to cause the coffee maker 324 to begin brewing coffee, to cause the security system 318 to deactivate, to turn on the lamp 326, to turn off the nightlight 328, to cause the thermostat 316 to raise the temperature in one or more rooms to 72 degrees, and/or to open the window blinds 330 in rooms other than the bedroom in which the bed 302 is located. Later, in response to detecting that the second user is no longer present on the bed (or that the second user is awake or is waking up) the control circuitry 334 can generate and transmit a second set of control signals to, for example, cause the lighting system 314 to turn on one or more lights in the bedroom, to cause window blinds in the bedroom to open, and to turn on the television 312 to a pre-specified channel. One or more other home automation control signals can be determined and generated by the control circuitry 334, the user device 310, and/or the central controller described herein.

Examples of Data Processing Systems Associated with a Bed

Described here are examples of systems and components that can be used for data processing tasks that are, for example, associated with a bed. In some cases, multiple examples of a particular component or group of components are presented. Some of these examples are redundant and/or mutually exclusive alternatives. Connections between components are shown as examples to illustrate possible network configurations for allowing communication between components. Different formats of connections can be used as technically needed or desired. The connections generally indicate a logical connection that can be created with any technologically feasible format. For example, a network on a motherboard can be created with a printed circuit board, wireless data connections, and/or other types of network connections. Some logical connections are not shown for clarity. For example, connections with power supplies and/or computer readable memory may not be shown for clarities sake, as many or all elements of a particular component may need to be connected to the power supplies and/or computer readable memory.

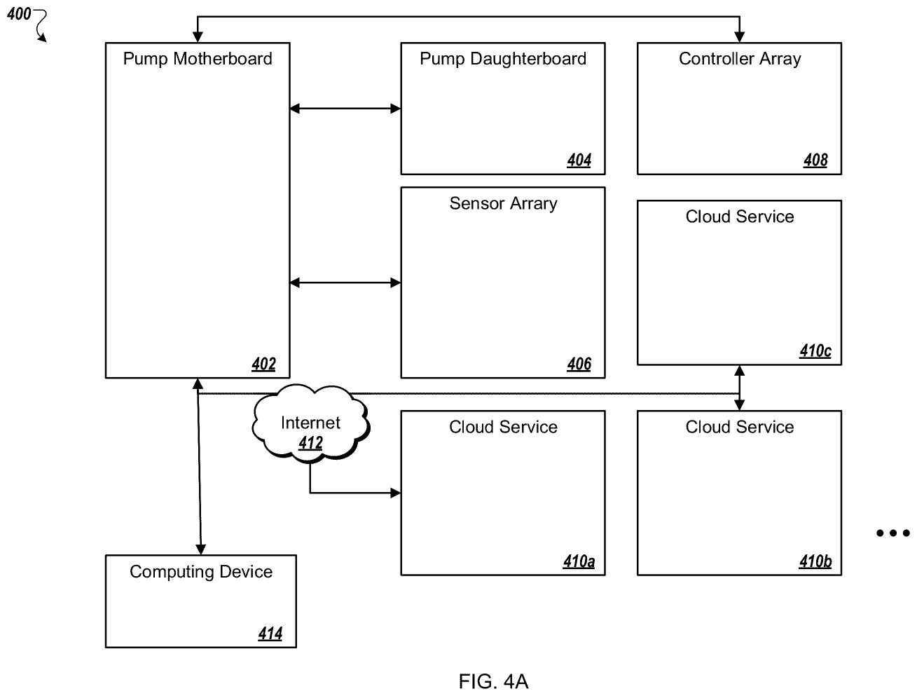

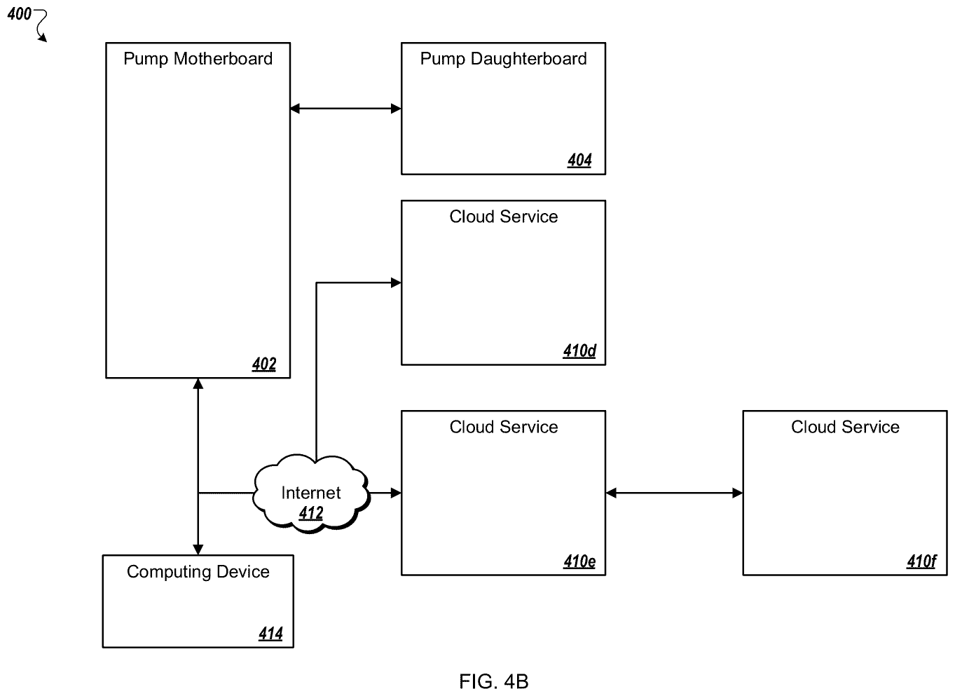

FIG. 4A is a block diagram of an example of a data processing system 400 that can be associated with a bed system, including those described above with respect to FIGS. 1-3. This system 400 includes a pump motherboard 402 and a pump daughterboard 404. The system 400 includes a sensor array 406 that can include one or more sensors configured to sense physical phenomenon of the environment and/or bed, and to report such sensing back to the pump motherboard 402 for, for example, analysis. The sensor array 406 can include one or more different types of sensors, including but not limited to pressure sensors, temperature sensors, light sensors, movement (e.g. motion) sensors, and audio sensors. The system 400 also includes a controller array 408 that can include one or more controllers configured to control logic-controlled devices of the bed and/or environment (such as home automation devices, security systems light systems, and other devices that are described in reference to FIG. 3). The pump motherboard 400 can be in communication with one or more computing devices 414 and one or more cloud services 410 over local networks, the Internet 412, or otherwise as is technically appropriate. Each of these components will be described in more detail, some with multiple example configurations, below.

In this example, a pump motherboard 402 and a pump daughterboard 404 are communicably coupled. They can be conceptually described as a center or hub of the system 400, with the other components conceptually described as spokes of the system 400. In some configurations, this can mean that each of the spoke components communicates primarily or exclusively with the pump motherboard 402. For example, a sensor of the sensor array 406 may not be configured to, or may not be able to, communicate directly with a corresponding controller. Instead, each spoke component can communicate with the motherboard 402. The sensor of the sensor array 406 can report a sensor reading to the motherboard 402, and the motherboard 402 can determine that, in response, a controller of the controller array 408 should adjust some parameters of a logic controlled device or otherwise modify a state of one or more peripheral devices. In one case, if the temperature of the bed is determined to be too hot based on received temperature signals from the sensor array 406, the pump motherboard 402 can determine that a temperature controller should cool the bed.

One advantage of a hub-and-spoke network configuration, sometimes also referred to as a star-shaped network, is a reduction in network traffic compared to, for example, a mesh network with dynamic routing. If a particular sensor generates a large, continuous stream of traffic, that traffic may only be transmitted over one spoke of the network to the motherboard 402. The motherboard 402 can, for example, marshal that data and condense it to a smaller data format for retransmission for storage in a cloud service 410. Additionally or alternatively, the motherboard 402 can generate a single, small, command message to be sent down a different spoke of the network in response to the large stream. For example, if the large stream of data is a pressure reading that is transmitted from the sensor array 406 a few times a second, the motherboard 402 can respond with a single command message to the controller array to increase the pressure in an air chamber of the bed. In this case, the single command message can be orders of magnitude smaller than the stream of pressure readings.

As another advantage, a hub-and-spoke network configuration can allow for an extensible network that can accommodate components being added, removed, failing, etc. This can allow, for example, more, fewer, or different sensors in the sensor array 406, controllers in the controller array 408, computing devices 414, and/or cloud services 410. For example, if a particular sensor fails or is deprecated by a newer version of the sensor, the system 400 can be configured such that only the motherboard 402 needs to be updated about the replacement sensor. This can allow, for example, product differentiation where the same motherboard 402 can support an entry level product with fewer sensors and controllers, a higher value product with more sensors and controllers, and customer personalization where a customer can add their own selected components to the system 400.

Additionally, a line of air bed products can use the system 400 with different components. In an application in which every air bed in the product line includes both a central logic unit and a pump, the motherboard 402 (and optionally the daughterboard 404) can be designed to fit within a single, universal housing. Then, for each upgrade of the product in the product line, additional sensors, controllers, cloud services, etc., can be added. Design, manufacturing, and testing time can be reduced by designing all products in a product line from this base, compared to a product line in which each product has a bespoke logic control system.

Each of the components discussed above can be realized in a wide variety of technologies and configurations. Below, some examples of each component will be further discussed. In some alternatives, two or more of the components of the system 400 can be realized in a single alternative component; some components can be realized in multiple, separate components; and/or some functionality can be provided by different components.

FIG. 4B is a block diagram showing some communication paths of the data processing system 400. As previously described, the motherboard 402 and the pump daughterboard 404 may act as a hub for peripheral devices and cloud services of the system 400. In cases in which the pump daughterboard 404 communicates with cloud services or other components, communications from the pump daughterboard 404 may be routed through the pump motherboard 402. This may allow, for example, the bed to have only a single connection with the internet 412. The computing device 414 may also have a connection to the internet 412, possibly through the same gateway used by the bed and/or possibly through a different gateway (e.g., a cell service provider).

Previously, a number of cloud services 410 were described. As shown in FIG. 4B, some cloud services, such as cloud services 410d and 410e, may be configured such that the pump motherboard 402 can communicate with the cloud service directly—that is the motherboard 402 may communicate with a cloud service 410 without having to use another cloud service 410 as an intermediary. Additionally or alternatively, some cloud services 410, for example cloud service 410f, may only be reachable by the pump motherboard 402 through an intermediary cloud service, for example cloud service 410e. While not shown here, some cloud services 410 may be reachable either directly or indirectly by the pump motherboard 402.

Additionally, some or all of the cloud services 410 may be configured to communicate with other cloud services. This communication may include the transfer of data and/or remote function calls according to any technologically appropriate format. For example, one cloud service 410 may request a copy for another cloud service's 410 data, for example, for purposes of backup, coordination, migration, or for performance of calculations or data mining. In another example, many cloud services 410 may contain data that is indexed according to specific users tracked by the user account cloud 410c and/or the bed data cloud 410a. These cloud services 410 may communicate with the user account cloud 410c and/or the bed data cloud 410a when accessing data specific to a particular user or bed.

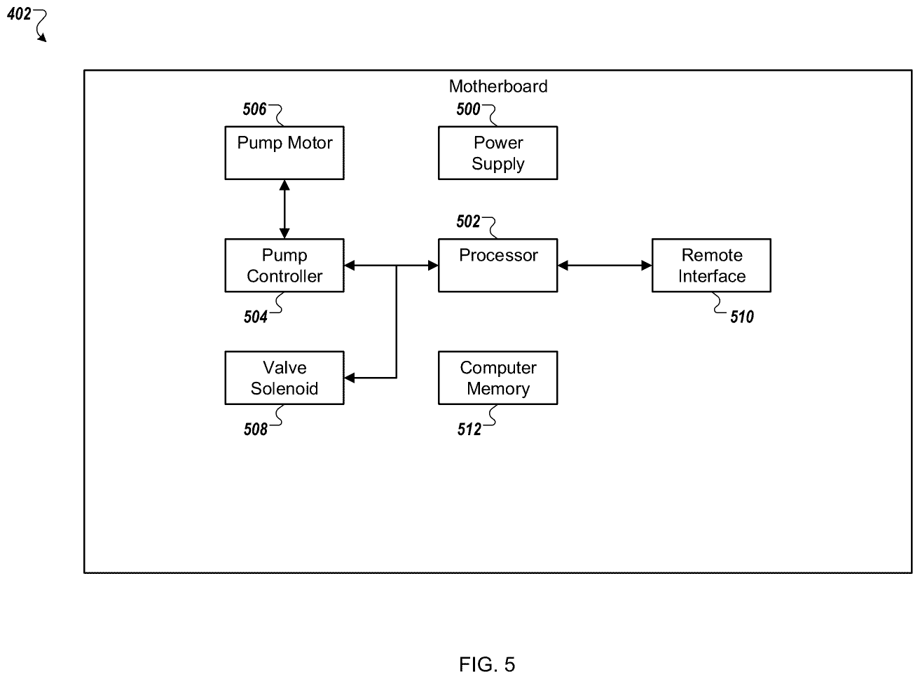

FIG. 5 is a block diagram of an example of a motherboard 402 that can be used in a data processing system that can be associated with a bed system, including those described above with respect to FIGS. 1-3. In this example, compared to other examples described below, this motherboard 402 consists of relatively fewer parts and can be limited to provide a relatively limited feature set.

The motherboard 402 includes a power supply 500, a processor 502, and computer memory 512. In general, the power supply 500 includes hardware used to receive electrical power from an outside source and supply it to components of the motherboard 402. The power supply can include, for example, a battery pack and/or wall outlet adapter, an AC to DC converter, a DC to AC converter, a power conditioner, a capacitor bank, and/or one or more interfaces for providing power in the current type, voltage, etc., needed by other components of the motherboard 402.

The processor 502 is generally a device for receiving input, performing logical determinations, and providing output. The processor 502 can be a central processing unit, a microprocessor, general purpose logic circuitry, application-specific integrated circuitry, a combination of these, and/or other hardware for performing the functionality needed.

The memory 512 is generally one or more devices for storing data. The memory 512 can include long term stable data storage (e.g., on a hard disk), short term unstable (e.g., on Random Access Memory) or any other technologically appropriate configuration.

The motherboard 402 includes a pump controller 504 and a pump motor 506. The pump controller 504 can receive commands from the processor 502 and, in response, control the functioning of the pump motor 506. For example, the pump controller 504 can receive, from the processor 502, a command to increase pressure of an air chamber by 0.3 pounds per square inch (PSI). The pump controller 504, in response, engages a valve so that the pump motor 506 is configured to pump air into the selected air chamber, and can engage the pump motor 506 for a length of time that corresponds to 0.3 PSI or until a sensor indicates that pressure has been increased by 0.3 PSI. In an alternative configuration, the message can specify that the chamber should be inflated to a target PSI, and the pump controller 504 can engage the pump motor 506 until the target PSI is reached.

A valve solenoid 508 can control which air chamber a pump is connected to. In some cases, the solenoid 508 can be controlled by the processor 502 directly. In some cases, the solenoid 508 can be controlled by the pump controller 504.

A remote interface 510 of the motherboard 402 can allow the motherboard 402 to communicate with other components of a data processing system. For example, the motherboard 402 can be able to communicate with one or more daughterboards, with peripheral sensors, and/or with peripheral controllers through the remote interface 510. The remote interface 510 can provide any technologically appropriate communication interface, including but not limited to multiple communication interfaces such as WIFI, Bluetooth, and copper wired networks.

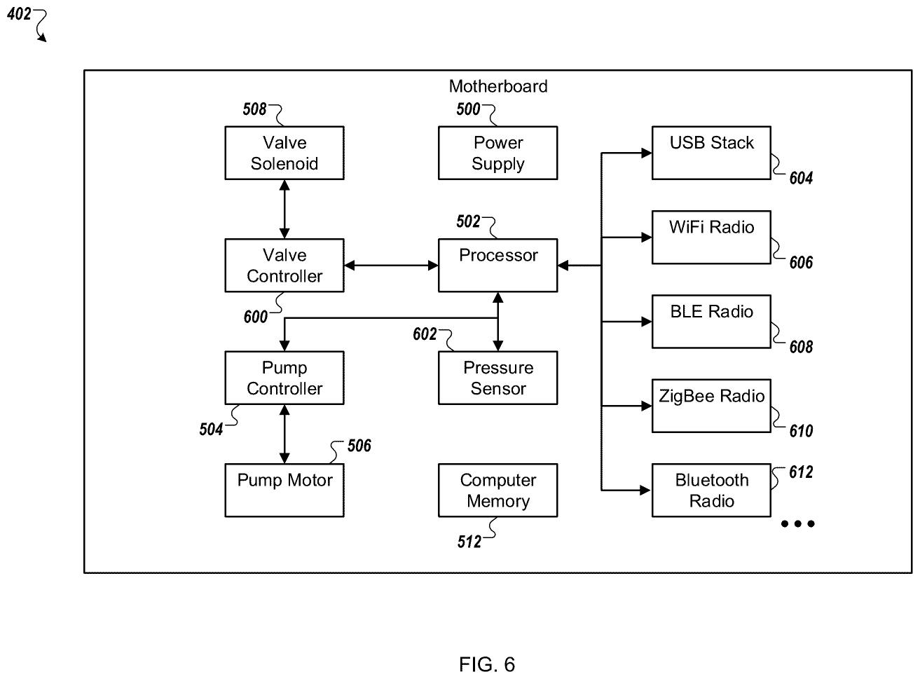

FIG. 6 is a block diagram of an example of the motherboard 402 that can be used in a data processing system associated with a bed system, including those described above with respect to FIGS. 1-3. Compared to the motherboard 402 described with reference to FIG. 5, the motherboard 402 in FIG. 6 can contain more components and provide more functionality in some applications.

In addition to the power supply 500, processor 502, pump controller 504, pump motor 506, and valve solenoid 508, this motherboard 402 is shown with a valve controller 600, a pressure sensor 602, a universal serial bus (USB) stack 604, a WiFi radio 606, a Bluetooth Low Energy (BLE) radio 608, a ZigBee radio 610, a Bluetooth radio 612, and a computer memory 512.

Similar to the way that the pump controller 504 converts commands from the processor 502 into control signals for the pump motor 506, the valve controller 600 can convert commands from the processor 502 into control signals for the valve solenoid 508. In one example, the processor 502 can issue a command to the valve controller 600 to connect the pump to a particular air chamber out of a group of air chambers in an air bed. The valve controller 600 can control the position of the valve solenoid 508 so that the pump is connected to the indicated air chamber.

The pressure sensor 602 can read pressure readings from one or more air chambers of the air bed. The pressure sensor 602 can also preform digital sensor conditioning. As described herein, multiple pressure sensors 602 can be included as part of the motherboard 402 or otherwise in communication with the motherboard 402.

The motherboard 402 can include a suite of network interfaces 604, 606, 608, 610, 612, etc., including but not limited to those shown in FIG. 6. These network interfaces can allow the motherboard to communicate over a wired or wireless network with any number of devices, including but not limited to peripheral sensors, peripheral controllers, computing devices, and devices and services connected to the Internet 412.

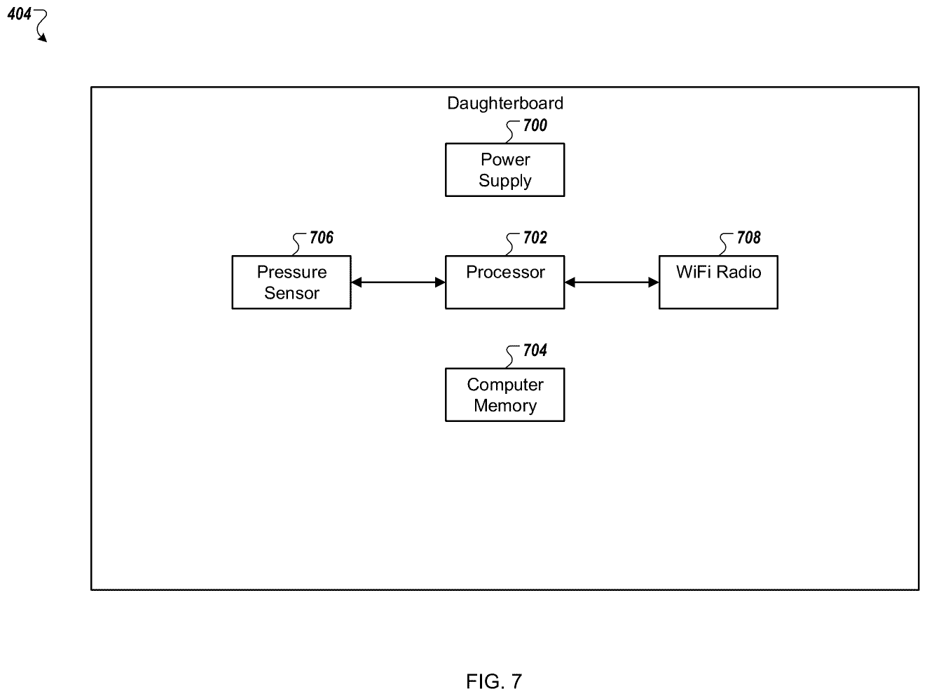

FIG. 7 is a block diagram of an example of a daughterboard 404 that can be used in a data processing system associated with a bed system, including those described above with respect to FIGS. 1-3. In some configurations, one or more daughterboards 404 can be connected to the motherboard 402. Some daughterboards 404 can be designed to offload particular and/or compartmentalized tasks from the motherboard 402. This can be advantageous, for example, if the particular tasks are computationally intensive, proprietary, or subject to future revisions. For example, the daughterboard 404 can be used to calculate a particular sleep data metric. This metric can be computationally intensive, and calculating the sleep metric on the daughterboard 404 can free up the resources of the motherboard 402 while the metric is being calculated. Additionally and/or alternatively, the sleep metric can be subject to future revisions. To update the system 400 with the new sleep metric, it is possible that only the daughterboard 404 that calculates that metric need be replaced. In this case, the same motherboard 402 and other components can be used, saving the need to perform unit testing of additional components instead of just the daughterboard 404.

The daughterboard 404 is shown with a power supply 700, a processor 702, computer readable memory 704, a pressure sensor 706, and a WiFi radio 708. The processor 702 can use the pressure sensor 706 to gather information about the pressure of an air chamber or chambers of an air bed. From this data, the processor 702 can perform an algorithm to calculate a sleep metric (e.g., sleep quality, whether a user is presently in the bed, whether the user has fallen asleep, a heartrate of the user, a respiration rate of the user, movement of the user, etc.). In some examples, the sleep metric can be calculated from only the pressure of air chambers. In other examples, the sleep metric can be calculated using signals from a variety of sensors (e.g., a movement sensor, a pressure sensor, a temperature sensor, and/or an audio sensor). In an example in which different data is needed, the processor 702 can receive that data from an appropriate sensor or sensors. These sensors can be internal to the daughterboard 404, accessible via the WiFi radio 708, or otherwise in communication with the processor 702. Once the sleep metric is calculated, the processor 702 can report that sleep metric to, for example, the motherboard 402. The motherboard 402 can then generate instructions for outputting the sleep metric to the user or otherwise using the sleep metric to determine one or more other information about the user or controls to control the bed system and/or peripheral devices.

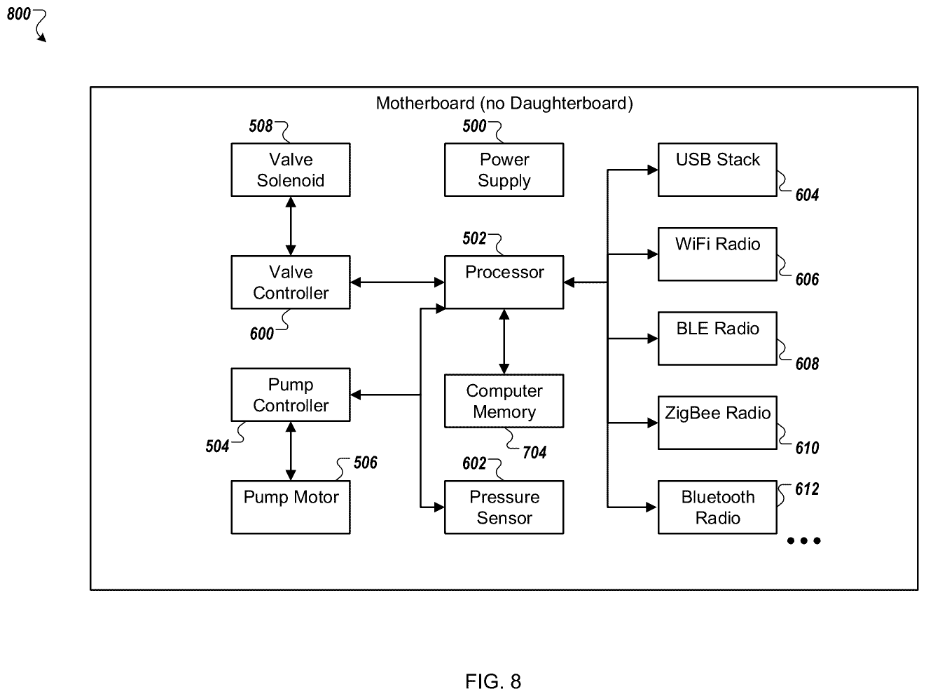

FIG. 8 is a block diagram of an example of a motherboard 800 with no daughterboard that can be used in a data processing system associated with a bed system, including those described above with respect to FIGS. 1-3. In this example, the motherboard 800 can perform most, all, or more of the features described with reference to the motherboard 402 in FIG. 6 and the daughterboard 404 in FIG. 7.

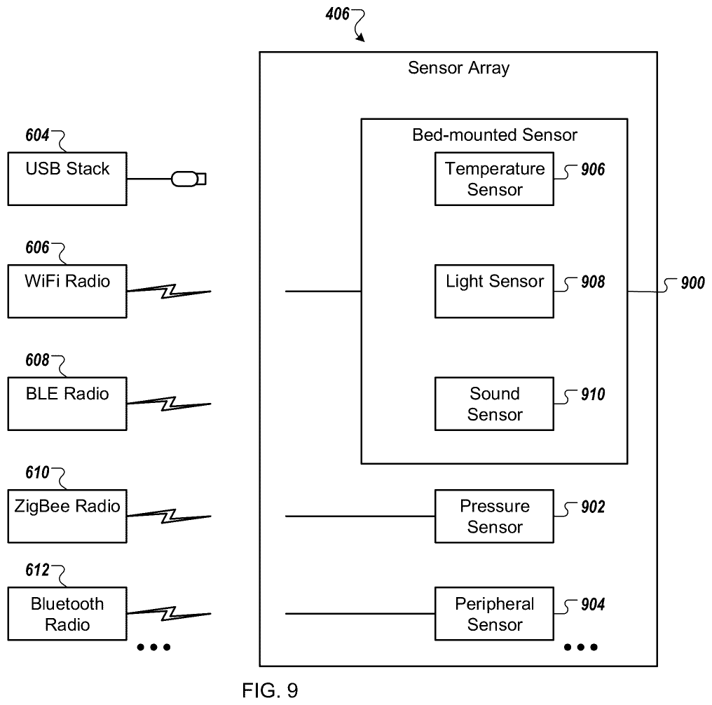

FIG. 9 is a block diagram of an example of the sensory array 406 that can be used in a data processing system associated with a bed system, including those described above with respect to FIGS. 1-3. In general, the sensor array 406 is a conceptual grouping of some or all the peripheral sensors that communicate with the motherboard 402 but are not native to the motherboard 402.

The peripheral sensors 902, 904, 906, 908, 910, etc. of the sensor array 406 can communicate with the motherboard 402 through one or more of the network interfaces of the motherboard, including but not limited to the USB stack 604, WiFi radio 606, Bluetooth Low Energy (BLE) radio 608, ZigBee radio 610, and Bluetooth radio 612, as is appropriate for the configuration of the particular sensor. For example, a sensor that outputs a reading over a USB cable can communicate through the USB stack 604.

Some of the peripheral sensors of the sensor array 406 can be bed mounted sensors 900, such as a temperature sensor 906, a light sensor 908, and a sound sensor 910. The bed mounted sensors 900 can be, for example, embedded into the structure of a bed and sold with the bed, or later affixed to the structure of the bed (e.g., part of a pressure sensing pad that is removably installed on a top surface of the bed, part of a temperature sensing or heating pad that is removably installed on the top surface of the bed, integrated into the top surface of the bed, attached along connecting tubes between a pump and air chambers, within air chambers, attached to a headboard of the bed, attached to one or more regions of an adjustable foundation, etc.). Other sensors 902 and 904 can be in communication with the motherboard 402, but optionally not mounted to the bed. The other sensors 902 and 904 can include a pressure sensor 902 and/or peripheral sensor 904. For example, the sensors 902 and 904 can be integrated or otherwise part of a user mobile device (e.g., mobile phone, wearable device, etc.). The sensors 902 and 904 can also be part of a central controller for controlling the bed and peripheral devices in the home. Sometimes, the sensors 902 and 904 can also be part of one or more home automation devices or other peripheral devices in the home.

In some cases, some or all of the bed mounted sensors 900 and/or sensors 902 and 904 can share networking hardware, including a conduit that contains wires from each sensor, a multi-wire cable or plug that, when affixed to the motherboard 402, connect all of the associated sensors with the motherboard 402. In some embodiments, one, some, or all of sensors 902, 904, 906, 908, and 910 can sense one or more features of a mattress, such as pressure, temperature, light, sound, and/or one or more other features of the mattress. In some embodiments, one, some, or all of sensors 902, 904, 906, 908, and 910 can sense one or more features external to the mattress. In some embodiments, pressure sensor 902 can sense pressure of the mattress while some or all of sensors 902, 904, 906, 908, and 910 can sense one or more features of the mattress and/or external to the mattress.

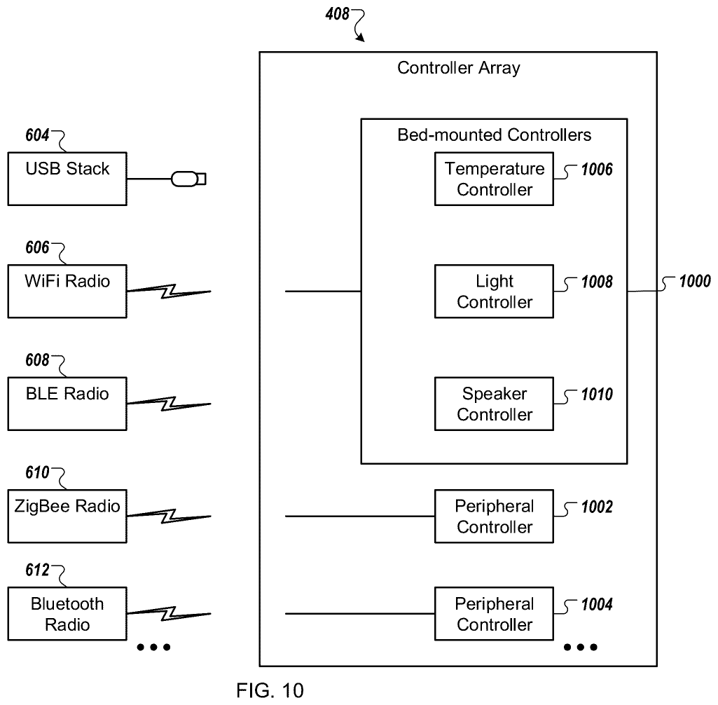

FIG. 10 is a block diagram of an example of the controller array 408 that can be used in a data processing system associated with a bed system, including those described above with respect to FIGS. 1-3. In general, the controller array 408 is a conceptual grouping of some or all peripheral controllers that communicate with the motherboard 402 but are not native to the motherboard 402.

The peripheral controllers of the controller array 408 can communicate with the motherboard 402 through one or more of the network interfaces of the motherboard, including but not limited to the USB stack 604, WiFi radio 606, Bluetooth Low Energy (BLE) radio 608, ZigBee radio 610, and Bluetooth radio 612, as is appropriate for the configuration of the particular sensor. For example, a controller that receives a command over a USB cable can communicate through the USB stack 604.

Some of the controllers of the controller array 408 can be bed mounted controllers 1000, such as a temperature controller 1006, a light controller 1008, and a speaker controller 1010. The bed mounting controllers 1000 can be, for example, embedded into the structure of a bed and sold with the bed, or later affixed to the structure of the bed, as described in reference to the peripheral sensors in FIG. 9. Other peripheral controllers 1002 and 1004 can be in communication with the motherboard 402, but optionally not mounted to the bed. In some cases, some or all of the bed mounted controllers 1000 and/or the peripheral controllers 1002 and 1004 can share networking hardware, including a conduit that contains wires for each controller, a multi-wire cable or plug that, when affixed to the motherboard 402, connects all of the associated controllers with the motherboard 402.

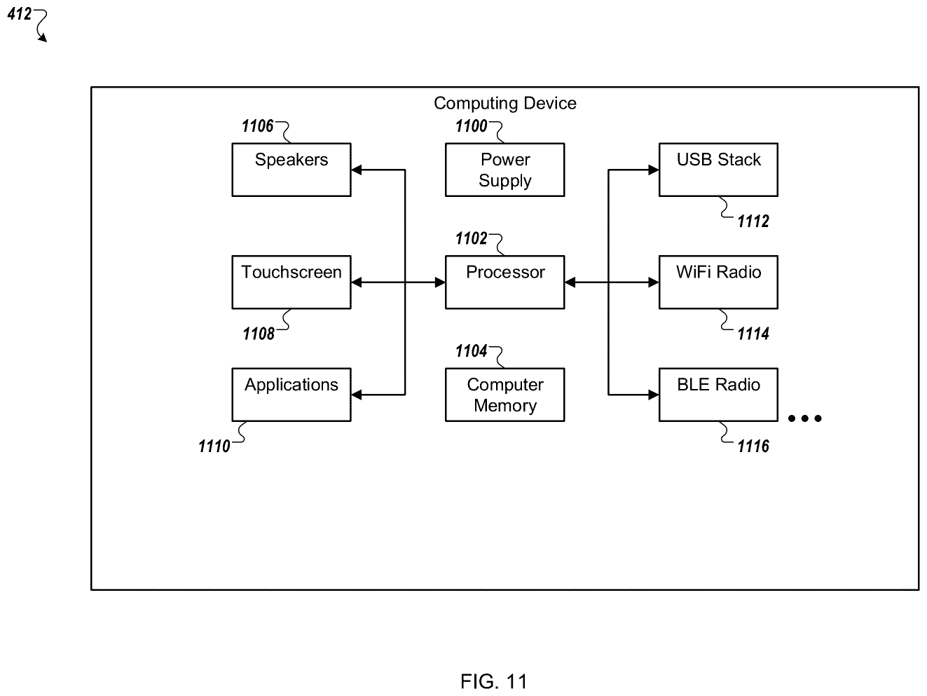

FIG. 11 is a block diagram of an example of the computing device 412 that can be used in a data processing system associated with a bed system, including those described above with respect to FIGS. 1-3. The computing device 412 can include, for example, computing devices used by a user of a bed. Example computing devices 412 include, but are not limited to, mobile computing devices (e.g., mobile phones, tablet computers, laptops, smart phones, wearable devices), desktop computers, home automation devices, and/or central controllers or other hub devices.

The computing device 412 includes a power supply 1100, a processor 1102, and computer readable memory 1104. User input and output can be transmitted by, for example, speakers 1106, a touchscreen 1108, or other not shown components, such as a pointing device or keyboard. The computing device 412 can run one or more applications 1110. These applications can include, for example, applications to allow the user to interact with the system 400. These applications can allow a user to view information about the bed (e.g., sensor readings, sleep metrics), information about themselves (e.g., health conditions that are detected based on signals that are sensed at the bed), and/or configure the behavior of the system 400 (e.g., set a desired firmness to the bed, set desired behavior for peripheral devices). In some cases, the computing device 412 can be used in addition to, or to replace, the remote control 122 described previously.

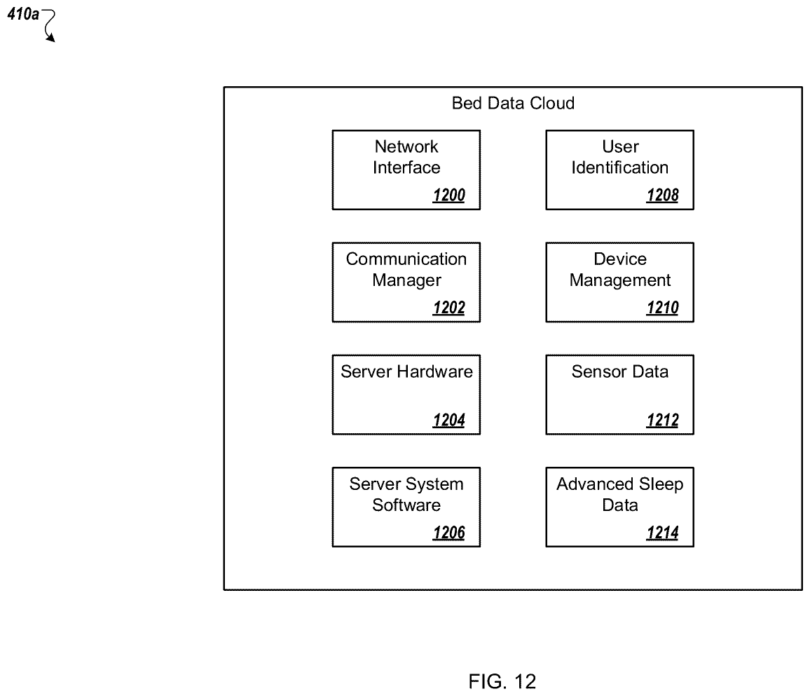

FIG. 12 is a block diagram of an example bed data cloud service 410a that can be used in a data processing system associated with a bed system, including those described above with respect to FIGS. 1-3. In this example, the bed data cloud service 410a is configured to collect sensor data and sleep data from a particular bed, and to match the sensor and sleep data with one or more users that use the bed when the sensor and sleep data was generated.

The bed data cloud service 410a is shown with a network interface 1200, a communication manager 1202, server hardware 1204, and server system software 1206. In addition, the bed data cloud service 410a is shown with a user identification module 1208, a device management 1210 module, a sensor data module 1210, and an advanced sleep data module 1214.

The network interface 1200 generally includes hardware and low level software used to allow one or more hardware devices to communicate over networks. For example the network interface 1200 can include network cards, routers, modems, and other hardware needed to allow the components of the bed data cloud service 410a to communicate with each other and other destinations over, for example, the Internet 412.

The communication manager 1202 generally comprises hardware and software that operate above the network interface 1200. This includes software to initiate, maintain, and tear down network communications used by the bed data cloud service 410a. This includes, for example, TCP/IP, SSL or TLS, Torrent, and other communication sessions over local or wide area networks. The communication manager 1202 can also provide load balancing and other services to other elements of the bed data cloud service 410a.

The server hardware 1204 generally includes physical processing devices used to instantiate and maintain the bed data cloud service 410a. This hardware includes, but is not limited to, processors (e.g., central processing units, ASICs, graphical processers) and computer readable memory (e.g., random access memory, stable hard disks, tape backup). One or more servers can be configured into clusters, multi-computer, or datacenters that can be geographically separate or connected.

The server system software 1206 generally includes software that runs on the server hardware 1204 to provide operating environments to applications and services. The server system software 1206 can include operating systems running on real servers, virtual machines instantiated on real servers to create many virtual servers, server level operations such as data migration, redundancy, and backup.

The user identification 1208 can include, or reference, data related to users of beds with associated data processing systems. For example, the users can include customers, owners, or other users registered with the bed data cloud service 410a or another service. Each user can have, for example, a unique identifier, user credentials, contact information, billing information, demographic information, or any other technologically appropriate information.

The device manager 1210 can include, or reference, data related to beds or other products associated with data processing systems. For example, the beds can include products sold or registered with a system associated with the bed data cloud service 410a. Each bed can have, for example, a unique identifier, model and/or serial number, sales information, geographic information, delivery information, a listing of associated sensors and control peripherals, etc. Additionally, an index or indexes stored by the bed data cloud service 410a can identify users that are associated with beds. For example, this index can record sales of a bed to a user, users that sleep in a bed, etc.

The sensor data 1212 can record raw or condensed sensor data recorded by beds with associated data processing systems. For example, a bed's data processing system can have a temperature sensor, pressure sensor, motion sensor, audio sensor, and/or light sensor. Readings from one or more of these sensors, either in raw form or in a format generated from the raw data (e.g. sleep metrics) of the sensors, can be communicated by the bed's data processing system to the bed data cloud service 410a for storage in the sensor data 1212. Additionally, an index or indexes stored by the bed data cloud service 410a can identify users and/or beds that are associated with the sensor data 1212.

The bed data cloud service 410a can use any of its available data, such as the sensor data 1212, to generate advanced sleep data 1214. In general, the advanced sleep data 1214 includes sleep metrics and other data generated from sensor readings, such as health information associated with the user of a particular bed. Some of these calculations can be performed in the bed data cloud service 410a instead of locally on the bed's data processing system, for example, because the calculations can be computationally complex or require a large amount of memory space or processor power that may not be available on the bed's data processing system. This can help allow a bed system to operate with a relatively simple controller and still be part of a system that performs relatively complex tasks and computations.

For example, the bed data cloud service 410a can retrieve one or more machine learning models from a remote data store and use those models to determine the advanced sleep data 1214. The bed data cloud service 410a can retrieve different types of models based on a type of the advanced sleep data 1214 that is being generated. As an illustrative example, the bed data cloud service 410a can retrieve one or more models to determine overall sleep quality of the user based on currently detected sensor data 1212 and/or historic sensor data (e.g., which can be stored in and accessed from a data store). The bed data cloud service 410a can retrieve one or more other models to determine whether the user is currently snoring based on the detected sensor data 1212. The bed data cloud service 410a can also retrieve one or more other models that can be used to determine whether the user is experiencing some health condition based on the detected sensor data 1212.

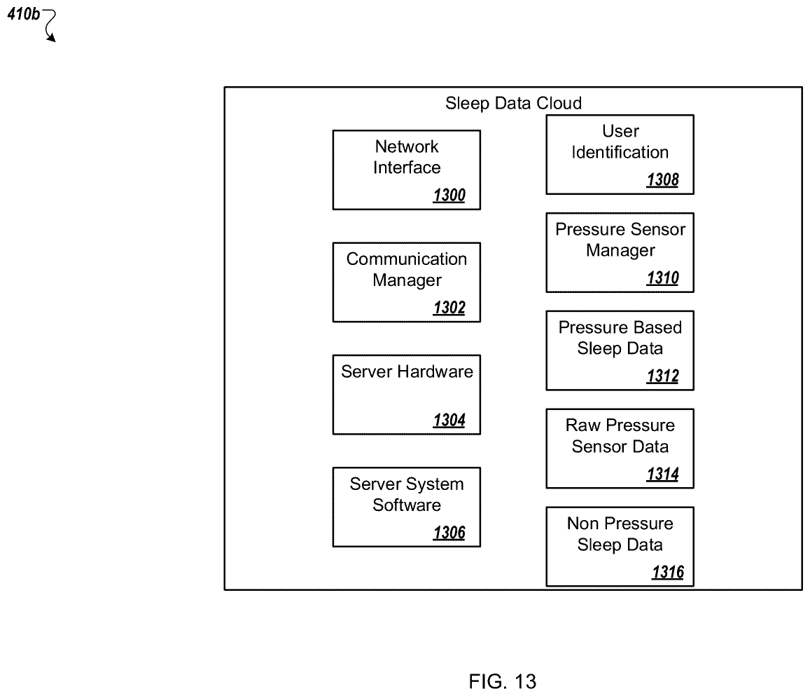

FIG. 13 is a block diagram of an example sleep data cloud service 410b that can be used in a data processing system associated with a bed system, including those described above with respect to FIGS. 1-3. In this example, the sleep data cloud service 410b is configured to record data related to users' sleep experience.

The sleep data cloud service 410b is shown with a network interface 1300, a communication manager 1302, server hardware 1304, and server system software 1306. In addition, the sleep data cloud service 410b is shown with a user identification module 1308, a pressure sensor manager 1310, a pressure based sleep data module 1312, a raw pressure sensor data module 1314, and a non-pressure sleep data module 1316. Sometimes, the sleep data cloud service 410b can include a sensor manager for each of the sensors that are integrated or otherwise in communication with the bed. In some implementations, the sleep data cloud service 410b can include a sensor manager that relates to multiple sensors in beds. For example, a single sensor manager can relate to pressure, temperature, light, movement, and audio sensors in a bed.

Referring to the sleep data cloud service 410b in FIG. 13, the pressure sensor manager 1310 can include, or reference, data related to the configuration and operation of pressure sensors in beds. For example, this data can include an identifier of the types of sensors in a particular bed, their settings and calibration data, etc.

The pressure based sleep data 1312 can use raw pressure sensor data 1314 to calculate sleep metrics specifically tied to pressure sensor data. For example, user presence, movements, weight change, heartrate, and breathing rate can all be determined from raw pressure sensor data 1314. Additionally, an index or indexes stored by the sleep data cloud service 410b can identify users that are associated with pressure sensors, raw pressure sensor data, and/or pressure based sleep data.

The non-pressure sleep data 1316 can use other sources of data to calculate sleep metrics. For example, user-entered preferences, light sensor readings, and sound sensor readings can all be used to track sleep data. Additionally, an index or indexes stored by the sleep data cloud service 410b can identify users that are associated with other sensors and/or non-pressure sleep data 1316.

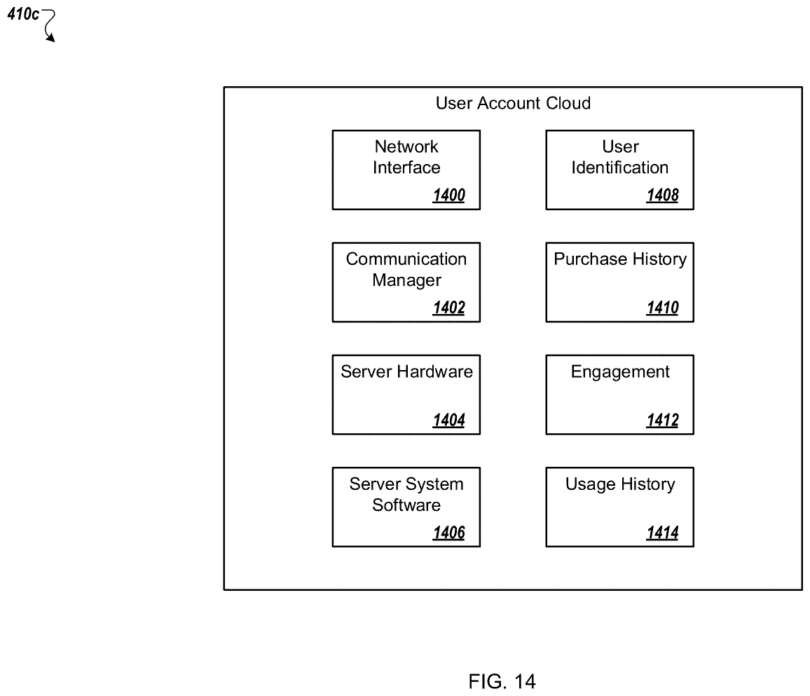

FIG. 14 is a block diagram of an example user account cloud service 410c that can be used in a data processing system associated with a bed system, including those described above with respect to FIGS. 1-3. In this example, the user account cloud service 410c is configured to record a list of users and to identify other data related to those users.

The user account cloud service 410c is shown with a network interface 1400, a communication manager 1402, server hardware 1404, and server system software 1406. In addition, the user account cloud service 410c is shown with a user identification module 1408, a purchase history module 1410, an engagement module 1412, and an application usage history module 1414.

The user identification module 1408 can include, or reference, data related to users of beds with associated data processing systems. For example, the users can include customers, owners, or other users registered with the user account cloud service 410c or another service. Each user can have, for example, a unique identifier, and user credentials, demographic information, or any other technologically appropriate information. Each user can also have user-inputted preferences pertaining to the user's bed system (e.g., firmness settings, heating/cooling settings, inclined and/or declined positions of different regions of the bed, etc.), ambient environment (e.g., lighting, temperature, etc.), and/or peripheral devices (e.g., turning on or off a television, coffee maker, security system, alarm clock, etc.).

The purchase history module 1410 can include, or reference, data related to purchases by users. For example, the purchase data can include a sale's contact information, billing information, and salesperson information that is associated with the user's purchase of the bed system. Additionally, an index or indexes stored by the user account cloud service 410c can identify users that are associated with a purchase of the bed system.

The engagement 1412 can track user interactions with the manufacturer, vendor, and/or manager of the bed and or cloud services. This engagement data can include communications (e.g., emails, service calls), data from sales (e.g., sales receipts, configuration logs), and social network interactions. The engagement data can also include servicing, maintenance, or replacements of components of the user's bed system.

The usage history module 1414 can contain data about user interactions with one or more applications and/or remote controls of a bed. For example, a monitoring and configuration application can be distributed to run on, for example, computing devices 412. The computing devices 412 can include a mobile phone, laptop, tablet, computer, smartphone, and/or wearable device of the user. The computing devices 412 can also include a central controller or hub device that can be used to control operations of the bed system and one or more peripheral devices. Moreover, the computing devices 412 can include a home automation device. The application that is presented to the user via the computing devices 412 can log and report user interactions for storage in the application usage history module 1414. Additionally, an index or indexes stored by the user account cloud service 410c can identify users that are associated with each log entry. User interactions that are stored in the application usage history module 1414 can optionally be used to determine or otherwise predict user preferences and/or settings for the user's bed and/or peripheral devices that can improve the user's overall sleep quality.

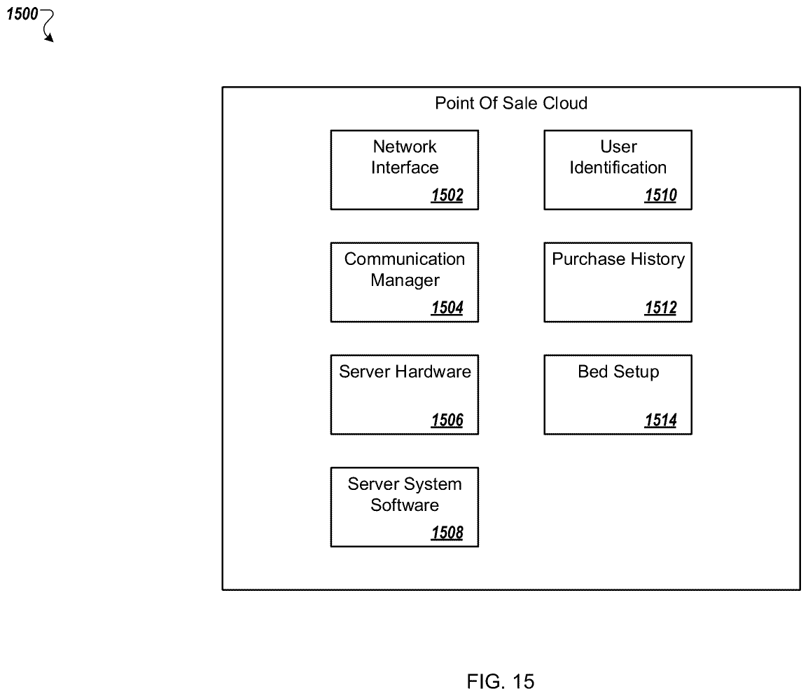

FIG. 15 is a block diagram of an example point of sale cloud service 1500 that can be used in a data processing system associated with a bed system, including those described above with respect to FIGS. 1-3. In this example, the point of sale cloud service 1500 is configured to record data related to users' purchases, specifically purchases of bed systems described herein.

The point of sale cloud service 1500 is shown with a network interface 1502, a communication manager 1504, server hardware 1506, and server system software 1508. In addition, the point of sale cloud service 1500 is shown with a user identification module 1510, a purchase history module 1512, and a bed setup module 1514.

The purchase history module 1512 can include, or reference, data related to purchases made by users identified in the user identification module 1510. The purchase information can include, for example, data of a sale, price, and location of sale, delivery address, and configuration options selected by the users at the time of sale. These configuration options can include selections made by the user about how they wish their newly purchased beds to be setup and can include, for example, expected sleep schedule, a listing of peripheral sensors and controllers that they have or will install, etc.

The bed setup module 1514 can include, or reference, data related to installations of beds that users purchase. The bed setup data can include, for example, a date and address to which a bed is delivered, a person who accepts delivery, configuration that is applied to the bed upon delivery (e.g., firmness settings), name or names of a user or users who will sleep on the bed, which side of the bed each user will use, etc.

Data recorded in the point of sale cloud service 1500 can be referenced by a user's bed system at later dates to control functionality of the bed system and/or to send control signals to peripheral components according to data recorded in the point of sale cloud service 1500. This can allow a salesperson to collect information from the user at the point of sale that later facilitates automation of the bed system. In some examples, some or all aspects of the bed system can be automated with little or no user-entered data required after the point of sale. In other examples, data recorded in the point of sale cloud service 1500 can be used in connection with a variety of additional data gathered from user-entered data.

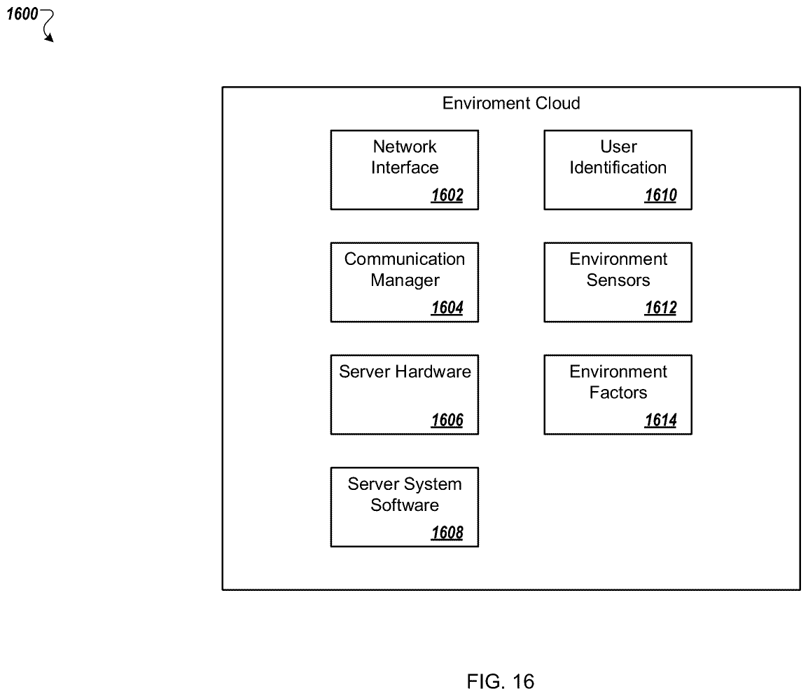

FIG. 16 is a block diagram of an example environment cloud service 1600 that can be used in a data processing system associated with a bed system, including those described above with respect to FIGS. 1-3. In this example, the environment cloud service 1600 is configured to record data related to users' home environment.

The environment cloud service 1600 is shown with a network interface 1602, a communication manager 1604, server hardware 1606, and server system software 1608. In addition, the environment cloud service 1600 is shown with a user identification module 1610, an environmental sensors module 1612, and an environmental factors module 1614.

The environmental sensors module 1612 can include a listing and identification of sensors that users identified in the user identification module 1610 have installed in and/or surrounding their bed. These sensors may include any sensors that can detect environmental variables, including but not limited to light sensors, noise/audio sensors, vibration sensors, thermostats, movement sensors (e.g., motion), etc. Additionally, the environmental sensors module 1612 can store historical readings or reports from those sensors. The environmental sensors module 1612 can then be accessed at a later time and used by one or more of the cloud services described herein to determine sleep quality and/or health information of the users.

The environmental factors module 1614 can include reports generated based on data in the environmental sensors module 1612. For example, the environmental factors module 1614 can generate and retain a report indicating frequency and duration of instances of increased lighting when the user is asleep based on light sensor data that is stored in the environment sensors module 1612.

In the examples discussed here, each cloud service 410 is shown with some of the same components. In various configurations, these same components can be partially or wholly shared between services, or they can be separate. In some configurations, each service can have separate copies of some or all of the components that are the same or different in some ways. Additionally, these components are only provided as illustrative examples. In other examples, each cloud service can have different number, types, and styles of components that are technically possible.

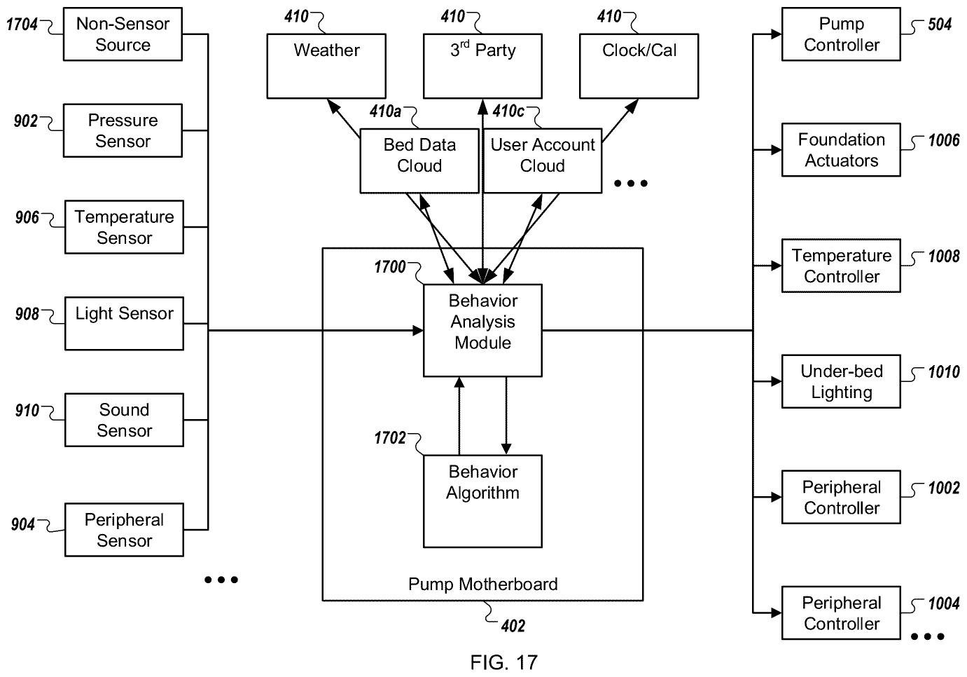

FIG. 17 is a block diagram of an example of using a data processing system associated with a bed (e.g., a bed of the bed systems described herein, such as in FIGS. 1-3) to automate peripherals around the bed. Shown here is a behavior analysis module 1700 that runs on the pump motherboard 402. For example, the behavior analysis module 1700 can be one or more software components stored on the computer memory 512 and executed by the processor 502.

In general, the behavior analysis module 1700 can collect data from a wide variety of sources (e.g., sensors 902, 904, 906, 908, and/or 910, non-sensor local sources 1704, cloud data services 410a and/or 410c) and use a behavioral algorithm 1702 (e.g., one or more machine learning models) to generate one or more actions to be taken (e.g., commands to send to peripheral controllers, data to send to cloud services, such as the bed data cloud 410a and/or the user account cloud 410c). This can be useful, for example, in tracking user behavior and automating devices in communication with the user's bed.

The behavior analysis module 1700 can collect data from any technologically appropriate source, for example, to gather data about features of a bed, the bed's environment, and/or the bed's users. Some such sources include any of the sensors of the sensor array 406 that is previously described (e.g., including but not limited to sensors such as 902, 904, 906, 908, and/or 910). For example, this data can provide the behavior analysis module 1700 with information about a current state of the environment around the bed. For example, the behavior analysis module 1700 can access readings from the pressure sensor 902 to determine the pressure of an air chamber in the bed. From this reading, and potentially other data, user presence in the bed can be determined. In another example, the behavior analysis module 1700 can access the light sensor 908 to detect the amount of light in the bed's environment. The behavior analysis module 1700 can also access the temperature sensor 906 to detect a temperature in the bed's environment and/or one or more microclimates in the bed. Using this data, the behavior analysis module 1700 can determine whether temperature adjustments should be made to the bed's environment and/or components of the bed in order to improve the user's sleep quality and overall comfortability.

Similarly, the behavior analysis module 1700 can access data from cloud services and use such data to make more accurate determinations of user sleep quality, health information, and/or control of the user's bed and/or peripheral devices. For example, the behavior analysis module 1700 can access the bed cloud service 410a to access historical sensor data 1212 and/or advanced sleep data 1214. Other cloud services 410, including those previously described can be accessed by the behavior analysis module 1700. For example, the behavior analysis module 1700 can access a weather reporting service, a 3^{rd} party data provider (e.g., traffic and news data, emergency broadcast data, user travel data), and/or a clock and calendar service. Using data that is retrieved from the cloud services 410, the behavior analysis module 1700 can more accurately determine user sleep quality, health information, and/or control of the user's bed and/or peripheral devices.

Similarly, the behavior analysis module 1700 can access data from non-sensor sources 1704. For example, the behavior analysis module 1700 can access a local clock and calendar service (e.g., a component of the motherboard 402 or of the processor 502). The behavior analysis module 1700 can use the local clock and/or calendar information to determine, for example, times of day that the user is in the bed, asleep, waking up, and/or going to bed.

The behavior analysis module 1700 can aggregate and prepare this data for use with one or more behavioral algorithms 1702. As mentioned, the behavioral algorithm 1702 can include machine learning models. The behavioral algorithms 1702 can be used to learn a user's behavior and/or to perform some action based on the state of the accessed data and/or the predicted user behavior. For example, the behavior algorithm 1702 can use available data (e.g., pressure sensor, non-sensor data, clock and calendar data) to create a model of when a user goes to bed every night. Later, the same or a different behavioral algorithm 1702 can be used to determine if an increase in air chamber pressure is likely to indicate a user going to bed and, if so, send some data to a third-party cloud service 410 and/or engage a peripheral controller 1002 or 1004, foundation actuators 1006, a temperature controller 1008, and/or an under-bed lighting controller 1010.

In the example shown, the behavioral analysis module 1700 and the behavioral algorithm 1702 are shown as components of the pump motherboard 402. However, other configurations are possible. For example, the same or a similar behavioral analysis module 1700 and/or behavioral algorithm 1702 can be run in one or more cloud services, and resulting output can be sent to the pump motherboard 402, a controller in the controller array 408, or to any other technologically appropriate recipient described throughout this document.

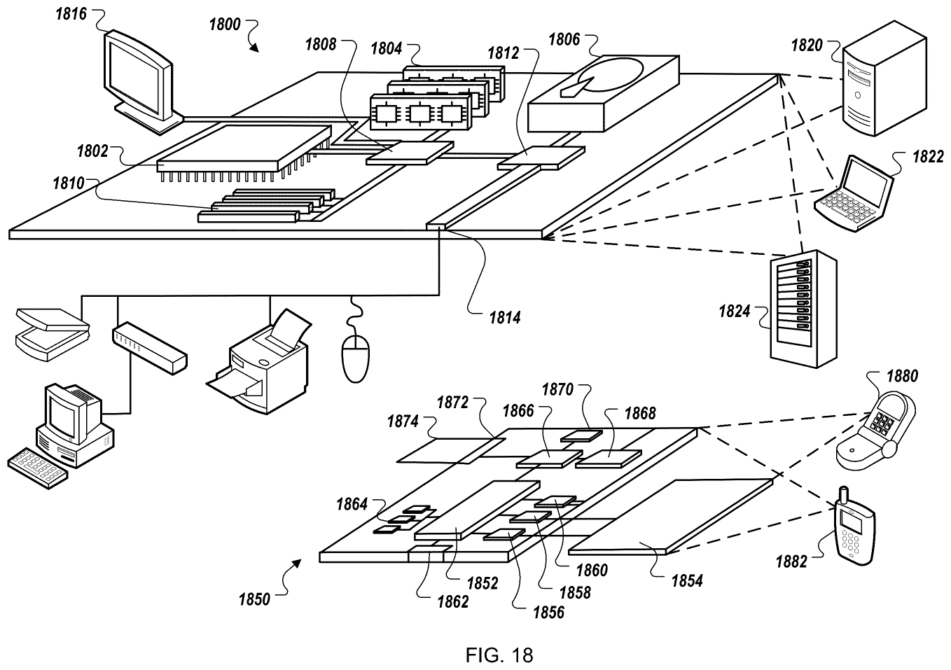

FIG. 18 shows an example of a computing device 1800 and an example of a mobile computing device that can be used to implement the techniques described here. The computing device 1800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and can be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1804 stores information within the computing device 1800. In some implementations, the memory 1804 is a volatile memory unit or units. In some implementations, the memory 1804 is a non-volatile memory unit or units. The memory 1804 can also be another form of computer-readable medium, such as a magnetic or optical disk.

The storage device 1806 is capable of providing mass storage for the computing device 1800. In some implementations, the storage device 1806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1804, the storage device 1806, or memory on the processor 1802.

The high-speed interface 1808 manages bandwidth-intensive operations for the computing device 1800, while the low-speed interface 1812 manages lower bandwidth-intensive operations. Such allocation of functions is exemplary only. In some implementations, the high-speed interface 1808 is coupled to the memory 1804, the display 1816 (e.g., through a graphics processor or accelerator), and to the high-speed expansion ports 1810, which can accept various expansion cards (not shown). In the implementation, the low-speed interface 1812 is coupled to the storage device 1806 and the low-speed expansion port 1814. The low-speed expansion port 1814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1800 can be implemented in a number of different forms, as shown in the figure. For example, it can be implemented as a standard server 1820, or multiple times in a group of such servers. In addition, it can be implemented in a personal computer such as a laptop computer 1822. It can also be implemented as part of a rack server system 1824. Alternatively, components from the computing device 1800 can be combined with other components in a mobile device (not shown), such as a mobile computing device 1850. Each of such devices can contain one or more of the computing device 1800 and the mobile computing device 1850, and an entire system can be made up of multiple computing devices communicating with each other.

The mobile computing device 1850 includes a processor 1852, a memory 1864, an input/output device such as a display 1854, a communication interface 1866, and a transceiver 1868, among other components. The mobile computing device 1850 can also be provided with a storage device, such as a micro-drive or other device, to provide additional storage. Each of the processor 1852, the memory 1864, the display 1854, the communication interface 1866, and the transceiver 1868, are interconnected using various buses, and several of the components can be mounted on a common motherboard or in other manners as appropriate.

The processor 1852 can execute instructions within the mobile computing device 1850, including instructions stored in the memory 1864. The processor 1852 can be implemented as a chip set of chips that include separate and multiple analog and digital processors. The processor 1852 can provide, for example, for coordination of the other components of the mobile computing device 1850, such as control of user interfaces, applications run by the mobile computing device 1850, and wireless communication by the mobile computing device 1850.

The processor 1852 can communicate with a user through a control interface 1858 and a display interface 1856 coupled to the display 1854. The display 1854 can be, for example, a TFT (Thin-Film-Transistor Liquid Crystal Display) display or an OLED (Organic Light Emitting Diode) display, or other appropriate display technology. The display interface 1856 can comprise appropriate circuitry for driving the display 1854 to present graphical and other information to a user. The control interface 1858 can receive commands from a user and convert them for submission to the processor 1852. In addition, an external interface 1862 can provide communication with the processor 1852, so as to enable near area communication of the mobile computing device 1850 with other devices. The external interface 1862 can provide, for example, for wired communication in some implementations, or for wireless communication in other implementations, and multiple interfaces can also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 can also be provided and connected to the mobile computing device 1850 through an expansion interface 1872, which can include, for example, a SIMM (Single In Line Memory Module) card interface. The expansion memory 1874 can provide extra storage space for the mobile computing device 1850, or can also store applications or other information for the mobile computing device 1850. Specifically, the expansion memory 1874 can include instructions to carry out or supplement the processes described above, and can include secure information also. Thus, for example, the expansion memory 1874 can be provide as a security module for the mobile computing device 1850, and can be programmed with instructions that permit secure use of the mobile computing device 1850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1864, the expansion memory 1874, or memory on the processor 1852. In some implementations, the computer program product can be received in a propagated signal, for example, over the transceiver 1868 or the external interface 1862.

The mobile computing device 1850 can communicate wirelessly through the communication interface 1866, which can include digital signal processing circuitry where necessary. The communication interface 1866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1868 using a radio-frequency. In addition, short-range communication can occur, such as using a Bluetooth, WiFi, or other such transceiver (not shown). In addition, a GPS (Global Positioning System) receiver module 1870 can provide additional navigation- and location-related wireless data to the mobile computing device 1850, which can be used as appropriate by applications running on the mobile computing device 1850.

The mobile computing device 1850 can also communicate audibly using an audio codec 1860, which can receive spoken information from a user and convert it to usable digital information. The audio codec 1860 can likewise generate audible sound for a user, such as through a speaker, e.g., in a handset of the mobile computing device 1850. Such sound can include sound from voice telephone calls, can include recorded sound (e.g., voice messages, music files, etc.) and can also include sound generated by applications operating on the mobile computing device 1850.

The mobile computing device 1850 can be implemented in a number of different forms, as shown in the figure. For example, it can be implemented as a cellular telephone 1880. It can also be implemented as part of a smart-phone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

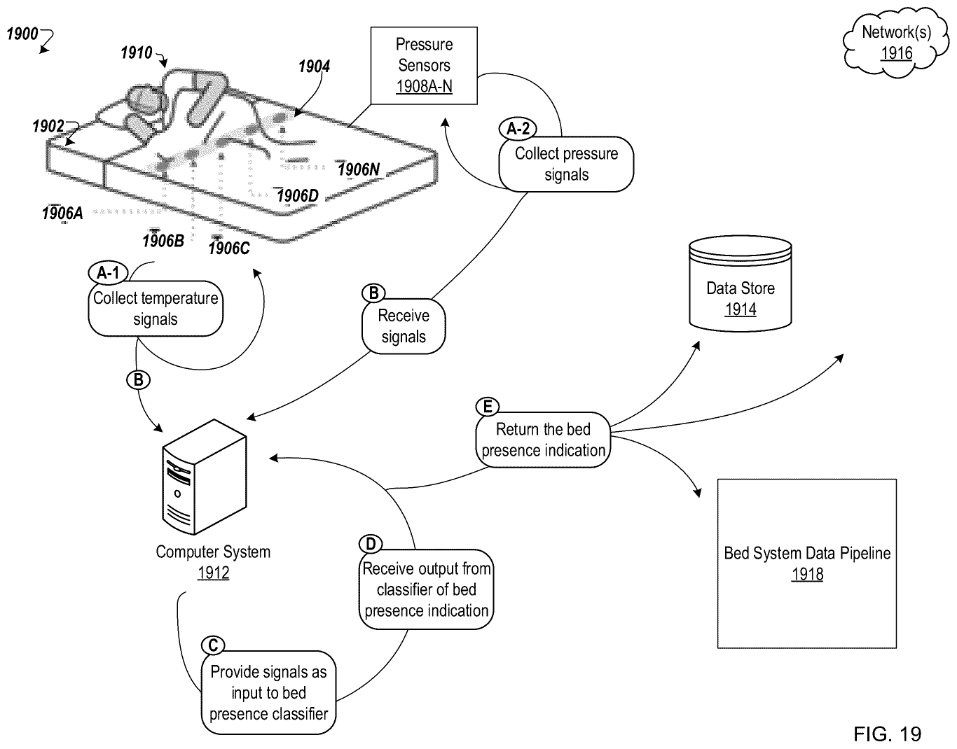

FIG. 19 is a conceptual diagram of a bed system 1900 for detecting bed presence using at least temperature signals. The bed system 1900 can include a mattress 1902. A temperature strip 1904 can be attached to the mattress 1901, the temperature strip 1904 having temperature sensors 1906A-N.

The temperature sensors 1906A-N can be arranged in series across the temperature strip 1904. The temperature sensors 1906A-N can be equally spaced apart along a length of the temperature strip 1904. In some implementations, the temperature strip 1904 can include 5 sensors. The temperature sensors 19096A-N can be spaced approximately 6 inches apart from each other along the length of the temperature strip 1904. In some implementations, the spacing between sensors can be greater or less, for example depending on a length of the temperature strip 1904. The temperature strip 1904 can include additional or fewer sensors, in some implementations. The sensors 1906A-N can be positioned along the length of the temperature strip 1904 such that the sensors 1906A-N can collect temperature signals on both sides of the mattress 1902 (e.g., a left side and a right side) where first and second users may rest. In some implementations, the bed system 1900 can include 2 temperature strips 1904, one for each side of the mattress 1902 (and therefore one for each user of the bed system 1900).

Moreover, positioning the temperature strip 1904 at a top surface of the mattress 1902 provides for the temperature sensors 1906A-N to be close to a user's body.

Therefore, the temperature sensors 1906A-N can accurately detect user body temperature and distinguish the body temperature from potential heating and/or cooling routines that have been activated inside the mattress 1902. Using 5 temperature sensors 1906A-N along the temperature strip 1904 also can, for example, provide for accurate detection of the user's body temperature to detect user bed presence.

As mentioned above, the temperature strip 1904 can be attached to the top surface of the mattress 1902 and can extend laterally from the left side to the right of the bed system 1900 at a midpoint of the mattress 1902. In some implementations, the temperature strip 1904 can be positioned closer to a head end of the mattress 1902 (e.g., where users chests/mid-backs may rest on the mattress 1902). For example, the temperature strip 1902 can be positioned approximately 30 inches from the head end of the mattress 1902. The temperature strip 1904 can also be positioned closer to a foot end of the mattress 1902. In some implementations, multiple temperature strips can be used, in which a first temperature strip can be positioned closer to the head end of the mattress 1902 and a second temperature strip can be positioned closer to the foot end of the mattress 1902. Multiple other variations of the temperature strip 1904 configuration to the mattress 1902 are also possible.

The temperature strip 1904 can be attached to the mattress 1902 with adhesives. In some implementations, the mattress 1902 can be manufactured with the temperature strip 1904. The mattress 1902 can be sold/purchased with the temperature strip 1904. The temperature strip 1904 can also be applied to a mattress at a later time (e.g., after the mattress is already purchased and/or has been used). Therefore, the temperature strip 1904 can be used to perform the disclosed techniques with any of a variety of mattresses.

In some implementations, the bed system 1900 can include temperature sensors 1906A-N that are attached to or otherwise part of the mattress 1902. For example, individual temperature sensors 1906A-N can be attached to the top surface of the mattress 1902 with adhesives. One or more of the temperature sensors 1906A-N may not be part of the temperature strip 1904, as an illustrative example. Sometimes, for example, the temperature sensors 1906A-N can be an array of sensors (e.g., 5 sensors) that are linearly arranged on the top surface of the mattress 1902 of the bed system 1900.

The bed system 1900 can also include pressure sensors 1908A-N. The pressure sensors 1908A-N can be any of the pressure sensors and/or load cells described throughout this disclosure. For example, one or more of the pressure sensors 1908A-N can be attached to a pump of the bed system 1900. The pump can be fluidically connected to at least one air chamber of the mattress 1902 and can inflate and/or deflate the at least one air chamber. In some implementations, one or more of the pressure sensors 1908A-N can be inside the at least one air chamber. Sometimes, one or more of the pressure sensors 1908A-N can be inline of a fluid connection between the at least one air chamber and the pump. As another example, the bed system 1900 can include load cells (not depicted). The load cells can be attached to one or more legs, a base, and/or support frame of the bed system 1900. Load cell data can be collected and used in combination with at least temperature signals from the temperature sensors 1906A-N to detect bed presence.

Components of the bed system 1900, such as the temperature sensors 1906A-N and the pressure sensors 1908A-N can communicate (e.g., wired and/or wireless) with a computer system 1912, a data store 1914, and/or a bed system data pipeline 1918 via network(s) 1916.

The computer system 1912 can be any type of computing system (e.g., cloud-based system, remote computer, network of computing devices, controller that is part of the bed system 1900, etc.) configured to make bed presence determinations using the disclosed techniques. In some implementations, the computer system 1912 can be part of the bed system 1900. For example, the computer system 1912 can be a controller or processor of the bed system 1900. In some implementations, the computer system 1912 can be separate and/or remote from the bed system 1900. For example, the computer system 1912 can be a cloud-based computing system configured to make bed presence determinations for one or more different bed systems.

The data store 1914 can be any type of data storage system (e.g., cloud-based data store, database, memory, network of storage devices, etc.) configured to store information about the bed system 1900, bed presence detections, bed presence classifiers, and any other data described throughout this disclosure.

The bed system data pipeline 1918 can be a data pipeline that provides for making various determinations for controlling the bed system 1900, monitoring conditions of users in the bed system 1900, and providing feedback and/or other information about the bed system 1900, a surrounding environment, and/or users of the bed system 1900. Bed presence determinations made by the computer system 1912 can be deployed in the pipeline 1918 for use in one or more operations or decisions. For example, the pipeline 1918 can receive a bed presence determination, which can be used to determine microclimate settings for the bed system 1900 (e.g., if user 1910 is detected as being in the bed system 1900, the pipeline 1918 can determine that a heating unit should be turned on to heat a microclimate of the bed system 1900). The pipeline 1918 can also use the bed presence determination to make home automation decisions (e.g., if the user 1910 is detected as being in the bed system 1900, the pipeline 1918 can determine that lights in rooms other than the bedroom can be turned off). The pipeline 1918 can also use the bed presence determination to make bed adjustment decisions (e.g., if no one is detected as being in the bed system 1900, the pipeline 1918 can determine that a foundation of the bed system 1900 should be reset to a flat position, assuming the foundation had been articulated while the user 1910 was in the bed system 1900). One or more other operations and/or decisions can be determined in the pipeline 1918 by leveraging the bed presence determinations made by the computer system 1912.

The pipeline 1918 can be deployed by a variety of computing systems, engines, and/or modules. In some implementations, the pipeline 1918 can be deployed by the computer system 1912. The computer system 1912 can then include one or more sub-components, modules, and/or engines that perform various operations in the pipeline 1918, as described above.

Still referring to FIG. 19, the temperature sensors 1906A-N can collect temperature signals in block A-1. The pressure sensors 1908A-N can collect pressure signals in block A-2. In some implementations, as described herein, load cells of the bed system 1900 can collect load cell data in addition to or instead of the pressure sensors 1908A-N. Blocks A-1 and A-2 can be performed at a same time. Blocks A-1 and A-2 can be performed at different times. In some implementations, only block A-1 may be performed (e.g., if the bed system 1900 only has temperature sensors 1906A-N and does not have pressure sensors 1908A-N, if only the temperature sensors 1906A-N are activated, etc.). In some implementations, only block A-2 may be performed (e.g., if the bed system 1900 only has pressure sensors 1908A-N, if only the pressure sensors 1908A-N are activated, etc.). In some implementations, the signals can be continuously collected in blocks A-1 and/or A-2. The signals can also be collected in blocks A-1 and/or A-2 at predetermined time intervals. For example, the temperature signals can be collected in 1-second time intervals in block A-1. The pressure signals can also be collected in 1-second time intervals in block A-2. The temperature and/or pressure signals can also be collected in one or more other time intervals, including but not limited to 2-second time intervals, 3-second time intervals, 4-second time intervals, 5-second time intervals, etc.

In block B, the computer system 1912 can receive the temperature signals from the temperature sensors 1906A-N and/or the pressure signals from the pressure sensors 1908A-N. The computer system 1912 can receive the signals in real-time, as they are collected in blocks A-1 and/or A-2. In some implementations, the computer system 1912 can receive the temperature signals and/or the pressure signals in a batch at predetermined times. For example, the computer system 1912 can receive the signals in the batch every 5 minutes. The predetermined time can include one or more periods of time, including but not limited to every 1 minute, 2 minutes, 3 minutes, 4 minutes, 6 minutes, 7 minutes, 8 minutes, 9 minutes, 10 minutes, 15 minutes, 20 minutes, etc. The computer system 1912 can receive the signals whenever the computer system 1912 is performing a bed presence determination.

The computer system 1912 can provide the received signals as input to a bed presence classifier in block C. The bed presence classifier can be deployed at the computer system 1912. The bed presence classifier can be stateless, meaning the classifier can determine bed presence on the currently received signals rather than prior states of bed presence at the bed system 1900. As a result, the bed presence classifier can accurately, quickly, and efficiently determine a current bed presence in the bed system 1900 by using less processing power and compute resources.

In some implementations, as described herein, the bed presence classifier can be trained to determine bed presence based on just the temperature signals. The bed presence classifier can also be trained to determine bed presence based on a combination of temperature and pressure signals. In such scenarios, the bed presence classifier could be trained to differentiate the temperature signals from the pressure signals, identify a peak value in the temperature signals and a peak value in the pressure signals, and generate a bed presence indication based on correlating the peak value in the temperature signals with the peak value in the pressure signals. The peak value in the temperature signals can be within a threshold distance from the peak value in the pressure signals, in some implementations. In other words, the classifier could be trained with machine learning techniques to correlate (i) increases in the temperature signals and increases in the pressure signals with presence of the user 1910 in the bed system 1900 and (ii) decreases in the temperature signals and decreases in the pressure signals with absence of the user 1910 from the bed system 1900.

The bed presence classifier can be a logistic regression classifier, in some implementations. A logistic regression classifier can take into account all temperature and pressure signals at once to accurately determine bed presence or exit (and/or an estimation or probability of an in-bed event). The bed presence classifier can also be any other type of machine learning algorithm, including but not limited to deep neural networks, convolutional neural network (CNNs), etc. The bed presence classifier can be trained using a machine learning model to correlate increases in the temperature signals with presence of the user 1910 in the bed system 1900 and decreases in the temperature signals with absence of the user 1910 from the bed system 1900. The training can be performed such that the bed presence classifier can detect bed presence of any user in any bed system. In some implementations, the classifier can be trained to detect bed presence of the particular user 1910 and/or in the particular bed system 1900.

In some implementations, the computer system 1912 can receive the signals from the temperature sensors 1906A-N and/or the pressure sensors 1908A-N for a threshold period of time (block B). The computer system 1912 can then separate the received signals into threshold frames, such as 1-second frames. Then, the computer system 1912 can provide each of the threshold frames as input to the bed presence classifier in block C. As a result, the bed presence classifier can generate bed presence determinations for each of the threshold frames. In other words, the classifier can determine whether the user 1910 is present in the bed system 1900 at every second. One or more other threshold frames of time can be used, including but not limited to 2-second frames, 3-second frames, 4-second frames, 5-second frames, 6-second frames, 7-second frames, 8-second frames, 9-second frames, 10-second frames, 15-second frames, 20-second frames, 30-second frames, etc. Moreover, the computer system 1912 can receive another set of signals from the temperature sensors 1906A-N and/or the pressure sensors 1908A-N during another threshold period of time, the another threshold period of time being adjacent to the threshold period of time. The threshold period of time may not overlap with the another threshold period of time. The computer system 1912 can then separate the signals received during the another threshold period of time into the threshold frames, and process each of those separated signals through the bed presence classifier.

In block D, the computer system 1912 can receive output from the classifier of a bed presence indication. The bed presence indication can be an indication that the user 1910 is in the bed system 1900. The bed presence indication can also be an indication that the user 1910 exited the bed system 1900. The bed presence indication can also be a probability (e.g. likelihood) that the user 1910 is currently in the bed system 1900. The bed presence indication can be a numeric value assigned along a scale of integer values, such as 0 to 1, 0 to 5, 0 to 10, 1 to 5, 1 to 10, etc. A lower numeric value, such as 0 or 1, can indicate that the user 1910 is absent from the bed system 1900. A higher numeric value, such as 1, 5, 10, etc., can indicate that the user 1910 is presently in the bed system 1900. The bed presence indication can also be a string value and/or a Boolean value, in some implementations.

In some implementations, the computer system 1912 can also determine a time at which the user 1910 enters the bed system 1900 and/or exits the bed system 1900 as a time associated with the temperature signals and/or the pressure signals received from the temperature sensors 1906A-N and/or the pressure sensors 1908A-N, respectively. In some implementations, the computer system 1912, and/or the bed presence classifier, can normalize the bed presence indication to a binary value. A binary value of 0 can indicate that the user 1910 is absent from the bed system 1900 and a binary value of 1 can indicate that the user 1910 is in the bed system 1900. One or more other binary values can be used, including but not limited to 0 to 5, 1 to 5, 1 to 10, 0 to 10, etc. The binary values can also be non-numeric/integer values, such as True/False, In bed/Out of bed, Yes/No, etc. The binary value can then be returned as output in block D.

Moreover, in block D, the computer system 1912 can generate an indication that the user 1910 is in the bed system 1900 based on a determination that the bed presence indication exceeds a threshold value. The computer system 1912 can also generate an indication that the user 1910 is absent from the bed system 1900 (e.g., exited the bed system 1900) based on a determination that the bed presence indication is less than the threshold value. The threshold value can be 0.5, in some implementations. One or more threshold values can be used, which can be based on sensitivity in detecting bed presence from temperature signals and/or pressure signals.

The computer system 1912 can return the bed presence indication in block E. Returning the bed presence indication can include storing the bed presence indication in the data store 1914. Returning the bed presence indication can also include passing the indication to the bed system data pipeline 1918 for further processing and use in one or more bed system operations. For example, the computer system 1912 can provide the bed presence indication to the pipeline 1918, which can include at least one classifier that was trained to determine at least one of user sleep metrics or user health metrics based at least in part on the bed presence indication.

For example, the computer system 1912 can provide the bed presence indication as input to a sleep walking detection classifier in the pipeline 1918. The sleep walking detection classifier can be configured to predict likelihood of a sleepwalking event occurring during a current sleep session based at least in part on the bed presence indication (e.g., predicting that the user 1910 is likely to sleep walk if the user 1910 is currently in the bed system 1900, predicting that the user 1910 is sleep walking if they are not currently in the bed system 1900, etc.). As another example, the computer system 1912 can provide the bed presence indication to a microclimate adjustment module in the pipeline. The microclimate adjustment module can be configured to generate instructions that cause one or more components of the bed system 1900 to adjust a microclimate at the top surface of the bed system 1900 based at least in part on the bed presence indication (e.g., turning on a heating routine when the user 1910 is detected in the bed system 1900, turning off a heating or cooling routine when the user 1910 is absent from the bed system 1900, etc.). As another example, returning the bed presence indication in block E can include generating instructions, based on the bed presence indication, to actuate a home automation device.

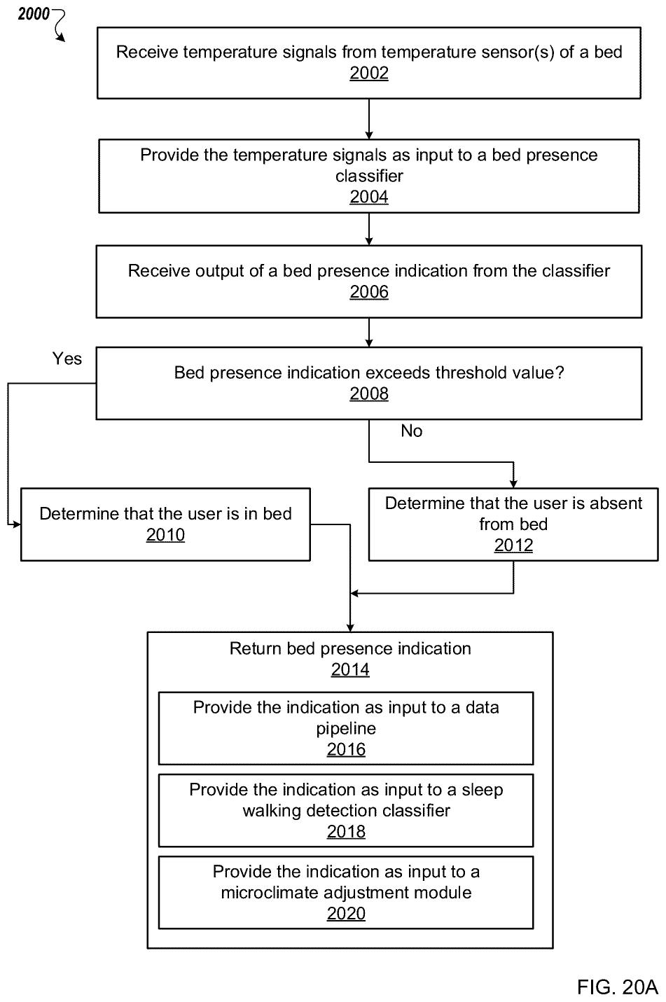

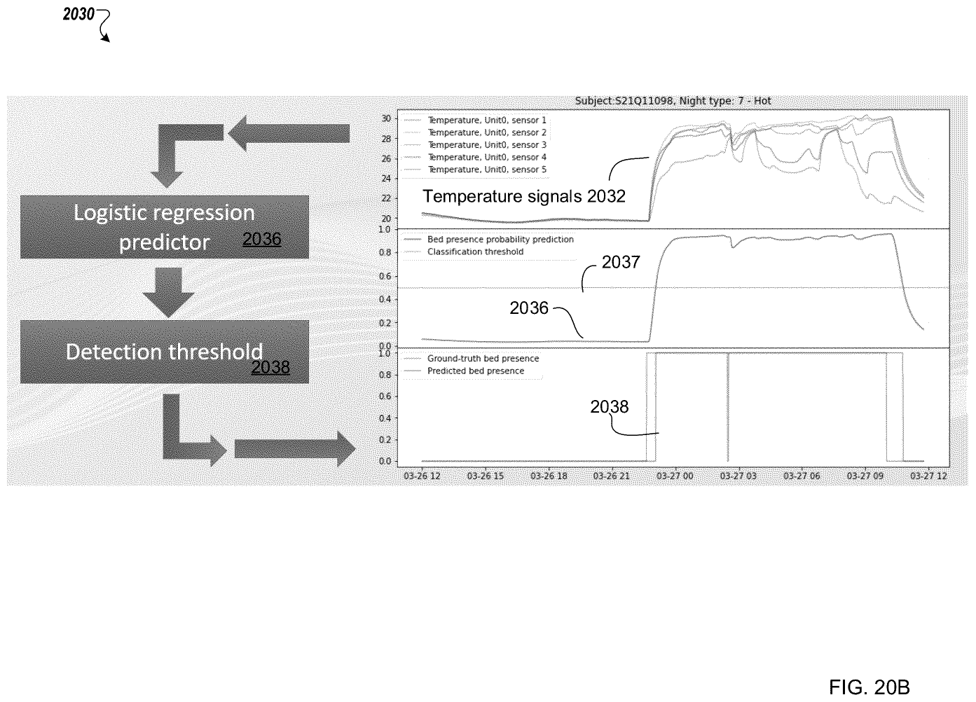

FIG. 20A is a flowchart of a process 2000 for detecting bed presence using temperature signals. The process 2000 can be performed by the computer system 1912. The process 2000 can also be performed by one or more other computing systems, network of devices, computing devices, cloud-based systems, and/or controllers of beds. For illustrative purposes, the process 2000 is described from the perspective of a computer system that can be used to control one or more components of the bed. The computer system can also be a server, such as a remote computer system, that can be used to generate instructions for execution by controllers of beds. In some implementations, the computer system can also be a controller of a bed.

Referring to the process 2000 in FIG. 20A, the computer system can receive temperature signals from at least one temperature sensor of a bed in block 2002. Refer to blocks A-1 and B in FIG. 19 for further discussion.

In block 2004, the computer system can provide the temperature signals as input to a bed presence classifier. Refer to block C in FIG. 19 for further discussion.

The computer system can receive output of a bed presence indication from the classifier in block 2006. Refer to block D in FIG. 19 for further discussion. As described in reference to block D in FIG. 19, the bed presence indication can be a numeric value, string value, and/or Boolean value, for example, indicating whether the user is in bed and/or a likelihood or probability that the user is in the bed. In some implementations, the classifier (such as a logistic regression classifier) can output a numeric value. The numeric value can be on a scale of 0 to 1, as an illustrative example. A subsequent processing step can apply a threshold to the numeric value to obtain a binary value. The binary value can be True (1) or False (0) score that represents bed presence. The binary value can be the bed presence indication. The computer system can also convert the binary value or the numeric value into a probability value indicating a likelihood that the user is in the bed. The probability value can be a numeric value, such as between 0 and 1, where 0 indicates that the user is out of the bed and 1 indicates that the user is in the bed. One or more other probability values can be used as described throughout this disclosure.

As described herein, the bed presence indication can be determined by the classifier at predetermined time intervals. For example, the classifier can determine the bed presence indication every 5 minutes. As another example, the classifier can determine the bed presence indication at variable times when computing resources are available. As yet another example, the classifier can determine the bed presence indication in response to a request from another computing device and/or a controller of the bed.

In some implementations, the computer system can receive the temperature signals in block 2002 every 5 minutes, then provide the temperature signals to the classifier to generate the bed presence indication. The classifier can also generate the bed presence indication based on one or more other time intervals, including but not limited to every 1 minute, 2 minutes, 3 minutes, 4 minutes, 6 minutes, 7 minutes, 8 minutes, 9 minutes, 10 minutes. As a result, bed presence of the user can be determined continuously and/or more than once throughout a sleep session of the user.

The computer system can determine whether the bed presence indication exceeds a threshold value (block 2008). Refer to block D in FIG. 19 for further discussion. The threshold value can, for example, define a probability that the user is in bed. Where the bed presence indication can be a numeric value between 0 and 1, the threshold value can be 0.5. Any numeric value of 0.5 to 1 can indicate that the user is likely in the bed while any numeric value between 0 and 0.5 can indicate that the user is likely not in the bed. The threshold value can also be adjusted accordingly to compensate for varying degrees of signal detection sensitivity. For example, the threshold value can be lowered, for example to 0.3, to increase sensitivity. As another example, the threshold value can be raised, for example, to 0.8, to increase specificity. The threshold value can vary depending on the type of bed, the type of sensors, a firmness of a mattress of the bed, whether the bed is articulated, whether a heating/cooling routine is activated, a certainty that the user is in bed, varying degrees of sensitivity, varying degrees of specificity, and/or one or more other factors. As another example, the threshold value can be adjusted to prioritize sensitivity to reduce or otherwise avoid false negatives. Sensitivity of the threshold value can also be adjusted based on estimation of microclimates on the surface of the bed. Sensitivity of the threshold value can also be adjusted based on an estimated body temperature of the user during a sleep session. Therefore, the temperature signals can be received and processed by the computer system to determine whether the user is in bed, whether the user is actually asleep, and/or a current body temperature of the user. As another example, sensitivity of the threshold value can be adjusted to provide for estimation of illness onset of the user. As a result, the temperature signals can be received and processed by the computer system to determine whether the user is in bed, whether the user is actually asleep, and/or whether the user is developing fever or other illness symptoms based on changes in their body temperature.

If the bed presence indication exceeds the threshold value, the computer system can determine that the user is in bed (block 2010). The computer system can then proceed to block 2014, discussed below. For example, when the user enters the bed, temperature detected at the surface of the bed may immediately increase because of the user's body temperature. The spike in temperature can indicate that the user is likely in bed, resulting in a higher value being assigned to the bed presence indication. Therefore, the bed presence indication can exceed the threshold value.

If the bed presence indication is less than the threshold value, the computer system can determine that the user is absent from the bed (block 2012). The computer system can then proceed to block 2014. For example, when the user exits the bed, temperature detected at the surface of the bed may immediately decrease because of the sudden absence of the user's body temperature. The sudden drop in temperature can indicate that the user has likely exited the bed, and thus a lower value can be assigned to the bed presence indication. The bed presence indication can therefore be less than the threshold value.

In block 2014, the computer system can return the bed presence indication. Returning the bed presence indication can include providing the indication as input to a data pipeline (block 2016) (e.g., the bed system data pipeline 1918 of FIG. 19). Returning the bed presence indication can additionally or alternatively include providing the indication as input to a sleep walking detection classifier (block 2018). Returning the bed presence indication can additionally or alternatively include providing the indication as input to a microclimate adjustment module (block 2020). The indication can also be provided to one or more other modules, engines, and/or classifiers for use in further processing and determinations made about the user of the bed (e.g., health metrics of the user) and/or control/adjustment of the bed (e.g., adjusting a firmness level, articulating a foundation of the bed, raising/lowering the bed, turning on/off home automation devices and/or environmental systems and/or devices, etc.). Refer to block E in FIG. 19 for further discussion.

In some implementations, returning the bed presence indication can include outputting the bed presence indication to the user of the bed and/or other relevant users. Presenting the bed presence indication to the user can be beneficial for behavioral coaching and/or recommending for the user to keep certain timing and/or regularity in times they go to sleep so that they can improve their overall sleep quality and/or health.

As described herein, the process 2000 can be performed throughout a sleep session of the user. The process 2000 can be performed at time intervals, such as every 5 minutes, every 3 minutes, every 1 minute. In some implementations, the process 2000 can be performed continuously. In some implementations, one or more blocks of the process 2000 can be performed at the predetermined time intervals described herein. As non-limiting example, the classifier can determine the bed presence indication every 5 minutes, the computer system can continuously receive temperature signals from the at least one temperature sensor, and/or the computer system can return the bed presence indication whenever it is generated and/or at the end of the sleep session.

FIG. 20B is a conceptual diagram of a process 2030 for detecting bed presence using temperature signals. The process 2030 is similar to the process 2000 described in FIG. 20A in that the process 2030 can be used to process temperature signals to determine bed presence of a user in a bed. The process 2030 can be performed by the computer system 1912. The process 2030 can also be performed by one or more other computing systems, network of devices, computing devices, cloud-based systems, and/or controllers of beds. For illustrative purposes, the process 2030 is described from the perspective of a computer system.

Temperature signals 2032 are received by the computer system from temperature sensors at a bed system. In the illustrative example of FIG. 20B, the temperature signals 2302 are received from 5 sensors between a timeframe of noon (hour 12) on March 26^{th} to noon (hour 12) on March 27th. The temperature signals 2302 can be collected at 1 minute intervals during the above timeframe. In some implementations, the temperature signals 2302 can be collected at one or more other intervals of time (e.g., second intervals, 2 minute intervals, 3 minute intervals, 5 minute intervals, etc.). The temperature signals 2302 are collected in ° C. As shown, the temperature signals 2032 spike from all of the 5 sensors between March 26^{th} at hour 21 and March 27^{th} at hour 0 (midnight). The temperature signals 2032 then remain relatively high until they begin to drop between hour 9 on March 27^{th} and hour 12 (noon) on March 27^{th}. The spike in the temperature signals 2032 can indicate the user entering the bed. The drop in the temperature signals 2032 can indicate that the user is moving in the bed and/or exiting the bed. Refer to blocks A-1 and B in FIG. 19 and block 2002 in FIG. 20A for further discussion about receiving the temperature signals 2032.

The temperature signals 2032 are provided as input to a logistic regression predictor 2036. The logistic regression predictor 2306 can be the bed presence classifier described throughout this disclosure. Refer to blocks C-D in FIG. 19 and blocks 2004-2006 in FIG. 20A.

The logistic regression predictor 2306 can generate a bed presence indication, which can be a binary value. The computer system can convert the binary value into a bed presence probability prediction 2036. As shown in FIG. 20B, the bed presence probability prediction 2036 can be a numeric value between 0 and 1. 0 can indicate lowest probability (or no probability) that the user is in the bed. 1 can indicate highest probability that the user is in the bed. The bed presence probability prediction 2036 generally matches to or aligns with the temperature signals 2032 received from the temperature sensors. A classification threshold 2037 has also been established at the numeric value of 0.5.

The computer system can then determine whether the bed presence probability prediction 2306 satisfies or exceeds the classification threshold 2037 to determine and return a predicted bed presence 2038. As shown in FIG. 20B, the bed presence probability prediction 2306 exceeds the classification threshold 2037 between hour 21 on March 26^{th} and hour 0 (midnight) on March 27^{th}, which indicates that the user likely gets into bed during that timeframe. Therefore, the computer system can return an indication of the predicted bed presence 2038 as the user entering the bed between hour 21 on March 26^{th} and hour 0 (midnight) on March 27^{th}. The predicted bed presence 2038 can be represented as a binary value or binary decision (e.g., True (1)/False (0), Yes (1)/No (0)).

The computer system can return indications of times at which the user was detected as being in bed and/or being out of bed throughout a sleep session. These indications can be outputted and presented to the user at a user device, such as the user's mobile phone, as a text message, push notification, alert, and/or in-app notification. These indications can also be stored in a data store and retrieved for later processing and/or analysis. The indications can also be used in real-time and/or at predetermined time intervals throughout the sleep session of the user and/or within a threshold amount of time after the sleep session of the user ends. As described herein, these indications can be used by the computer system or other computing systems in a pipeline (e.g., the pipeline 1918 described in FIG. 19) to determine whether the user is likely to sleepwalk during subsequent sleep sessions and generate one or more interventions (such as activating a heating or cooling routine to delay deep sleep onset, which can typically be when the user sleepwalks) that can be automatically implemented by components of the bed to prevent the user from sleepwalking during those subsequent sleep sessions. As another example, the indications can be used in the pipeline to determine whether a heating routine and/or cooling routine should be activated based at least in part on whether and when the user is in bed and/or a body temperature of the user. The indications can be used to make one or more other determinations, home automation controls, bed controls, and/or sleep/health determinations as described throughout this disclosure.

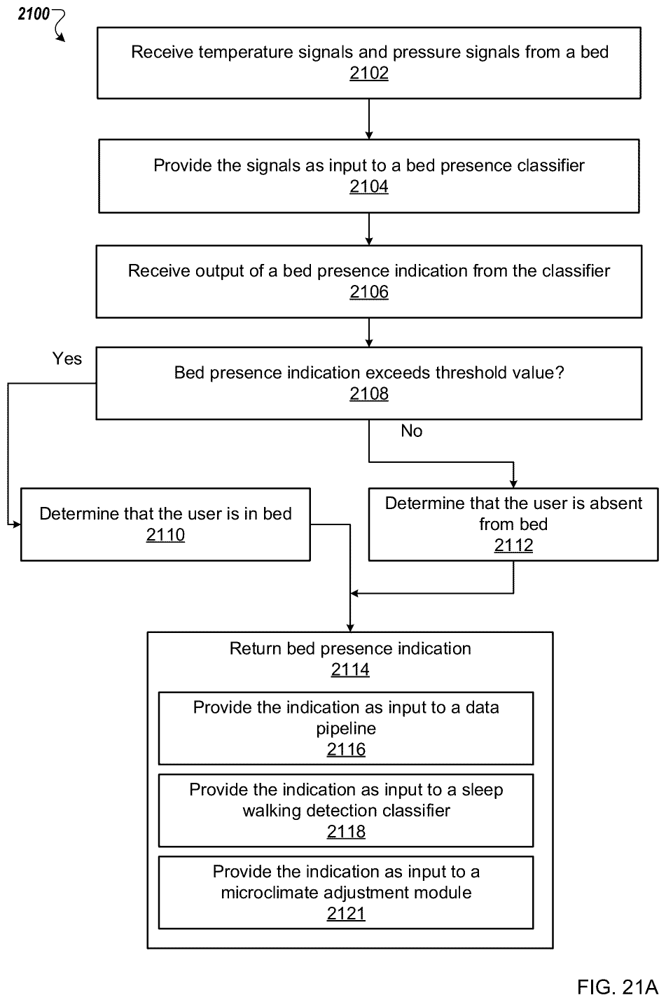

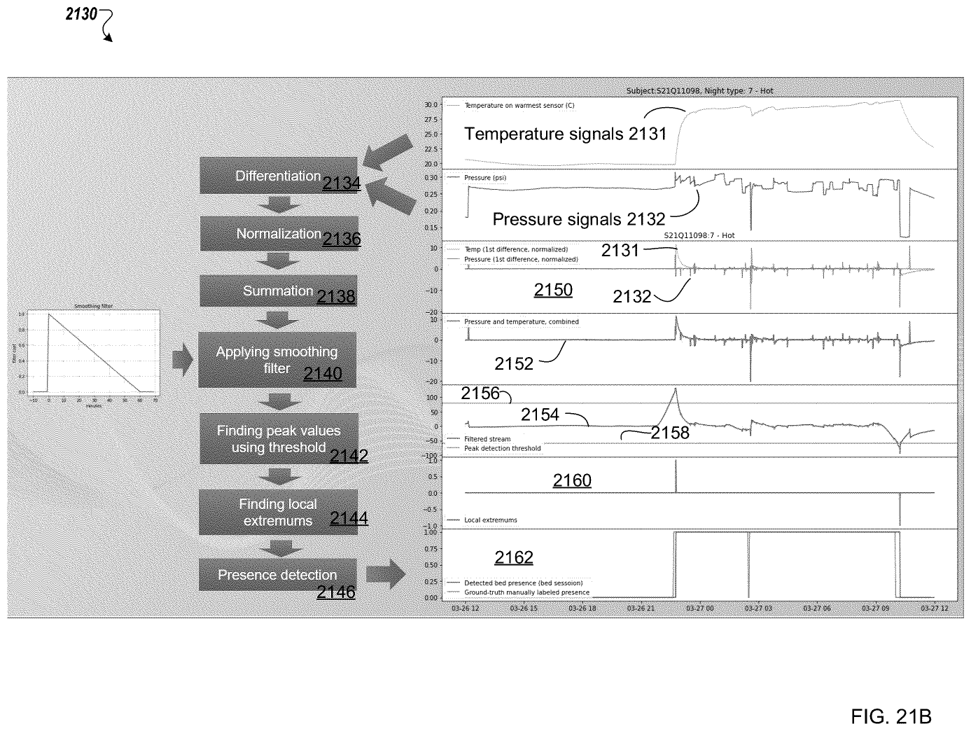

FIG. 21A is a flowchart of an example process 2100 for detecting bed presence using temperature and pressure signals. As described herein, using both temperature and pressure signals can result in accurate detection of user bed presence. The process 2000 in FIG. 20A shows receiving temperature signals for detecting bed presence while the process 2100 in FIG. 21A shows receiving temperature and pressure signals for detecting bed presence. The process 2100 can be performed by the computer system 1912. The process 2100 can also be performed by one or more other computing systems, network of devices, computing devices, cloud-based systems, and/or controllers of beds. For illustrative purposes, the process 2100 is described from the perspective of a computer system.

Referring to the process 2100 in FIG. 21A, the computer system can receive temperature signals and pressure signals from a bed (block 2102). Refer to blocks A-1, A-2, and B in FIG. 19 and block 2002 in FIG. 20A for further discussion.

The computer system can provide the signals as input to a bed presence classifier in block 2104. The bed presence classifier can be the same as the bed presence classifier described in FIGS. 19-20. In some implementations, a bed presence classifier can be trained to determine bed presence from just temperature signals and another bed presence classifier can be trained to determine bed presence from temperature signals and pressure signals. Refer to block C in FIG. 19 and block 2004 in FIG. 20A for further discussion.

The bed presence classifier can be trained to correlate the temperature signals with the pressure signals to determine whether the user is likely in the bed. For example, a spike in temperature signals can be correlated with a spike in pressure signals at or near the time of the spike in temperature signals, thereby indicating that the user enters the bed. Similarly, a sudden drop in temperature signals can be correlated with a drop in pressure signals at or near the time of the sudden drop in temperature signals, thereby indicating that the user exits the bed. Refer to FIG. 21B for further discussion about correlating the temperature signals with the pressure signals.

The computer system can receive output of a bed presence indication from the classifier in block 2106. Refer to block D in FIG. 19 and block 2006 in FIG. 20A for further discussion.

In block 2108, the computer system can determine whether the bed presence indication exceeds a threshold value. Refer to block 2008 in the process 2000 in FIG. 20A for further discussion. As described herein, the threshold value can be 0.5 on a scale of 0 to 1, where 0 indicates that the user likely is absent from the bed and 1 indicates that the user is likely in the bed.

If the threshold value is exceeded, the computer system can determine that the user is in the bed in block 2110. The computer system then proceeds to block 2114 described below. Refer to block 2010 in the process 2000 in FIG. 20A for further discussion.

If the threshold value is not exceeded, the computer system can determine that the user is absent from the bed in block 2112. The computer system can then proceed to block 2114. Refer to block 2012 in FIG. 20A for further discussion.

In block 2114, the computer system can return the bed presence indication. Returning the bed presence indication can include providing the indication as input to a data pipeline (block 2116). Returning the bed presence indication can additionally or alternatively include providing the indication as input to a sleep walking detection classifier (block 2118). Returning the bed presence indication can additionally or alternatively include providing the indication as input to a microclimate adjustment module (block 2121). The indication can also be provided to one or more other modules, engines, and/or classifiers for use in further processing and determinations made about the user of the bed (e.g., health metrics of the user) and/or control/adjustment of the bed (e.g., adjusting a firmness level, articulating a foundation of the bed, raising/lowering the bed, turning on/off home automation devices and/or environmental systems and/or devices, etc.). Refer to block E in FIG. 19 and blocks 2014-2021 in the process 2000 in FIG. 20A for further discussion.

FIG. 21B is a conceptual diagram of a process 2130 for detecting bed presence using temperature signals 2131 and pressure signals 2132. In some implementations, the process 2130 can be performed using temperature signals and load cell signals/data. The process 2130 can be performed by the computer system 1912. The process 2130 can also be performed by one or more other computing systems, network of devices, computing devices, cloud-based systems, and/or controllers of beds. For illustrative purposes, the process 2130 is described from the perspective of a computer system.

As shown in FIG. 21B, the computer system can receive temperature signals 2131 and pressure signals 2132 over a period of time (e.g., continuously throughout a sleep session of a user, at predetermined time intervals, etc.). Here, the computer system can receive the signals 2131 and 2132 between a timeframe spanning from March 26^{th} at noon (hour 12) to March 27^{th} at noon (hour 12). The temperature signals 2131 can be measured in degrees Celsius. The pressure signals 2132 can be measured in PSI.

In the example of FIG. 21B, the temperature signals 2131 remain low and constant (between 20 and 22.5 degrees Celsius) between 3:26:12 and halfway between 3:26:21 and 3:27:00. Between 3:26:21 and 3:27:00, the temperature signals 2131 spike to approximately 27.5 degrees Celsius and remains high and relatively constant (between 27.5 and 30) until approximately 3:27:09. The temperature signals 2131 alone can indicate that the user likely entered the bed and/or began a sleep session between 3:26:21 and 3:27:00 and remains in the bed until approximately 3:27:09. After all, when the user enters the bed and/or begins a sleep session, a bed surface temperature can increase. Once the user exits the bed and/or ends a sleep session, the bed surface temperature can decrease. Temperature variations can be a long term effect (e.g., greater than 10 minutes) during the user's sleep session in comparison to fluctuations and/or sharp/sudden changes in bed pressure caused by body movements during the user's sleep session. Therefore, correlating the temperature variations with pressure fluctuations can be beneficial to accurately detect whether and when the user is in the bed or absent from the bed.

The pressure signals 2132 generally correlate with the spikes and/or changes in the temperature signals 2131. For example, the pressure signals 2132 remain constant (between 0.25 and 0.30 PSI) between 3:26:12 and halfway between 3:26:21 and 3:27:00. The pressure signals 2132 also increase halfway between 3:26:21 and 3:27:00. The pressure signals 2132 fluctuate between 3:26:21 and 3:27:12, which can be related to movement of the user while they sleep and/or automatic adjustments to firmness of the bed while the user is asleep. Therefore, the pressure signals 2132 alone may not provide as accurate an indication of whether the user is in the bed or not. However, correlating and combining the pressure signals 2132 with the temperature signals 2131 can result in more accurate determinations of whether and when the user is in the bed.

The computer system can calculate the derivative with respect to time using the temperature signals 2131 and the pressure signals 2132 (block 2134) (e.g., differentiation). Finding the derivative with respect to time using the signals 2131 and 2132 can include performing operations to separate the signals from each other. The derivative can be found separately for each of the signals 2131 and 2132. For example, the derivative of the temperature signals 2131 can be T′(t)=T(t)−T(t−1), where T′(t) represents a unit of time and t can be in minutes. The derivative of the pressure signals 2132 can be P′(t)=S(t)−S(t−1), where P′(t) represents a unit of time and t can be in minutes.

The computer system can normalize the signals 2131 and 2132 in block 2136. In some implementations, a Z-score type normalization process can be performed. In some implementations, a Max-type normalization process can be performed. One or more other normalization techniques can be performed in block 2136. Normalizing the signals 2131 and 2132 can help highlight or distinguish peaks and/or dips in each of the signals 2131 and 2132. Therefore, the peaks and/or dips in the signals 2131 and 2132 can be visualized more clearly. Clearer visualization can be beneficial to match the peaks and/or dips in the temperature signals 2131 with the peaks and/or dips in the pressure signals 2132. Graph 2150 illustrates the temperature signals 2131 and the pressure signals 2132 normalized. As shown in the graph 2150, the temperature signals 2131 and the pressure signals 2132 generally peak and/or dip at or around the same times. A scale on they axis of the graph 2150 can vary depending on a type of normalization process used. As an illustrative example, the scale on the y axis of the graph 2150 can indicate a change in absolute value that exceeds a baseline by a factor of 10 or 20.

In block 2138, the computer system can perform a summation operation to determine a combined signal 2152 for the signals 2131 and 2132. For example, the computer system can average the normalized signals 2131 and 2132 to determine the combined signal 2152. As an illustrative example, a summation operation can include: Z(t)=k1*T′_N(t)+k2*P′_N(t), where k1 and k2 can represent weighting constants, T_N can be the normalized temperature-derivative signals and P_N can be the normalized-derivative pressure signals. Z(t) can qualitatively represent a combined indication of change for both the temperature and pressure signals.

In block 2140, the computer system can apply a smoothing filter to the combined signal 2152 to generate filtered stream 2154. The smoothing filter can be applied to remove noise and/or sharp changes in the combined signal 2152. In some implementations, the smoothing filter can be a smoothing triangle filter. In some implementations, smoothing can be performed as a running average over “Q” samples, using an equation such as Z_s(t)=(Z(t−9)+Z(t−8)+ . . . +Z(t))/10. A range of 50 to 100 can therefore represent a smoothed and normalized magnitude of simultaneous change for both the temperature and pressure signals described herein. One or more other filters can also be applied. Smoothing the combined signal 2152 to determine the filtered stream 2154 can beneficially highlight particular moments of bed exit and/or entry events in the filtered stream 2154. In some implementations, block 2140 can be optionally performed.

The computer system can find peak values in the filtered stream 2154 using thresholds 2156 and 2158 (block 2142). The thresholds 2156 and 2158 can vary based on types of normalization and smoothing processes that are used in the process 2130. The peak values can indicate likely bed exit and/or entry events. In the example of FIG. 21B, the filtered stream 2154 exceeds the threshold 2156 halfway between timeframes of hour 21 on March 26^{th} and hour 0 (midnight) on March 27^{th}, which can be identified as a peak value. This peak value can indicate that the user has entered the bed.

The threshold 2156 can be between 50 and 100 units, as shown in FIG. 21B, which can indicate a change in signals that exceeds a baseline change by 50. In some implementations, as described herein, the threshold can correspond to a probability value, which can be within a range of 0 to 1 instead of −100 to 100. In some implementations, the thresholds 2156 and 2158 can be adjusted to a 0 to 1 scale by applying a logistic function to a change metric for the signals.

The threshold 2158 can be used to determine when the user likely exits the bed. Therefore, when the filtered stream 2154 dips or drops below the threshold 2158, the computer system can determine that the user likely exited the bed. In the example of FIG. 21B, the filtered stream 2154 drops to a lowest value (below the threshold 2158) halfway between timeframes of hour 9 on March 27^{th} and hour 12 (noon) on March 27^{th}, which can be identified as another peak value. This peak value can indicate that the user has exited the bed.

The computer system can also find/identify local extremums in block 2144. In other words, the computer system can identify the peak values in block 2142 as the local extremums, as shown in graph 2160. The local extremums can represent bed entry and bed exit events. At extreme values, a derivative value can be small (e.g., approaching 0). Therefore, in some implementations a small threshold (e.g., near 0) can be applied to the derivative of the signal in order to identify the extreme values. In some implementations, the extreme values can be identified by detecting a maximum window in slighting windows of time that can last a threshold amount of time. The threshold amount of time can be 5 minutes. The threshold amount of time can also vary, and can include but is not limited to 30 seconds, 1 minute, 2 minutes, 3 minutes, 4 minutes, 10 minutes, etc.

In block 2146, the computer system can make and/or return a user bed presence determination, as shown by graph 2162. The computer system can convert the local extremums identified in block 2144 to numeric probability values representing the bed presence determination. As described throughout this disclosure, the bed presence determination can be a numeric value between 0 and 1. A value closer to 1 can indicate when the user enters the bed and/or is in the bed. A value closer to 0 indicates when the user exits the bed and/or is absent from the bed. One or more other numeric values can be used for the bed presence determination, as described herein.

Any one or more of the blocks 2134-2146 can be performed by the computer system and/or by a bed presence classifier described herein that is executed by the computer system.

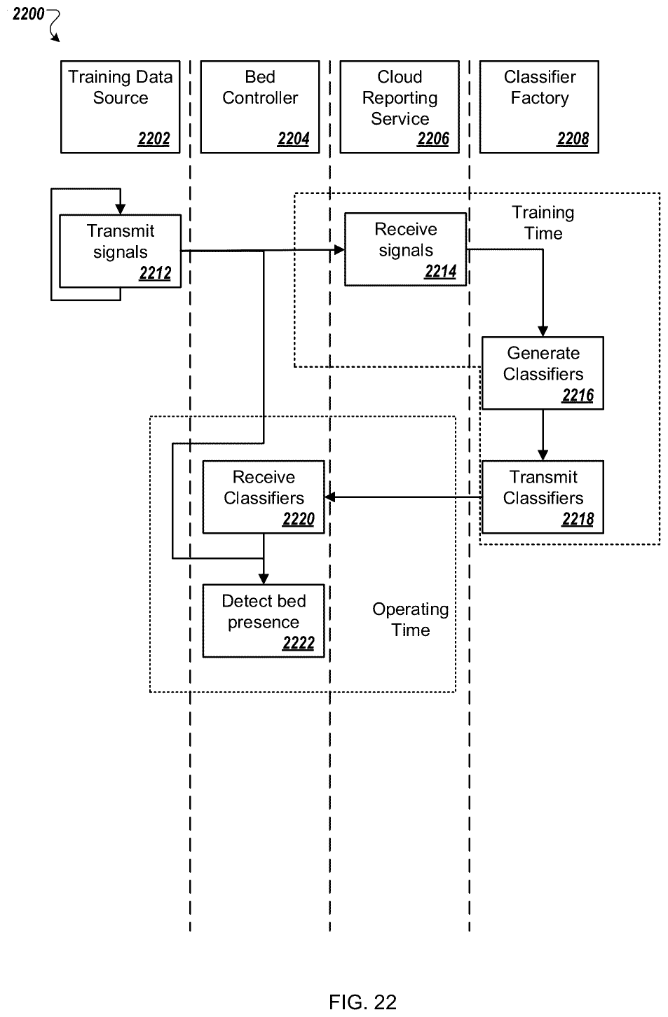

FIG. 22 is a swimlane diagram of an example process 2200 for training and using machine-learning classifiers to determine (e.g., detect) bed presence of a user in a bed system. For clarity, the process 2200 is being described with reference to a particular set of components. However, other system or systems can be used to perform the same or a similar process.

In some implementations, the process 2200 can be performed by a remote computing system to train a bed presence classifier. The bed presence classifier can then be loaded into a controller of a bed system for runtime execution. The bed presence classifier can also be loaded into controllers of many bed systems for runtime execution. In some implementations, the bed presence classifier can be trained using user-specific data. The bed presence classifier can then be deployed at the controller of the bed system of the particular user associated with the user-specific data. In some implementations, the bed presence classifier can be trained using general population data. The bed presence classifier can then be deployed at controllers of many bed systems. Sometimes, the bed presence classifier can be deployed at controllers of bed systems for users that are part of or share characteristics with those of the general population data used in training.

Moreover, in some implementations, the classifiers described herein can be trained and deployed at the controllers of bed systems before the bed systems are delivered to and set up in homes of users. The classifiers can also be trained and/or deployed at the controllers of bed systems that are already set up in the homes of users and/or used by the users. For example, a bed presence classifier can be improved using the disclosed techniques and then deployed as an update at the controllers of the bed systems that already use the bed presence classifier. As another example, the bed presence classifier can be deployed as an update at the controllers of the bed systems that do not currently use the bed presence classifier but have the capabilities to determine bed presence using temperature signals or a combination of temperature and pressure signals. As a result, the disclosed techniques can be applied to bed systems that are already in use by users as well as bed systems that are being purchased and/or set up in the homes of users.

Referring to the process 2200 in FIG. 22, a bed system can use a variety of signals from a training data source 2202 to determine whether the user is present or absent from the bed system. The signals used for training can include temperature signals from at least one temperature sensor that is attached to a sensing portion (e.g., top surface, outer face) of a mattress of the bed system. For example, temperature signals can be collected from temperature sensor arrays configured to the top surface of the mattress. In some implementations, the temperature signals for training can be collected from one temperature sensor array. In some implementations, the temperature signals for training can be collected from multiple temperature sensor arrays that are attached to the top surface of the mattress. For example, 4 parallel temperature sensor arrays can be arranged across the mattress (from a left side to a right side of the mattress). Each array can include 5 sensors. Each array can also include additional or fewer sensors. The temperature sensor arrays can be arranged over a head, shoulder, midpoint, lower back, upper legs, lower legs, and/or feet region of the mattress. The signals used for training can also include environmental signals, such as bed pressure, light, CO₂, humidity, organic concentration, etc.). The signals used for training can also include pressure signals collected by pressure sensors at the bed system. In some implementations, signals used for training can also include subjective information collected and recorded by the user of the bed system. Moreover, the signals used for training can be collected from many users of many bed systems.

The temperature sensors, temperature sensor arrays, pressure sensors, and/or other sensors described above for collecting signals can be the training data source 2202. In some implementations, the training data source 2202 can be a repository, such as a database, data store, and/or cloud-based storage for storing already collected signals and of a variety of users of bed systems. These already collected signals can be annotated and labeled with different bed presence detections (e.g., in bed, out of bed).

The bed system is able to use the training signals described above for a decision engine that classifies whether the use is presently in the bed or absent from the bed. Thus, the decision engine can use temperature signals as an input to predict or otherwise determine whether the user is present in the bed or absent from the bed during a sleep session.

The training data source 2202 can collect sensor signals for a variety of different users. Those sensor signals can be annotated and tagged with different bed presence indicators (e.g., in bed, out of bed) and used to train one or more machine learning models to detect bed presence of users. Bed presence classifiers can then be transmitted to one or more beds for run-time use. The one or more beds that receive the classifiers can be different than the training data source 2202. In some implementations, one or more of the beds that receive the classifiers can be the same as the training data source 2202. In some implementations, during runtime use, the classifiers can be used by a computer system, such as the computer system 1912 described in FIG. 19, to detect bed presence of users of one or more different beds. The computer system can, in some implementations, be remote from the one or more different bed systems.

During runtime use, the bed presence classifiers can be used by the one or more beds to detect bed presence of users during their sleep sessions. For example, during runtime use, a bed system can collect temperature or temperature and pressure signals indicating body movement and body position as the user rests on the bed. The bed system can apply the bed presence classifiers to the signals to determine whether the user is presently in the bed or absent from the bed.

In some implementations, sensor signals can be collected from a first bed, used to train one or more machine learning models to classify bed presence, and then resulting classifiers can be transmitted back to the first bed and used during runtime. Thus, the process 2200 can be used to refine or otherwise improve one or more existing bed presence classifiers. As a result, the first bed can more accurately detect and determine bed presence of the particular user(s) who uses the first bed.

In some implementations, sensor signals can be collected from a first bed, used to train one or more machine learning models to classify bed presence, and then resulting classifiers can be transmitted to a second bed. The second bed can be different than the first bed. Thus, in this example, the process 2200 can be used to prepare the second bed to be able to detect user bed presence. In other words, the second bed might have just been manufactured and purchased by a user. Before the second bed is delivered to the user's home for installation and use, the second bed can be configured/calibrated to perform functions that it is intended to perform, such as detecting bed presence, detecting sleep states, determining health/sleep metrics for the user, etc. Thus, the process 2200 can be performed to configure the second bed for detecting bed presence.

Still referring to the process 2200, the training data source 2202 can transmit one or more signals (e.g., temperature, pressure, environmental conditions, etc.) to a cloud computing service 2206 in block 2212. Such signals can be measured from a variety of users and their sleep environment, and annotated with corresponding bed presence conditions. In some implementations, as described above, the signals can also include streams of pressure readings received from a bed system. The pressure readings can reflect pressure inside of an air bladder within the bed system. The pressure readings can also reflect health conditions of the user of the bed system, such as the user's body movement. The signals can also include one or more environmental readings. For example, the signals can include information about the microclimate (e.g., bed, bedding, and are against the sleeper) such as temperature, barometric pressure, etc. In some examples, the signals can include state-information that records the state of one or more automation devices (e.g., heaters such as a foot warmer, heated mattress topper, HVAC, space heater, air-quality devices such as air filters and humidifiers).

The cloud reporting service 2206 can receive the signals in block 2214. For example, the training data source 2202 can transmit all signals or determine that some signals—and not others—should be transmitted to the cloud reporting service 2206 that is configured to receive signals and, in some cases, other types of data. The signals sent to the cloud reporting service 2206 may be unchanged by the training data source 2202, aggregated (e.g., averages, maximums and minimums, etc.), or otherwise changed by the training data source 2202. As described above, for example, the training data source 2202 can modify the signals by annotating them with bed presence indications (e.g., in bed, present, out of bed, absent). Another way that the training data source 2202 can modify the signals can be sending just temperature signals instead of a combination of temperature and pressure signals. Thus, the training data source 2202 can extract the temperature signals out from the combination and transmit just the extracted temperature signals.

During training time, a classifier factory 2208 generates classifiers from the received signals in block 2216. The classifier factory 2208 can train classifiers by first obtaining a large set of pre-classified signal (e.g., temperature, pressure, or temperature and pressure signals) variation patterns. For example, one bed or many beds may report pressure data to the cloud reporting service 2206. This pressure data may be tagged, recorded, and stored for analysis in the creation of pressure classifiers to be used by the bed controller 2204 and/or other bed controllers. This pressure data can indicate a variety of bed presence signal patterns. The more data that is collected, the more likely a greater quantity of bed presence signal patterns can be used for training. Accordingly, the more robust training datasets, the more likely the classifiers can accurately identify bed presence signal patterns that may exist during run-time use.

The classifier factory 2208 can generate features from the signals as part of block 2216. The stream of signals may be broken into buffers of, for example, 1 second, 2.125 seconds, 30 seconds, or 3 seconds, to generate features in time or frequency domains. Features can be extracted or otherwise identified in each of these buffers. As an illustrative example, features can include peaks and dips in detected temperature and/or a combination of temperature and pressure signals. As another example, features can include detection of body movement (e.g., movement of the user's head, shoulders, arms, torso, legs, and/or feet), which can be used to distinguish from bed entry and bed exit events.

In some cases, the classifier factory 2208 can generate features directly. In some cases (not shown), the bed controller 2204 and/or the training data source 2202 can generate features and send features to the cloud reporting service 2206. In some cases, the features may be generated only from signals related to the sleeper (e.g., physiological measures and/or measures of the sleeper's pressure against a mattress). This may be a desirable configuration, for example, in a scheme in which the environment of the sleeper or sleepers is likely to be held constant or predictable, with one example being a hospital with centrally-controlled air quality and temperature controls. In some cases, the features may be generated from at least signals related to the sleeper (e.g., physiological measures and/or measures of the sleeper's pressure against a mattress) and also environmental signals (e.g., ambient or microclimate temperatures, environmental air pressure, seasonality measures such as month of the year). This may be a desirable configuration, for example, in a scheme in which the environment of the sleeper or sleepers is likely be variable—either on a person-to-person basis or for any particular sleeper that can and may alter their sleeping environment (e.g., keeping their home cooler in the winter and warmer in the summer). As such, by using the environmental signals, the classifiers may be configured to compensate for naturally-occurring (e.g., due to weather) or human-caused (e.g., due to control of a home's heating system) environmental shifts.

Some features may include, but are not limited to, a maximum, minimum, and/or random temperature values and/or temperature and pressure values combined. These features may be derived from the temperature and/or pressure readings or signals within those buffers. For example, such features may include an average temperature, a standard deviation, a slope value that indicates an increase or decrease over time within that buffer, average pressure, user motion, respiration measurement, cardiac measurement, average body temperature, and/or cardiorespiratory coupling measurement from the temperature variations and/or the temperature and pressure variations combined. The values of the feature vectors described herein may be in binary or numerical form. For each buffer, the values may be stored in a predetermined order creating a vector that is composed of a series of fields, where every vector has the same series of fields and data in those fields.

As another example, the classifier factory 2208 can identify instances within the signals where the signals match a pattern or rules for a pattern. Such patterns may be identified, and corresponding synthetic information about the pattern (e.g., timestamp, duration, rate of change, frequency of change, max change, slope of change, etc.) may be synthesized from the signal and/or other outside information (e.g., a real-time clock).

The classifier factory 2208 can also combine or reduce the features during training. For example, the extracted features can be combined using principal component analysis. For a principal component analysis of the features, the classifier factory 2208 can determine a subset of all features that are discriminant of the bed presence of the user. That is, the classifier factory 2208 can sort features into those features that are useful for determining bed presence (e.g., peaks or dips in temperature or a combination of pressure and temperature) and those features that are less useful (e.g., peaks or dips in pressure signals most likely associated with user movement during sleep), and the more useful features may be kept. This process may be done on a trial-and-error basis, in which random combinations of features can be tested. This process may be done with the use of one or more systematic processes. For example, a linear discriminant analysis or generalized discriminant analysis may be used.

In some cases, a proper subset of features may be selected out of the set of all available features. This selection may be done once per classifier if multiple classifiers are being created. Alternatively, this selection may be done once for a plurality or all classifiers if multiple classifiers are being created.

For example, a random (or pseudorandom) number may be generated and that number of features may be removed. In some cases, a plurality of features may be aggregated into a single aggregate feature. For example, for a case in which a plurality of fluctuating patterns are identified in the temperature signals, the patterns and/or synthetic data related to the patterns may be aggregated. For example, the patterns and/or synthetic data related to the patterns can be aggregated into a mean, a standard deviation, a minimum, and/or a maximum temperature.

The classifier factory 2208 can also process the features. For example, the remaining features may then be processed to rationalize their values so that each feature is handled with a weight that corresponds to how discriminant the feature is. If a feature is found to be highly discriminant so that is highly useful in classifying state, that feature may be given a larger weight than other features. If a second feature is found to be less discriminant than other features, that second feature can be given a lower weight.

Once mapped into kernel space, for example, the features can be standardized to center the data points at a predetermined mean and to scale the features to have unit standard deviation. This can allow the features to all have, for example, a mean value of 0 and a standard deviation of 1. The extracted features are then converted to a vector format using the same vector format as described above.

In some cases, the remaining features can be processed by applying a kernel function to map the input data into a kernel space. A kernel space allows a high-dimensional space (e.g., the vector space populated with vectors of feature data) to be clustered such that different clusters can represent different states. The kernel function may be of any appropriate format, including linear, quadratic, polynomial, radial basis, multilayer perceptron, or custom.

In some cases, the classifier factory 2208 can use machine-learning techniques that do not create features. For example, deep learning networks such as convolutional networks, deep feed forward, or deep recurrent networks can be used. The classifier factory 2208 can train a dilated convolutional neural network (CNN) with the signals in which the classifier factory 2208 can detect peaks in the temperature signals (or a combination of temperature and pressure signals), remove missing data segments that are greater than a predetermined amount of time (e.g., 4 seconds), remove outliers that are out of range (e.g., by standard deviation or physiologic considerations), linearly interpolate and resample the peaks in the temperature signals, and/or normalize a local mean and standard deviation for each sleep session corresponding to each temperature signal (or a combination of temperature and pressure signals).

Thus, convolutional layers can be used by the classifier factor 2208 to learn local temperature features. Dilated convolutional blocks can also be used to learn long-range features as bed presence related to temporal temperature features contained in a long-time span.

As described above, the classifier factory 2208 can train the classifier(s) as part of block 2216. For example, a pattern recognizer algorithm can use the vectors of extracted features and their corresponding bed presence labels as a dataset to train the classifiers with which new temperature signals (or a combination of temperature and pressure signals) can be classified. In some cases, this can include storing the classifiers with the training data for later use.

In some implementations, the cloud reporting service 2206 and the classifier factory 2208 can be part of a computing system, such as the computer system 1912 described in FIG. 19. In some implementations, the cloud reporting service 2206 and/or the classifier factory 2208 can be separate components and/or remote from one or more bed systems.

The classifier factory 2208 can transmit the classifiers in block 2218 and the bed controller 2204 can receive the classifiers in block 2220. For example, the classifier or classifiers created by the classifier factory 2208 can be transmitted to the bed controller 2204 and/or other bed controllers. As described herein, the classifiers can also be transmitted to a computer system, such as the computer system 1912 in FIG. 19 for runtime use (e.g., operating time).

In some cases, the classifiers can be transmitted on non-transitory computer readable mediums like a compact disk (CD), a Universal Serial Bus (USB) drive, or other device. The classifiers may be loaded onto the bed controller 2204 and/or other bed controllers as part of a software installation, as part of a software update, or as part of another process. In some cases, the classifier factory 2208 can transmit a message to the bed controller 2204 and/or other bed controllers, and the message can contain data defining one or more classifiers that use a stream of temperature readings or a combination of temperature and pressure readings to classify user bed presence. In some configurations, the classifier factory 2208 can transmit the classifiers at once, either in one message or a series of messages near each other in time. In some configurations, the classifier factory 2208 can send the classifiers separated in time. For example, the classifier factory 2208 may generate and transmit classifiers. Later, with more temperature signals and training data available, the classifier factory 2208 may generate an updated classifier or a new classifier unlike one already created.

Moreover, in some implementations, the classifier factory 2208 can transmit one classifier to the bed controller 2204 and/or other bed controllers. For example, if the bed controller 2204 corresponds to a bed that only has components for collecting temperature signals, the classifier factory 2208 can transmit a bed presence classifier that is trained with temperature readings. As another example, if the bed controller 2204 corresponds to a bed that has components for collecting temperature signals and pressure signals, the classifier factory 2208 can transmit one or more bed presence classifiers, such as a classifier that is trained with just temperature readings and a classifier that is trained with both temperature and pressure readings. The classifier factory 2208 can transmit one or more other variations of classifiers to bed controllers based on configurations of bed systems associated with the bed controllers.

The classifier factory 2208 can transmit the classifiers to the bed controller 2204 of a bed that is different than the training data source 2202. For example, the training data source 2202 can be a first bed and the bed controller 2204 can be part of a second bed. The second bed can be different than the first bed and therefore the second bed can be used by different users than the first bed. In some implementations, the training data source 2202 can be a database and therefore the classifier factory 2208 can transmit the classifiers to a plurality of different beds that otherwise may not be associated with the training data source 2202.

The classifiers may be defined in one or more data structures. For example, the classifier factory 2208 can record a classifier in an executable or interpretable files such as a software library, executable file, or object file. The classifiers may be stored, used, or transmitted as a structured data object such as an extensible markup language (XML) document or a JavaScript object notation (JSON) object. In some examples, a classifier may be created in a binary or script format that the bed controller 2204 can run (e.g., execute or interpret). In some examples, a classifier may be created in a format that is not directly run, but in a format with data that allows the bed controller 2204 to construct the classifier according to the data. Moreover, the classifier may be created in a format that a computer system, such as the computer system 1912 can run (e.g., execute or interpret).

In some implementations, the bed controller 2204 can use the same temperature signals (and optionally pressure signals) that were used for training to detect bed presence during runtime use in block 2222 (e.g., operating time). In some implementations, the bed controller 2204 can use different temperature signals (and optionally pressure signals) to detect bed presence during runtime use. In some implementations, the bed controller 2204 can receive temperature readings (or a combination of temperature and pressure readings) of a user on the bed from one or more bed sensors. The bed sensors can be configured to detect changes in pressure and/or temperature in air chambers of the bed or at a top surface of the bed, as described herein. The bed sensors can also be configured to detect the user's body movements, heart rate, breathing rate, body temperature, or other biometrics. Refer to FIG. 19 for additional discussion about components of the bed that can be used to detect bed presence.

The bed controller 2204 can run one or more classifiers using data from the stream of temperature signals (or a combination of temperature and pressure signals) from the bed. A classifier can categorize this data into bed presence or bed absence indications, as described in reference to FIGS. 20-21. For example, the classifier may convert the data stream into a vector format described above. The classifier may then examine the vector to mathematically determine if the vector is more like training data labeled as one condition (in the bed, bed presence) or more like training data labeled as another condition (out of the bed, bed absence). Once this similarity is calculated, the categorizer can return a response indicating that condition.

The bed controller 2204 can use more than one classifier. That is, the bed controller 2204 may have access to a plurality of classifiers that each function differently and/or use different training data to generate classifications. In such cases, classifier decisions can be treated as a vote and vote aggregation can be used to detect bed presence. If only one classifier is used, for example, the vote of that classifier is the only vote and the vote is used as the bed presence indication. If there are multiple classifiers, the different classifiers can produce conflicting votes, and the bed controller can select a vote-winning bed presence indication.

Various vote-counting schemes are possible. In some cases, the bed controller 2204 can count the votes for each bed presence indication with the most votes being the detected bed presence. In some cases, the bed controller 2204 can use other vote-counting schemes. For example, votes from different classifiers may be weighed based on the classifiers historical accuracy. In such a scheme, classifiers that have been historically shown to be more accurate can be given greater weight while classifiers with lesser historical accuracy can be given less weight. This accuracy may be tracked on a population level or on a particular user level.

In some instances, votes may be cast by systems other than a machine-learning system, and those votes may be incorporated into the vote totals to impact the outcomes of the voting decision. For example, non-machine-learning temperature categorizing algorithms may cast votes based on, for example, comparisons with threshold values.

In some instances, the system may have different operational modes, and may tally votes differently depending on the mode. For example, when a bed is in the process of adjusting or when the adjustable foundation is moving or a portion of the bed is elevated, different vote strategies may be used. In some modes, some classifiers may be given greater weight or lesser weight or no weight as compared to some other modes. This may be useful, for example, when a classifier is shown to be accurate in one mode (e.g. with the bed flat) versus another mode (e.g., with the head of the bed elevated by the foundation).

In general, as shown and described in FIG. 22, the process 2200 can be organized into a training time and an operating time. The training time can include actions that are generally used to create bed presence classifiers, while the operating time can include actions that are generally used to detect bed presence with the classifiers. Depending on the configuration of the bed system, the actions of one or both of the times may be engaged or suspended. For example, when a user newly purchases a bed, the bed may have access to no temperature readings (or combination of temperature and pressure readings) caused by the user on the bed. When the user begins using the bed for the first few nights, the bed system can collect those temperature readings (or combination of temperature and pressure readings) and supply them to the cloud reporting service 2206 once a critical mass of readings have been collected (e.g. a certain number of readings, a certain number of nights, a certain number of expected entry and exit events based on different tests or heuristics).

The bed system may operate in the training time to update or expand the classifiers. The bed controller 2304 may continue actions of the training time after receipt of the classifiers. For example, the training data source 2302 may transmit temperature signals to the cloud reporting service 2306 on a regular basis, when computational resources are free, at user direction, etc. The classifier factory 2308 may generate and transmit new or updated classifiers, or may transmit messages indicating that one or more classifiers on the bed controller 2304 should be retired.

The bed system can use the same temperature signals from the training data source 2302 to operate in the training time and the operating time concurrently. For example, the bed system can use a stream of temperature readings to determine whether the user is in bed based on bed presence categorizers that are currently in use. In addition, the bed system can use the same temperature readings from the stream of temperature readings in the training time actions to improve the categorizers. In this way, a single stream of temperature readings may be used to both improve the function of the bed system and to determine bed presence.

In some cases, a generic set of classifiers may be used instead of, or in conjunction with, personalized classifiers. For example, when a bed is newly purchased or reset to factory settings, the bed system may operate with generic or default bed presence classifiers that are created based on population-level, not individual, temperature readings. That is, generic classifiers may be created for use in a bed system before the bed system has had an opportunity to learn about the particular temperature readings (or combination of temperature and pressure readings) associated with a particular user. These generic classifiers may be generated using machine learning techniques, such as those described in this document, on population-level training data. These generic classifiers may additionally or alternatively be generated using non-machine learning techniques. For example, a classifier may include a threshold value (e.g., temperature, temperature change over time, heart rate change over time, changes in physiological components of the temperature readings over time), and a temperature measure over that threshold may be used to determine that the user is in bed while temperature measures under that threshold may be used to determine that the user is absent from the bed.

While a particular number, order, and arrangement of elements are described here, other alternatives are possible. For example, while the generation of classifiers in 2216 is described as being performed on the classifier factory 2208, classifiers can be instead or additionally generated by the bed controller 2204, the cloud reporting service 2206, the computer system 1912, and/or other devices, computing systems and/or networks of devices.

In some implementations, the bed system may accommodate two users. In such a case, the process 2200 can be adapted in one or more ways to accommodate two users. For example, for each user, the bed system may use two sets of classifiers (with or without some classifiers being simultaneously used in both sets). For example, one set may be used when one side of the bed is occupied, and one set may be used when the other side of the bed is occupied. This may be useful, for example, when the presence or absence of the second user has an impact on temperature signals on the first user's side of the bed.

It will be understood that the system described in reference to FIG. 22 is applicable to many more beds and bed controllers. For example, temperature signals may be received from many training data sources, and training data can be synthesized from these many sources (which may or may not include beds), providing data about bed use by many users. The classifiers can then be distributed to some, none, or all of those training data sources or beds that provided training data. For example, some beds may receive a software updated with new classifiers. Or, as another example, the new classifiers may only be included on newly manufactured beds. Or as another example, each bed may receive classifiers that are particularly tailored to the users of that particular bed.

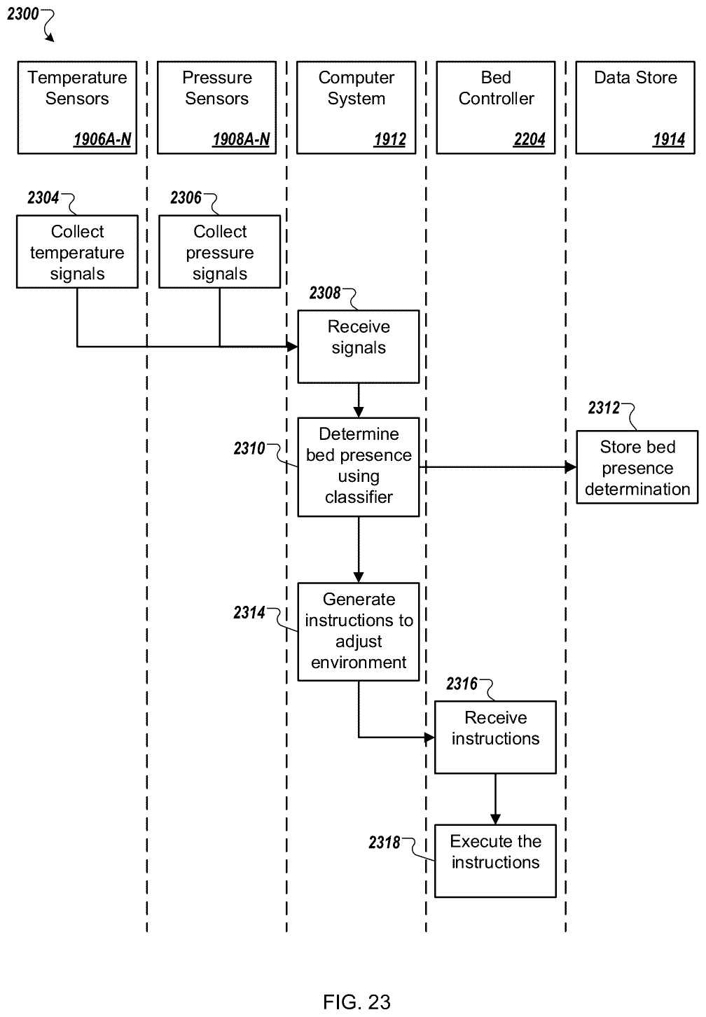

FIG. 23 is a swimlane diagram of an example process 2300 for detecting bed presence using temperature and pressure signals during runtime. For clarity, one or more blocks in the process 2300 are described with reference to components described in reference to FIG. 19 and FIG. 22. However, other systems or components can also be used to perform the same or a similar process.

Referring to the process 2300 in FIG. 23, the temperature sensors 1906A-N of a bed system can collect temperature signals in block 2304. Refer to block A-1 in FIG. 19 for further discussion.

The pressure sensors 1908A-N of the bed system can collect pressure signals in block 2306. Refer to block A-2 in FIG. 19 for further discussion.

Blocks 2304 and 2306 can be performed at a same time. In some implementations, the blocks 2304 and 2306 can be performed at different times, as described in reference to FIG. 19 and FIGS. 21A-B.

The computer system 1912 can receive the signals from the temperature sensors 1906A-N and the pressure sensors 1908A-N in block 2308. The signals from the temperature sensors 1906A-N can be received at different times than the signals from the pressure sensors 1908A-N. In some implementations, the signals from the temperature sensors 1906A-N can be received at a same time as the signals from the pressure sensors 1908A-N. Refer to block B in FIG. 19 for further discussion.

In block 2130, the computer system 1912 can determine a bed presence of a user of the bed system using a bed presence classifier. As described herein, the classifier can be trained using the techniques of FIG. 22 to generate a bed presence indication based on a combination of temperature and pressure signals. Refer to FIGS. 21A-B for further discussion about determining bed presence based on a combination of temperature and pressure signals.

The computer system 1912 can store the bed presence determination in the data store 1914 in block 2312. The bed presence determination can then be retrieved for additional processing and/or analysis. For example, as described in reference to FIG. 19, the bed presence determination can be provided as input to a data pipeline (e.g., the data pipeline 1918) to determine one or more controls and/or adjustments to the bed system and/or one or more sleep/health metrics of the user.

The computer system 1912 can generate instructions to adjust an environment of the bed system in block 2314, which can be transmitted and received by the bed controller 2204 in block 2316. Based on the bed presence determination, the computer system 1912 can determine whether a component of the bed system and/or a home automation device can be controlled to improve/maintain the user's sleep session and/or sleep quality. For example, if the user is detected as being in bed, the computer system 1912 can generate instructions to cause a smart lock in the user's home to lock doors in the house. The computer system 1912 can generate instructions to cause lights in the user's home to be automatically turned off. The computer system 1912 can generate instructions that cause a heating and cooling unit in the user's home to be turned off and/or turned on.

As another example, if the user is detected as being absent from the bed, the computer system 1912 can generate instructions that cause the lights in the user's home to be automatically turned on and/or for underbed lighting to be turned on.

As another example, if the user is detected as being absent from the bed, the computer system 1912 can generate instructions that cause a presently activated heating or cooling routine at the bed system to be turned off. The computer system 1912 can also generate instructions that cause a foundation of the bed system to be automatically reset to a flat position or a user-desired position. The computer system 1912 can also generate instructions that cause a firmness level of the bed system to be reset to a user-desired firmness level or other firmness level.

As yet another example, if the user is detected as being in the bed, the computer system 1912 can generate instructions that cause a user-preferred or user-defined heating routine or cooling routine to be activated in the bed system. The computer system 1912 can also generate instructions that cause the foundation of the bed system to be automatically adjusted to a user-desired position. The computer system 1912 can also generate instructions that cause the firmness level of the bed system to be adjusted to a user-defined or user-preferred firmness level. One or more other instructions can be generated by the computer system 1912, based on the bed presence determination, and intended to improve and/or maintain environmental and/or bed conditions for the user during their sleep session.

The bed controller 2204 can then execute the generated instructions in block 2318. For example, the bed controller 2204 can cause actuators of the foundation to adjust to a position defined in the instructions. The bed controller 2204 can cause a pump of the bed system to pump air into air chambers of the bed system to increase firmness and/or release air from the air chambers to decrease firmness. The bed controller 2204 can also cause a heating/cooling unit of the bed system to activate or deactivate for a predetermined period of time, as defined in the instructions. The bed controller 2204 can execute the instructions in one or more other ways described throughout this disclosure.

In some implementations, the bed controller 2204 can receive the signals in block 2308 and determine the bed presence indication using a classifier in block 2310. As described in reference to FIG. 22, the classifier can be deployed and executed at the bed controller 2204, in some implementations. Moreover, the bed controller 2204 can optionally generate the instructions to adjust the environment in block 2314 and then execute those instructions in block 2318. In some implementations, the bed controller 2204 can determine the bed presence indication in block 2310 and transmit that determination to the computer system 1912 so that the computer system 1912 can generate the instructions to adjust the environment in block 2314. The computer system 1912 can then transmit the instructions to the bed controller 2204 in block 2316 for execution by the bed controller 2204 in block 2318. One or more other variations in implementing the blocks 2304-2318 is also possible, as described throughout this disclosure.

What is claimed is:

1. A bed system for detecting bed presence of a user, the bed system comprising:
a bed including at least one temperature sensor attached to the bed; and
a computer system in communication with the bed, the computer system configured to perform operations comprising:
receiving, from the at least one temperature sensor, temperature signals collected at the bed;
providing the temperature signals as input to a bed presence classifier;
receiving, from the bed presence classifier, output of a bed presence indication; and
returning the bed presence indication.

2. The bed system of claim 1, wherein the bed presence classifier is a logistic regression classifier.

3. The bed system of claim 1, the operations further comprising:
determining a time at which the user enters the bed as a time associated with the temperature signals received from the at least one temperature sensor.

4. The bed system of claim 1, the operations further comprising:
receiving, from at least one motion sensor of the bed, pressure signals,
wherein the bed presence classifier is configured to generate the bed presence indication based on the pressure signals and the temperature signals.

5. The bed system of claim 1, the operations further comprising:
providing the bed presence indication as input to a sleep walking detection classifier,
wherein the sleep walking detection classifier is configured to predict likelihood of a sleepwalking event occurring during a current sleep session based at least in part on the bed presence indication.

6. The bed system of claim 1, the operations further comprising:
providing the bed presence indication to a microclimate adjustment module,
wherein the microclimate adjustment module is configured to generate instructions that cause one or more components of the bed to adjust a microclimate of the bed based at least in part on the bed presence indication.

7. The bed system of claim 1, the operations further comprising:
normalizing the bed presence indication to a binary value, wherein a binary value of 0 indicates that the user is absent from the bed and a binary value of 1 indicates that the user is in the bed; and
returning the binary value as output.

8. The bed system of claim 7, the operations further comprising:
providing, to a data pipeline, the output,
wherein the data pipeline includes at least one classifier that was trained to determine, based at least in part on the output, at least one of the group consisting of i) user sleep metrics and ii) user health metrics.

9. The bed system of claim 1, the operations further comprising:
normalizing the bed presence indication to a binary value, wherein a binary value of False indicates that the user is absent from the bed and a binary value of True indicates that the user is in the bed; and
returning the binary value as output.

10. The bed system of claim 1, the operations further comprising:
determining that the user is in the bed based on a determination that the bed presence indication exceeds a threshold value.

11. The bed system of claim 10, wherein the threshold value is 0.5.

12. The bed system of claim 1, the operations further comprising:
determining that the user is absent from the bed based on a determination that the bed presence indication is less than a threshold value.

13. The bed system of claim 1, wherein the bed presence classifier was trained using a machine learning model to correlate increases in the temperature signals with presence of the user in the bed and decreases in the temperature signals with absence of the user from the bed.

14. The bed system of claim 1, the operations further comprising:
receiving, from the at least one temperature sensor, the temperature signals for a threshold period of time;
separating the received temperature signals into 1 second frames; and
processing each of the 1 second frames to provide as input to the bed presence classifier.

15. The bed system of claim 14, the operations further comprising:
receiving, from the at least one temperature sensor, another set of temperature signals during another threshold period of time, the another threshold period of time being adjacent to the threshold period of time,
wherein the threshold period of time does not overlap with the another threshold period of time.

16. The bed system of claim 1, wherein the bed presence classifier is configured to generate the bed presence indication based on data collected in real-time by the at least one temperature sensor.

17. The bed system of claim 1, the operations further comprising:
generating instructions, based on the bed presence indication, to actuate a home automation device.

18. The bed system of claim 1, wherein the at least one temperature sensor is an array of 5 temperature sensors linearly arranged on a top surface of the bed.

19. The bed system of claim 1, wherein the at least one temperature sensor comprises 5 sensors arranged linearly on a top surface of the bed from a left side of the bed to a right side of the bed.

20. The bed system of claim 19, wherein:
the 5 sensors are attached to a strip material, and
the strip material is adhered to a top surface of the bed, extending from a left side of the bed to a right side of the bed.
